(19) United States
(12) Patent Application Publication
(10) Pub. No.: US 2004/0090195 A1
(43) Pub. Date: May 13, 2004

(54) Efficient control, monitoring and energy devices for vehicles such as watercraft

(76) Inventor: Marvin A. Motsenbocker, Fredericksburg, VA (US)

Correspondence Address: Marvin Motsenbocker, Maruta Electric Boatworks, 17 Wallace Farms Lane, Fredericksburg, VA, 22406, US

(21) Appl. No.: 10/620,618

(22) Filed: Jul. 17, 2003

Related U.S. Application Data
(63) Continuation-in-part of application No. 10/187,830, filed on Jul. 3, 2002, now Pat. No. 6,676,460.
(63) Continuation of application No. 10/164,566, filed on Jun. 10, 2002, now Pat. No. 6,659,815.
(63) Continuation of application No. 10/164,567, filed on Jun. 10, 2002.
(60) Provisional application No. 60/323,723, filed on Sep. 21, 2001.
(60) Provisional application No. 60/302,647, filed on Jul. 5, 2001.
(60) Provisional application No. 60/349,375, filed on Jan. 22, 2002.
(60) Provisional application No. 60/296,754, filed on Jun. 11, 2001.
(60) Provisional application No. 60/302,647, filed on Jul. 5, 2001.
(60) Provisional application No. 60/349,375, filed on Jan. 22, 2002.
(60) Provisional application No. 60/296,754, filed on Jun. 11, 2001.
(60) Provisional application No. 60/396,084, filed on Jul. 17, 2002.
(60) Provisional application No. 60/445,249, filed on Feb. 6, 2003.
(60) Provisional application No. 60/433,591, filed on Dec. 16, 2002.
(60) Provisional application No. 60/431,200, filed on Dec. 6, 2002.

(51) Int. Cl. H02P 5/46

(52) U.S. Cl. 318/109

(57) ABSTRACT

Advances in electric power storage, monitoring, control and use in electric motors are described from the viewpoint of their optimal use in electric watercraft. Electric motor overspeed capability is provided to allow a wider range of performance from electric motors. Monitors and useful ways of constructing electric power supplies such as cost performance monitored batteries for electric motors and hydrogen absorbent chambers for fuel cells are further described. Such devices and methods provide greater efficiencies, greater convenience and improved flexibility for operators and riders of watercraft, land vehicles, airplanes and other devices.

### RELATED APPLICATION DATA

This application is a continuation in part of U.S. Ser. No. 10/187,830 filed Jul. 3, 2002, which enjoys priority to U.S. Nos. 60/323,723 filed Sep. 21, 2001; 60/302,647 filed Jul. 5, 2001 and 60/349,375 filed Jan. 22, 2002, and is a continuation of U.S. Ser. No. 10/164,566 filed Jun. 10, 2002, which enjoys priority to U.S. Ser. No. 09/877,196 filed Jun. 11, 2001; 60/296,754 filed Jun. 11, 2001; 60/302,647 filed Jul. 5, 2001 and 60/349,375 filed Dec. 22, 2001 and is a continuation of U.S. Ser. No. 10/164,567 filed Jun. 10, 2002, which enjoys priority to U.S. No. 60/296,754 filed Jun. 11, 2001, and also receives priority from U.S. Nos. 60/396,084 filed Jul. 17, 2003; 60/445,249 filed Feb. 6, 2003; 60/433,591 filed Dec. 16, 2002; 60/349,375 filed Dec. 22, 2002; 60/431,200 filed Dec. 6, 2002 and U.S. provisional application entitled “Magnetic Torque Converter” filed Jun. 3, 2003.

### FIELD OF THE INVENTION

This invention relates generally to transport apparatus such as watercraft and more specifically to monitoring and control systems for watercraft and other apparatus, including that related to electric motors, propeller monitoring and control, fuel cell degradation monitoring and control, and battery monitoring and control.

### BACKGROUND OF THE INVENTION

The technology of electric energy storage and use has a rich history in the transportation industries. In some aspects, electric powered transportation vehicles and watercraft, were more popular about a hundred years ago before widespread use of exploding motors (internal combustion motors) but recently appear to be making a comeback. The technology for storing and using electric power in these industries is becoming commensurately more important. Electric boats in particular, once dominated the power watercraft field but became disfavored due to the lower power to weight ratio and lower speed available in electric boats compared to fossil fuel burning watercraft that later developed. The renewed public interest in electric watercraft partly is due to their advantages of lower pollution, lower noise, and in some cases elegance, compared with air breathing fossil fueled watercraft. Because of the use of low energy density power supplies such as lead acid batteries, metal hydride batteries, and increasingly in the future, fuel cells (including the chemical energy conversion unit) and the like however, electric boats have limited range and speed compared to equivalent sized fossil boats. Accordingly, any improvement in propulsion efficiency, battery use efficiency, or fuel cell or hydrogen reservoir use efficiency would directly ameliorate this problem and improve acceptance of electric boats by the public. Furthermore, such advances generally are applicable in some respects to the land vehicle and air transport industries that utilize related components as well.

Electric boats (“Eboats”) present wonderful opportunities for the study and commercialization of electric and electronic control devices for monitoring and control of watercraft (as well as other vehicle) functions and components such as batteries, fuel cells, direction monitoring and the like. For brevity, watercraft component and function monitoring and control primarily are discussed herein, although many corresponding functions may be seen in the electric vehicle and other industries.

Much electric boat motor and battery technology arose from advances in the electric golf cart and electric car industries. Accordingly, most commercial motors used in electric boats have been designed for those other uses. Many of those active in the electric boat industry use series wound motors and believe that the torque versus speed characteristics of this motor are well optimized for electric boating because the motor speed automatically increases to reach a suitable maximum propeller resistance (Paul Kydd, Electric Boat Journal Issue 4, Vol. 6). On the other hand, electronic technologies designed for golf carts, cars and trolleys, such as electrified rails that provide electric power, satellite/roadway navigational aids, automated braking systems, back up radar monitor systems and the like have limited or no use in electric boats. Thus, the electric boat industry cannot rely on aftermarket parts and solutions from these other industries but must invest in and exploit new technologies that solve the particular problems of electric boats.

Improved batteries and motors are the automotive technology advances that seems to relate most to electric boating. Recent developments in permanent magnet direct current motors that utilize high powered rare earth magnets, as exemplified by the Lynch motor taught in U.S. Pat. No. 4,823,039 are greatly welcomed. Such motors are expected to bring great improvements to the industry. However, most motors still are limited to having optimum performance peaks at a narrow or limited range of speed and load. Moreover, even the best motors, which utilize rare earth element high powered permanent magnets generally have low efficiencies at low speed.

A review of advances in the electric motor field would not be complete without acknowledging the improvements made by David Tether, including, among other things, permanent magnet motors having planetary/sun gear arrangements that provide significant advantages for regeneration and for use in watercraft, especially sailboats, as represented in U.S. Pat. Nos. 5,575,730, 5,067,932, 5,851,162 and 5,863,228. Also, the “ecycle” motor (see www.ecycle.com) promoted and refined by Daniel J. Sodomsky, which has many desirable attributes, with high performance magnets in the rotor and generally high performance overall. These motors alleviate many problems but still, like other motors before them, generally have highest efficiency at a high rotational speed. Thus, a general problem with applying electric motors in watercraft is that motor efficiency drops off at low speed and propulsion efficiency drops off at high speed. The relative lack of discussion of these phenomenon reflects the fact that most motors designers take the problems for granted. It should be noted in this context that shunt wound motors sold in watercraft from the Electric Launch Company of Highlands, N.Y. seem to be controlled by a circuit that independently drives the two coils. However, details of the algorithm used have been kept from the public and the control circuit is sold in a permanent opaque block of epoxy, and details of the circuit appear not to have been published.

Another problem in the watercraft industry that appears to have been overlooked generally is the need to match propeller slip with boat output at different watercraft velocities. Typically, a fixed propeller of a watercraft is chosen based on optimum performance of a given motor and boat at high speed or at low speed, or a compromise between the two speeds. During use, the operator merely increases power to the motor without regard to propeller slippage until the watercraft reaches a desired speed. This strategy may suit the operation of boats that have a maximum speed of only a few knots and may be appropriate for fossil burning watercraft in an era of very cheap energy. However, high speed personal watercraft, particularly heavy ones that can travel fast may require time to reach high speeds, and excessive propeller slip becomes more of a problem that noticeably affects efficiency of battery use, fuel cell power use and hydrocarbon combustion use in fossil fueled watercraft. Furthermore, the very high propeller slippage condition of cavitation becomes greater as higher revving motors are used to achieve higher speeds. These problems generally have remained unrecognized in the commercial electric boat industry (in particular, pleasure craft less than 35 feet long), which is best suited for electric controls because this industry focuses on slow boats limited to their displacement hull speeds.

Yet another problem with many electric motors used for watercraft is the mechanism used for removing excess heat. In many terrestrial applications an electric motor is air cooled. In boats, however, the moist and often salty marine environment is inhospitable to many materials used. Special materials and finishes may be required. A particular problem in this regard is when the entire motor is sealed. Trolling motors have been designed that rely on transfer of heat from an exterior case that surrounds the motor, with water. Such motors are generally thought as not very reliable for long term use. In some cases, an enclosed motor case cannot completely contact water, and heat build up is a greater concern. As trolling motors become more widely used for a variety of new boat hull designs that limit contact of water with the motor case, removal of heat will become more of a problem. Use of a separate pump with its own electrical circuit and pipes adds an extra level of complexity which undesirably increases costs and presents further opportunity for breakdown. A passive system or simpler system would advance this art.

Yet another problem is that control systems such as auto pilots have been developed primarily for complex operation in larger vessels, where high cost systems have been first adopted and operators are accustomed to training. Simple one button or twist knob analog operation of simple controls such as auto heading is desired by many pleasure boaters who may not want to read an operation manual before using a control.

Yet another problem in the watercraft industry is the propensity of spinning propellers to collide with solid objects, thereby shearing the propeller and/or damaging people and wildlife. According to statistics kept by the U.S. Coast Guard, scores of people are killed or severely maimed each year from propeller injuries. Other mammals such as manatees are severely injured and disfigured and this problem threatens the tourism industry in areas such as Homosassa Springs State Park in Florida. The boating industry has struggled with this problem without much success for some time. The often proposed solution of using a mechanical propeller guard to physically block contact, while logical at first glance actually is very impractical, despite a number of attempts to implement this idea as described in U.S. Pat. Nos. 3,889,624; 4,411,631; 44,826,461; 4,078,516; 5,238,432; 4,957,4459; 5,009,620; 4,304,558; 5,759,075; 4,565,533; and 4,106,425. The guard would rob too much propulsion power and in some cases could increase the occurrence and severity of propeller injuries because the guard can act as a catch that prevents easy removal of a hand or foot from the propeller vicinity as commented on, for example by the Superior Court of Pennsylvania (Fitzpatric v. Madonna, 623 Aa.2d 322 1993), which stated that “the presence of a shroud over the propeller presents its own risks for swimmers. For example, a shroud creates a larger target area. In addition, the possibility exists that human limbs may become wedged between a shroud and the propeller, exposing a swimmer to even greater injury.”

New propeller guard solutions have been proposed in view of the disadvantages of using a propeller guard. One such proposal is a guard that moves away from the propeller at high speed as described in JP5,310,188. Another is a switch on a ladder that prevents a fossil fueled motor from engaging when a swimmer's ladder is down, as described by Propeller Safety Technologies (Anderson Calif., www.propguardinc.com). A kill switch may prevent the problem of a passenger falling into the water during rapid boat movement. However, swimmers remain at risk of sudden contact with a boat at high speed. Others have mused over the possibility of sensing objects in the water (http://www.rbbi.com/invent/guard/propg/intro.htm) in a helpful effort to try and bring research groups working on animal and human detection in the water to think of this problem. However, there has been no solution that suitably accounts for the problems of motor inertia and the need for very rapid reaction times. Furthermore, most proposed solutions also do not address sufficiently the related problem of propeller contact with solid objects such as rocks while in operation. When the propeller is spinning rapidly during the contact, the propeller blades tend to quickly shear or grind down on the collided object, and can slice a human body many times in just one second.

The boating industry needs a low cost solution to propeller contact with solid objects. The issue of safety will become even more of a problem as the waterways become more and more crowded due to the obvious overpopulation and consequent egregious overuse of the limited resources of the planet. Accordingly, a system to prevent or alleviate this problem would help promote the boating industry make the waterways safer and allow even more commercially desirable overcrowding while minimizing damage from open propellers.

Propeller control and other motor control could benefit from simple and convenient torque control transmission/clutch systems by increased energy efficiency and improved safety. Energy efficiency is a major concern that affects nearly every aspect of society. Transportation in particular is a heavy consumer of portable energy through the use of gasoline, diesel or natural gas powered internal combustion motors. Most energy from a transportation fuel dissipates as heat because of inefficiencies during chemical energy conversion into mechanical work. A major inefficiency is the mismatch between a faster rotating motor shaft or gear and a slower rotating device that receives such energy such as a wheel of a car or propeller of a boat.

A variety of transmission systems have been developed to minimize these losses. Unfortunately, each system has its own inefficiencies and problems. For example, in the case of powered watercraft that employ a fixed gear ratio, energy is lost from friction in the reducing gear and also in the propeller of such drive systems because the small propellers used represent a compromise and rotate at a much higher than ideal rate to push water efficiently. Ideally, a fast rotating motor with a high power output and with shaft speed of about 3,000 or 4,000 rpm should be geared down to a much slower rpm of a few hundred rpm, but with higher torque as needed to push water with a (preferably) large, slowly revolving propeller. Inexpensive gears and transmissions generally are not available for such high ratio speed changes. Accordingly, modern pleasure watercraft at low to medium speed generally are operated at lower than desired efficiencies.

David Geer has described this low efficiency problem of moderate speed watercraft (Propeller Handbook page 79) as “[f]or a given horsepower, the slower the shaft RPM and the larger the diameter the more efficient the propeller will be. This is true for every installation, unless the boat speed will consistently be above 30 or 35 knots. Accordingly, in selecting a propeller you should always start with the largest diameter possible for the given hull, and work from there . . . . Draft limitations, hull shape, and tip clearances . . . are nearly the only factors that should cause you to consider a smaller diameter for slow-to-moderate speed craft. Another practical limitation is that while reduction gears with ratios as great as 6 or 7 to 1 are available for larger marine engines of, say over 250 hp (185 kw). standard reduction gears . . . are seldom available with ratios larger than 3 to 1 . . . . ” According to this reasoning, a highly efficient and simple gear reduction of greater ratios approaching 10 or even 20 fold would give great benefits for many watercraft but is not readily available for regular watercraft.

A related problem is the need to rapidly stop a propeller, conveyor or other equipment upon detection of an unsafe condition. For example, a spinning propeller poses great hazards to swimmers and other waterlife. A rapid propeller stop system, is highly desirable but generally not considered because of the extreme difficulty in rapidly stopping a propeller. A limitation in this regard is that most propeller shafts are permanently fixed to a motor, either directly or indirectly through reduction gearing and rapid stoppage would overstress the drive system, due to the inertia of moving parts. Although not generally appreciated, a power transmission link between motor and propeller that both provides a high rotational speed change and the ability to rapidly stop a connected propeller would potentiate technological advances in electronic propeller guard systems. Unfortunately, such system generally is not available.

A large variety of gear reducers, clutches and other power transmission devices have been developed for many transportation machines. New types of clutches have evolved particularly for fans and air conditioners on cars and trucks and have provided incremental but highly desirable efficiency improvements for some applications. For example, a series of patents from Larry Link describe an electric clutch that electromagnetically disengages a fan as needed to minimize drag on an engine when the cooling fan is not required. See, for example, U.S. Pat. Nos. 6,129,193; 6,230,866; 6,331,743 and 5,947,248; which teach the use of radially disposed electromagnets and a concentric set of pole pieces separated by an air gap. The torque transfer is modulated by controlling electric power to the multiple radially disposed electromagnets. This system promises to overcome frictional losses engendered by the widely used viscous clutch systems. However, the Link device appears to generate a considerable amount of heat, the electromagnets generally are rotating and need an electrical supply through a slip ring, and the entire system requires numerous parts. Furthermore, the energy efficiency of the Link system, which is notable by its omission from the copious documents that describe this technology, apparently is low. This view is supported by the Link disclosures, which emphasize multiple features that generally had to be added to remove heat buildup from the frictional losses, which again indicate that the system is inefficient.

Magnetic systems have been described for coupling other rotating axles as well. Masberg et al. (U.S. Pat. No. 6,149,544) teaches a coaxial (rotating cylinder within a rotating cylinder) dual electromagnet system that offers a stator body and a housing, which in some embodiments resembles a motor that couples two axles as a magnetically controlled clutch. This system is complex and generally requires a three dimensional magnetic assembly that maintains close tolerances in a dimension along the axis of rotation. Magnetic fields interact that are perpendicular to the rotational axis. The device is not unlike that of a regular induction motor, with the armature connected to a first axle and the field coil rotating and connected to a second axle.

Another interesting coaxial electromagnetic coupler is taught by U.S. Pat. No. 5,565,723, which emphasizes an internal electrical feedback to obtain a desired torque speed characteristic. The apparatus taught in this patent also uses two coaxially oriented rotable parts with inner and outer cylinders of electromagnets that exert magnetic coupling forces, which are perpendicular to the axis of rotation. This system as well appears very complex, and has slip rings to apply electricity to moving electromagnets. Such complexity is undesirable, particularly for applications in the marine environment, where exposed electrical connections and conductors need to be marinized.

Despite a wealth of technology in the automotive and related arts, transmissions that provide high gear ratios and inexpensive, durable rapid acting clutches are not widely used for regular pleasure watercraft and other applications such as screw conveyors, elevators and related devices. In the case of watercraft, durable and cost competitive gear reducers of gear ratios less than 4 to 1 generally are used and rapid disconnect of propellers from the drive train is not carried out because of technology and cost limitations. While not recognized as such, these limitations are taken for granted and specific watercraft installations are optimized with inherent built in equipment limitations. For example, a specific boat with a specific boat motor generally is matched with a specific propeller that meets a selected criteria for best torque, motor speed, and motor output for a single optimum boat speed. Consequently, most drive systems are limited to a single gear reduction ratio and a single optimum propeller/boat combination that is chosen partly based on such a specific combination.

Similar limitations exist for other applications such as conveyors. Any device that provides greater flexibility in torque conversion between an upstream driving axle, such as a crankshaft or other drive gear and a downstream axle, such as a propeller shaft or other gear would advance the art of mechanical energy conversion by allowing a broader range of conditions for optimization. In the example of a torque converter for a propeller driven watercraft, better optimization of boat speed for optimum efficiency, and motor or motor conditions would be possible if a suitable torque converter were available that was efficient over a wide range.

Another problem in the watercraft and other industries is the monitoring and control of batteries and fuel cells. The reliance on batteries and fuel cells present new challenges for monitoring and control. For example, most land vehicles and watercraft used today contain one or more tanks filled with a hydrocarbon such as gasoline or diesel to supply an internal combustion engine. The economics of using such power supplies is fairly straightforward. The hydrocarbon fluid is sold by the volume and the tank used to hold the fluid during use has a virtually trivial cost. Accordingly, the cost of using the energy per unit time or per unit distance traveled is a generally straightforward process of dividing a standard time period or distance by the cost of the fluid itself. An operator routinely monitors the status of the power supply with a gauge that displays the amount of hydrocarbon fluid remaining. In the case of an electric battery powered device, a power supply gauge often is used that shows how much of the original battery energy remains at any given time.

A vehicle operator often needs to know more than merely the amount of energy remaining while operating a vehicle. In order to save money the operator may need to determine the relative or absolute cost of a given throttle setting or other controlling parameter(s). Generally speaking the highest throttle (energy supply use rate) setting yields the highest speed, but is the least efficient use of energy. In many cases the operator chooses to sacrifice a small amount of speed for a commensurately greater reduction in energy use rate. This relationship between energy use rate and speed, or distance traveled may be provided by the manufacturer, who may recommend “cruise” power settings or the user may learn a more efficient power setting from experience.

The relationship between power setting and efficiency of vehicle or watercraft movement may be provided in real time to the user by an efficiency gauge. Such gauge may display a relative or absolute energy use rate such as gallons of fuel per hour or fuel per mile. In the electric boat industry, such gauges sometimes are used to show instantaneous energy use (generally amperage rate, but for greater accuracy would display watts).

These systems assist the internal combustion engine operator by indicating the efficiency of energy use. However, the systems and meters developed heretofore generally are less suitable for newer power sources used with electric motors, such as large battery banks that have large and variable installation costs, depending on how deeply the battery bank is discharged, and hydrogen fuel sources, which often require differing amounts of energy to operate, depending on the state of depletion. Gauges are needed to accommodate these new energy sources and can save the watercraft operator considerable time and money by informing the state of the power supply more accurately.

A related problem is the need to monitor the long term deterioration of the energy supply bank or conversion unit. While not readily appreciated by many workers in this field, fuel cells and hydrogen absorption-desorption storage systems, which presently are tested but for which superior designs are in development, like batteries, generally age depending on how they are used. Accordingly a monitor of such use or aging can help save resources by providing valuable information to the operator. Looking to the future, the problem of hydrogen storage in watercraft, unfortunately likely will be dominated by work in the automotive industry. On the other hand, watercraft have special features that generally are overlooked but which should be useful for designs that take advantage of watercraft and provide unique advantages for the commercial exploitation of fuel cells in watercraft.

In sum, much of the technology for watercraft, including both internal combustion power watercraft as well as (and/or) electric motor driven boats has developed from the automobile and golf industries. Further, present commercial electric pleasure craft are designed primarily for low speed operation and manufacturers have not seriously challenged the limits of motor performance. Yet further many of the control systems, monitors and devices used in fossil fuel powered watercraft follow their counterparts in the auto industry and much needs to be done to exploit electric technology for all types of watercraft. Any motor control, energy storage, or other control and monitoring system that improves the overall efficiency and convenience of pushing a boat would yield rich dividends in extending the performance of the power supply and in gaining further public acceptance of products from this industry.

### SUMMARY OF THE INVENTION

A number of discoveries were made that lead to improved propulsion efficiency and convenience, and improved monitoring and control of propellers, motors, batteries and fuel cells. These and other advantages will be appreciated by a reading of the specification.

One embodiment is an electronic motor control that alters the motor speed/torque output at varying boat speed to more closely match the increasing torque requirements of an attached propeller at increasing boat speeds. One such embodiment of a brushed motor is carried out by altering the armature voltage to change speed, while altering the magnetic field (fixed coil) around the armature, using at least two different magnetic field strengths on the fixed coil, with higher magnetic field(s) at lower rpm and lower field(s) at higher rpm. In a related embodiment, the magnetic field surrounding the armature is altered to at least three values of increasing magnetic strength with increasing rpm. In yet another embodiment the magnetic field is altered to at least 4 values. In yet another embodiment the magnetic field is altered with an algorithm or look up table to determine an increasing magnetic field for a higher rpm range to provide a smoother transition through more than 4 magnetic field strength values.

In yet another embodiment a permanent magnet magnetic field is modified by a superimposed electromagnetic field that optionally may increase the combined field at higher rpm to achieve higher torque and that may be reversed and subtracted from the field at lower rpm to achieve better lower speed efficiency. In yet another embodiment a permanent magnet magnetic field is modified by a superimposed electromagnetic field obtained by two separate electromagnets, which preferably comprise at least one inner electromagnet and an outer electromagnet. At higher torque (greater rpm) the inner magnet is progressively excited and at lower torque at lesser rpm the outer magnet is progressively excited more. In another embodiment the distance between the rotor and stator (or field and rotor) is adjusted to modify the magnetic field(s). In another embodiment the reluctance of the magnetic path between stator and rotor is modified for less magnetic field strength at lower rpm.

Another embodiment is an electronic control method for enhancing the efficiency of electric motor driven propeller watercraft comprising detecting the speed of the watercraft directly or indirectly, detecting the rotational speed of the electric motor, comparing the result of step (a) with the result of step (b) to estimate an expected propeller slip, and adjusting power to the motor to achieve a desired propeller slip. In other related embodiments, the first step is carried out by a procedure selected from the group consisting of detecting a signal or difference from a GSA receiver; detecting a signal or signal difference from a speedometer; and inputting a value from by a computer that monitors one or more electrical variables of the motor such as power, voltage or trip running time; the second step may be carried out by a procedure selected from the group consisting of detecting the motor rotational speed; indirectly determining the motor speed by detecting the current in the motor armature, the voltage of the motor armature, the impedance of the motor armature, the current in the motor field winding, the voltage of the motor field winding, and/or the impedance of the motor field winding; and detecting the propeller speed via magnetic or optical sensing. In related embodiments the desired propeller slip is less than 50%, and the rotational speed of the electric motor is determined by sensing the voltage of the motor power. In another embodiment the motor is adjusted to provide lower slip with faster boat and propeller speeds.

Another embodiment is an electronic control for enhancing the efficiency of electric motor driven watercraft a having a propeller over a range of speeds comprising a propeller rotation speed signal, a motor power controller, and a comparator for monitoring the propeller rotation speed signal, wherein the controller increases power to the motor by an increment and waits while the comparator detects when the propeller speed signal has reached a steady state or near steady state level, after which the controller increases power again. In further embodiments the propeller rotation speed signal is motor drive voltage, and the comparator repeats incremental increases until a desired endpoint power is reached.

Another embodiment is an electronic control for enhancing the efficiency of electric motor driven watercraft a having a propeller over a range of speeds comprising a motor power signal, a motor voltage controller; and a comparator for monitoring the motor power signal, wherein the controller increases voltage to the motor by an increment and waits while the comparator detects when the motor power has reached a higher steady state or near steady state level, after which the controller increases voltage again. In related embodiments the motor power signal is motor current, and the comparator repeats incremental increases until a desired endpoint motor voltage is reached.

Another embodiment is an electronic control device that controls propeller slip of an electric motor powered watercraft, comprising a detector of propeller speed, a detector of the watercraft's speed, and a circuit that controls power to the armature of the motor, a field winding of the motor or both, wherein a signal from the detector actuates the circuit to adjust propeller slip according to a predetermined relationship between propeller and boat speed. In related embodiments the detector is selected from the group consisting of a motor speed detector, voltage input to the motor, an optic or magnetic sensor of propeller speed and a computer that monitors power and time to estimate approximate speed; a watercraft contains such electronic control devices; the circuit decreases power to the motor when the propeller speed exceeds a predetermined limit for a given boat speed; the predetermined relationship between propeller and boat speed may be a single value for all boat speeds; and the electronic control device further comprises at least a second control condition that increases the allowable propeller slip to provide higher slippage for greater acceleration.

Another embodiment is a non-mechanical electronic control system for inhibiting cavitation of a propeller driven electric powered watercraft, comprising a boat speed monitor, and a control circuit, wherein the control circuit monitors motor voltage as an index of propeller speed and decreases motor power when the motor voltage is too high for a given boat speed. In related embodiments the control circuit contains a microprocessor look up table of motor voltage versus boat speed values for use in determining when to lower motor power; and the control circuit further comprises a first electronic comparator circuit or software subroutine that compares the motor voltage with boat speed and a second comparator circuit or software subroutine that compares the results of the first electronic comparator circuit or software subroutine with a reference value and outputs a motor power decrease signal when the comparison shows that the reference value has been surpassed.

One object is to provide a continuous optical readout in real time of propeller slip over a wide range of boat speeds. This readout allows the boat operator to optimize electric motor power for more efficient travel even at low speeds where cavitation is not a major concern.

Another object is to alert the boat operator to an adverse condition such as low speed cavitation, high (near hull displacement speed) cavitation, high planing or semi planing speed cavitation, excessive loading, fouled propeller and the like.

Yet another object is to provide autonomic control by setting a given desirable speed adjust motor power to obtain an efficient acceleration rate, adjusting motor power to obtain a desired cruising speed, adjusting motor power to decrease cavitation and the like.

In another embodiment propeller slip is expressed on a continuous scale via an analog meter having two or more regions indicating acceptable slip and unacceptable slip. In a preferred embodiment the analog meter display face contains areas, from left to right showing deceleration conditions (typically blue, black or white colored), acceptable economy acceleration (typically green colored), higher acceleration (typically yellow colored) and excess slippage (typically red colored). Another embodiment utilizes at least two light emitting diodes to display acceptable acceleration slip (typically green colored) and excess slippage (typically red colored). In another embodiment a series of light emitting diodes are arranged to display at least three conditions. In yet another embodiment a single light emitting diode is used to indicate excess slippage, and yet another embodiment a buzzer or other audible warning device is used to indicate excess slippage. In each embodiment an audible alerting device, such as a piezoelectric horn preferably is used to indicate gross excess slippage indicating cavitation.

Another object is to detect low speed cavitation separately from high speed cavitation or excess slippage that occurs at or near the boat hull speed. One embodiment pursuant thereto is an electric boat propeller efficiency indicator comprising an analog meter having a display surface with at least two visual indicator areas that indicate desirable slip and excessive slip, wherein the indicator areas are located at the left side and right sides, respectively. Another embodiment is a readout system for continuously reporting electric boat propeller efficiency in a displacement hull vessel, comprising: (a) a transducer or other device that outputs an electrical signal proportional to propeller speed; (b) a means for generating an electrical signal proportional to boat speed; (c) a signal generating unit that outputs a visual and/or auditory signal indicating propeller efficiency.

Another embodiment is a visual display system for continuously indicating electric motor driven boat propeller efficiency comprising: a) a propeller rotational speed electrical input; b) a comparison signal electrical input; and c) a visual indicator, wherein the signal input of (b) is compared with the propeller speed signal input of (a) to generate a continuous output analog or digital signal used by the visual indicator to continuously indicate propeller efficiency.

Another embodiment is a visual indicator of electric boat propeller efficiency comprising: a) a transducer that generates an electrical signal proportional to propeller rpm; b) a transducer or other device that generates an electrical signal proportional to boat speed; c) a comparator that compares the signal of a) with the signal of b) to output a comparison signal indicating relative propeller slip; and d) a visual output indicator that indicates relative slip.

Another embodiment is a simplified heading cruise control for a watercraft, comprising one or more ratiometric output geomagnetic sensors mounted to the watercraft and that output one or more analog signals that correspond to geomagnetic heading, a circuit that analyses the signal(s) from the one or more geomagnetic sensor(s) to output one or more correction signals for altering course, and a maximum of one on/off switch on the watercraft dash required for activating the cruise control. In related embodiments the simplified cruise control further comprises a propeller speed or boat speed signal that automatically turns on the heading cruise control upon exceeding a set speed to allow automatic heading correction at higher cruise speeds; a switch mounted on at least the motor throttle or steering wheel control, wherein activation of the switch turns the heading cruise control on or off; the switch mounted on the motor throttle or steering wheel control is a body capacitive switch that is activated upon electrical contact between skin of the watercraft operator and the throttle or steering control; and further comprises a rotating knob for directly setting a desired course, wherein the one or more ratiometric output geomagnetic sensors are attached to the rotating knob and rotate with the knob.

Another embodiment is a cavitation indication device for an electric motor driven watercraft comprising: a) a transducer for generating an electrical signal proportional to propeller rpm; b) an electrical comparison signal proportional to motor power, motor current, and/or boat speed; and c) a visual or audible readout signaler that indicates the presence of low speed cavitation during acceleration and high speed cavitation near displacement hull speed.

Yet another embodiment is a cavitation indicator for a displacement electric motor driven watercraft, the indicator capable of detecting acceleration cavitation separate from cavitation occuring near hull speed, comprising: a) a transducer for generating an electrical signal proportional to propeller rpm; b) a reference electric signal that is proportional to motor power, motor current and/or boat speed; c) a comparator that receives signals from a) and b) wherein the comparator uses the signals from a) and b) to detect low speed acceleration cavitation, no cavitation and high hull speed limiting cavitation conditions; and d) an output device.

Yet another embodiment is a device for alleviating cavitation of an electric motor driven watercraft comprising: a) a transducer for generating an electrical signal proportional to propeller rpm; b) a reference electric signal that is proportional to motor power, motor current and/or boat speed; c) a comparator that receives signals from a) and b) and outputs a cavitation detection signal upon detecting cavitation; and d) an electronic controller for adjusting motor power and/or rpm upon generation of the cavitation detection signal.

Yet another embodiment is a visual display for continuously indicating motor driven boat propeller efficiency comprising: a first electrical signal proportional to boat speed; a second electrical signal proportional to propeller speed; a circuit that accepts the first electrical signal proportional to boat speed and the second electrical signal proportional to propeller speed and compares the two signals to generate a slip measurement that is output; and a signal display that accepts the output measurement selected from the group consisting of an analog meter with a display surface having at least two colored areas denoting acceptable efficiency and less optimum efficiency; an analog meter with a display surface having green, yellow and red lights or colored areas that respectively indicate acceptable, less acceptable and least acceptable efficiency, an analog meter having a display surface with at least 3 regions located from left to right as indicating negative slip (deceleration), acceptable slip and excessive slip (or cavitation) respectively respectively; a display surface having multiple light emitting diodes denoting at least an acceptable efficiency and a less acceptable efficiency; and a liquid crystal display, wherein a greater acceptable slip at lower speed is factored into the comparison by the circuit of or is accommodated by the display to indicate acceptable slip

Yet another embodiment is a device that can detect an anchor down or propeller up situation or another unusual loading condition for a propeller comprising: a) a transducer for generating an electrical signal proportional to propeller rpm; b) a reference electric signal that is proportional to motor power, motor current and/or boat speed; c) a comparator that receives signals from a) and b) and outputs an anomalous propeller loading signal upon detecting a high slip condition at low propeller speed and low boat speed; and d) a signaling device that audibly and/or visually alerts the boat operator upon detecting a propeller down situation.

An embodiment of the invention provides a system for quickly stopping a propeller before the propeller can significantly damage a solid object that appears immediately upstream of the propeller. In embodiments an electronic sensor detects a solid object that enters a danger zone near the propeller and triggers a circuit that rapidly stops the propeller. In other embodiments a device records, monitors and reports in real time instances of sensing imminent contact of a propeller with a solid object.

Another embodiment provides a system to limit contact of a propeller having a diameter D with a solid object in a motor driven watercraft comprising at least one sensor that monitors a danger zone, the zone comprising a circular area of diameter D located distance D immediately ahead of the propeller perpendicular to the direction of motion and outputs a signal in response to intrusion of a solid object in the danger zone; and an activator electric control circuit that stops motor movement upon receipt of the signal.

Another embodiment provides a watercraft that contains a system for limiting propeller contact with a solid object in the water, comprising at least two monitor sensors attached to one or more control surfaces in the water and upstream of the propeller that output an electrical response upon detection of the solid object; and an electric control circuit that accepts the signal and stops motor movement upon the detection of the solid object.

Yet another embodiment provides an electrical control device for suddenly stopping a propeller in a motor driven watercraft, comprising a sensor that detects a solid object near the propeller and a control circuit that can stop or slow the propeller to less than 10 rpm within one second, wherein the sensor triggers the control circuit upon sensing the solid object.

Yet another embodiment provides a hydrogen power supply that is particularly useful for watercraft. An embodiment provides a buoyant hydrogen reservoir within a hull, under a seat and/or in other locations where ballast or buoyancy materials often are used. In another embodiment hydrogen such as compressed hydrogen or hydride bound as metal hydride or to carbon or other material is stored under the water. Yet another embodiment provides a monitor for determining the health of a hydrogen binding system reservoir. Yet another embodiment provides a battery or other power supply efficiency meter that accounts for the cost of replacing the power supply.

Other embodiments will be appreciated from a reading of the specification and of the priority documents referenced herein.

### DESCRIPTION OF THE DRAWINGS

FIG. 1 shows engine and propeller power curves as relative horsepower (increasing up the vertical axis) versus relative revolutions per minute (increasing RPM to the horizontal axis).

FIG. 2 shows a desirable propeller slip (vertical axis) versus boat speed (horizontal axis).

FIG. 3 shows an electronic steering device that comprises a rotating platen with 6 hall effect sensors mounted within it.

FIG. 4 shows a representative block diagram for using the electronic steering device of FIG. 3.

FIG. 5 shows a representative propeller slip versus boat speed curve for a range of watercraft speeds.

FIG. 6 is a block diagram of an embodiment that shows a simple circuit for an efficiency meter that compares a propeller speed signal with a boat speed signal and outputs a signal starting at zero level indicative of positive slip.

FIG. 7, is a block diagram of an embodiment that shows a circuit for an efficiency meter that compares a propeller speed signal with a boat speed signal and outputs a ratio signal indicative of negative slip, near zero slip and positive slip.

FIG. 8 shows representative optical readout displays useful for embodiments of the invention. FIG. 4a shows a multiple light emitting diode block meter with 10 different segments. FIG. 4b shows a multiple light emitting diode meter with 8 segments arranged in a partial circle to simulate an analog device. FIG. 4c shows a design that provides more meaningful information in the form of a slope.

FIG. 9 shows three representative analog meter faces useful for embodiments of the invention. Each quadrant of each meter face is a different color.

FIG. 10a shows a side view of two sensor and 4 sensor systems for detecting imminent propeller contact with a solid body.

FIG. 10b shows a side view of an 8 galvinometric electrode sensor system in a two control surface system for detecting imminent propeller contact with a solid body.

FIG. 10c shows a side view of a boat hull mounted 2 sensor system for detecting imminent propeller contact with a solid body.

FIG. 10d shows a side view of a boat hull mounted 6 sensor system for detecting imminent propeller contact with a solid body.

FIG. 11a shows a sonic sensor system that directs emission and/or detection of sonic vibration away from the propeller to limit spurious signals produced by cavitation.

FIG. 11b shows detail of a sensor for the system of FIG. 2a.

FIG. 12a is a rear view of a two sensor system (on two control surfaces) for detecting imminent propeller contact with a solid body.

FIG. 12b is a rear view for a three sensor system (on three control surfaces) for detecting imminent propeller contact with a solid body.

FIG. 12c is a rear view for a four sensor system for detecting imminent propeller contact with a solid body.

FIGS. 13a through 13c show front and side view respectively of how one, two and three sensor systems may be used for detecting imminent propeller contact with an outboard electric motor.

FIG. 14a shows a bottom hull view of a two sensor system on a boat hull for detecting imminent propeller contact.

FIG. 14b shows a rear hull view of a three sensor system on a boat hull for detecting imminent propeller contact.

FIG. 15 shows a representative tactile sensor placement in accordance with an embodiment of the invention.

FIG. 16 depicts a life cycle vs depth of discharge for a battery.

FIG. 17a shows an analog meter that displays battery health. A red or orange color is positioned on the left end, green on the right end, and yellow in between.

FIG. 17b shows an analog meter that displays battery health. The left side has a mark (“0” shown here) indicating that insufficient or low charge cycles remain. The right side has a mark (“200” shown here) indicating that high number of charge cycles remain available for the battery.

FIG. 17c shows an analog meter that displays state of charge, having an indicator light that activates when battery impedance has risen to indicate battery replacement is needed.

FIG. 17d shows an analog meter that displays state of charge, and also displaying battery health with a horizontal bar

FIG. 17e shows a dual gauge meter that displays both state of charge (left needle) and battery health (right needle).

FIG. 17f shows a vertical bar meter with 6 sections that indicates battery health.

### DETAILED DESCRIPTION OF THE INVENTION

Motor Controls and Cooling Designed for Boats, not Cars

The electric boat industry generally has been copying the electric car industry too much and has neglected important aspects of boat propulsion that limit the use of motors, their cooling systems and control systems as designed for cars. For example, unlike automobiles and golf carts which present a heaviest load to a motor at low speeds, a propeller on a boat at low speed usually presents very little torque load to a motor but increases load proportionately greater as RPMs increase. A motor designed for automobiles does not increase output power as fast with increasing RPM compared with the needs of a propeller. Also, unlike cars and golf carts, a boat motor always is near a large body of water (an excellent heat sink) when in operation.

The general copying of car systems for much of electric and fossil fuel boating has led, in many cases to suboptimum performance in various areas such as power/torque for a given condition, motor and battery cooling systems, and power monitoring and control. Furthermore, problems more unique to boating such as the need for directional control of the vehicle have not been addressed adequately. Embodiments pertaining to these areas are presented in turn below.

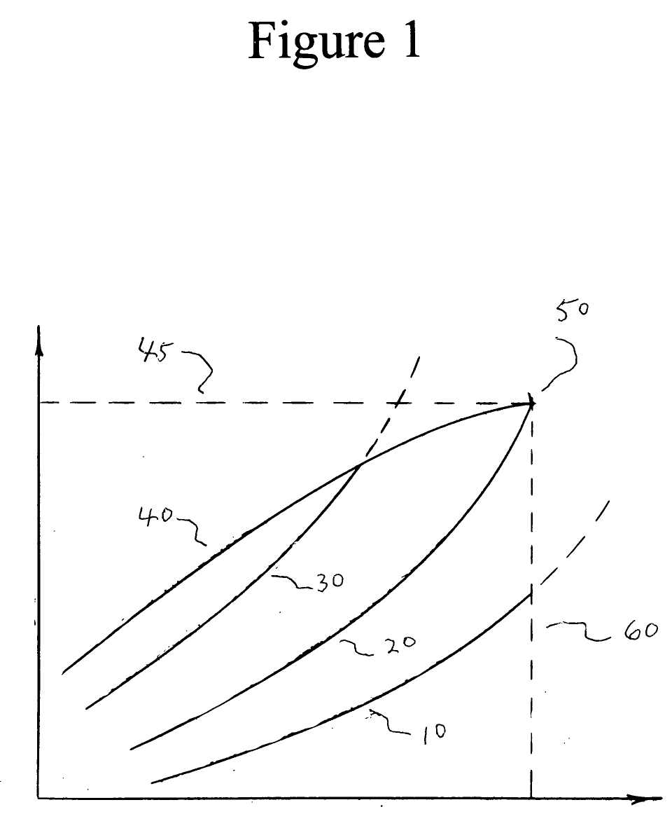

Optimum Power/Torque for a Given Condition The power requirements of a boat propeller with respect to motor output are exemplified in FIG. 1. The X axis of this figure shows increasing RPM. The Y axis shows increasing horsepower. Curve 10 of FIG. 1 shows the power to rotation speed relationship for a propeller that is less than optimum propeller size. Curve 20 shows an ideal power curve for a well-matched propeller and curve 30 shows the power curve for an oversized propeller. These curves show that, regardless of the propeller size, the power needed to drive the propeller increases more than linearly with increase in shaft rpm. In contrast, a typical motor power output increases less than a linear rate as seen by curve 40 until reaching a maximum horsepower (line 45) in FIG. 1. This means that such motors are well matched to a propeller only at one point (line crossing point 50). In fact, a motor typically is matched to meet the propeller power input need at only 70 to 85% of the top rated motor speed. That is, a motor is selected having a power output in a region as seen in FIG. 1 where curves 20 and 40 meet at “max rpm” line 60.

At engine power versus rpm ratios higher than for an ideal match (ideal match as shown in FIG. 1), the engine can produce more power than the propeller can absorb and the propeller will either speed up to create greater slippage in the water and waste energy or the motor will draw less current at the same rpm, and will operate outside of its maximum efficiency power band. That is, a motor may have great efficiency under one set of conditions, but those conditions may only exist for a short time of actual use. This is because for a given rpm the motor is most efficient for a particular power output. Many embodiments alleviate this situation by adjusting an otherwise constant magnetic field of the motor. Embodiments improve performance (optimizing slip) by increasing or decreasing power for a given rpm, typically by increasing power for high rpm and decreasing power for a lower rpm. Some embodiments of methods determine a suitable correction for particular desired speed point such as a “sweet spot” for a given motor/propeller combination that an operator tends to use most often. A “sweet spot” refers to the fact that a particular boat configuration has a particular (usually more efficient) performance at that speed, which a boat driver may favor.

In other embodiments, a range of speeds is corrected by an offset factor to adjust (for example) current to an electromagnet to optimize power/RPM for increased torque at higher speed and decreased torque at lower speed. In yet other embodiments a look-up table in a computer is used.

In preferred embodiments the engine HP (horsepower) output is corrected to increase more than linearly with respect to motor rpm. In a particularly advantageous embodiment the HP output increases 5-10% for every 3% increase in rpm. By way of example, if a motor spinning at 1000 rpm and producing 10 hp is increased to 1030 RPM then the motor at the new speed is adjusted to have a power output of between 10.5 and 11 hp. If the motor speed is further increased, the power output continues to increase by this same increment and so on, such that a doubling of rpm will provide a power increase of approximately 350% and preferably between 250% and 400%. In another embodiment field strength is adjusted by physical movement of field magnets (either permanent magnet(s) or electromagnet(s), preferably by solenoid). In another embodiment an electromagnet field coil contains different sections that are separately electrically modulated or switched to achieve differences such as lower field strength at lower rpm to get more efficient behavior over a wide rpm (and boat) speed.

Balance Magnetic Fields for Greater Boating Efficiency With the above in mind, the inventor studied and found motor and controller combinations that lead to greater watercraft propulsion efficiency. One discovery was that low speed performance, a boating condition that requires low torque (power to rpm) is improved by modifying the magnetic field strength outside the armature (“field” or “stator”) compared with that for high speed performance. Without wishing to be bound by any one theory of this embodiment, back emf of the motor is thought to inhibit further torque production as a motor increases speed. Decreasing the magnetic field surrounding the armature, by, for example decreasing the current in the surrounding field magnet., or increasing the air gap at higher motor speed reduces the back emf, thus permitting the motor to generate torque at higher speed. Accordingly the air gap is increased, the surrounding magnetic field is decreased somehow, or the ratio of armature magnetic field to the surrounding magnetic field is optimized to accommodate the needs of the boat at different speeds.

With this further insight, the inventor discovered that field weakening of the larger magnetic field would improve efficiency in boating applications. This is because the needed torque at low speeds is very low (with comparison with land vehicles) but increases with speed and the emf begins to more greatly limit the torque that can develop at the higher speeds. This feature is very different from that of electric motors used in automobiles and golf carts. During low speed operation in cars much stronger heavy magnetic fields are required to generate high torque particularly at low speed, whereas torque requirement is not so high at high speed.

In preferred embodiments the field weakening is adjusted (modulated by increasing or decreasing electrical energy) using feedback information from boat speed. By way of example, if an electrical boat speed indicator emits a signal that the boat is going 5 MPH, then a controller circuit would adjust the magnetic field strength (surrounding the armature) to a value appropriate for 5 MPH. A skilled artisan can appreciate also the more sophisticated embodiment wherein both armature field and outside field are adjusted for optimum (highest motor efficiency) for 5 MPH. In one very specific embodiment the armature field and the outside field strengths are kept approximately equal to each other (within 35%, preferably within 15% and more preferably within 7.5% of the same magnetic field as measured or calculated at the middle of the air gap between them) and both are increased as needed for higher boat speed (or decreased together for lower boat speed). In a low cost version of this embodiment electromagnets are used and power (watts) for each electromagnetic field is maintained within this ratio. In this case, the power supplied to the armature magnet and the power supplied to the outside field electromagnet(s) are kept balanced (of similar magnitude with respect to each other) within the above range measured in watts. In another embodiment however, the magnetic field of the field outside the armature is increased proportionately more than the armature field. In this embodiment the power to that field is increased 1-20% and preferably 5-1-% for every 3% increase in RPM, and results in greater than linear increase in torque with increasing RPM. In many instances the current is monitored and/or adjusted to achieve these ratios and field strength is inferred from electrical current.

In other embodiments the surrounding field is high at low rpm and decreases as needed for lower back emf to developed the higher torque needed as the propeller spins faster. One way to implement this is to decrease the magnetic field surrounding the armature at progressively higher speeds. A moderately high field is needed to start the motor from rest and this field is maintained until the back emf of the motor rises sufficiently to prevent further increases in the motor speed. The field strength then is progressively decreased by set values (such as by 1%, 2%, 3%, 5% at a time) and the motor speed monitored (by measuring voltage for example) to determine when the speed reaches a constant lower value (speed initially will be excessively high with high slip in the water) indicating that the boat speed has caught up to the propeller speed and good power transfer exists between propeller and water. Once the desired speed (or target constant rpm) is reached, the field for that particular speed is maintained so that the watercraft continues to run at the equilibrium point where the back emf prevents further acceleration. In preferred embodiments the boat operator will select a desired acceleration rate and/or final speed and the boat motor controller will automatically adjust the propeller speed through a time course to achieve smooth acceleration. In another embodiment, rather than adjust the field by decreasing or increasing its magnetic strength, the air gap between the stator and the rotor is increased or decreased respectively.

The embodiment of altering magnetic field with increasing propeller rpm may be very conveniently carried out by monitoring motor voltage (voltage at the motor itself, preferably) and motor current (or total power, current is easier to measure). Where power to the motor is easily controlled by controlling voltage (most common) the voltage to the motor is increased by a small amount, such as for example 1%, 2%, 3% or 5% of the total range. The motor current (or total power used) is continuously measured. When the propeller slips excessively due to the sudden increase in voltage, the current will be less, and the current will slowly increase again towards a steady state value. As that steady state is approached (or after the current becomes constant) the motor voltage is increased again and the process is repeated. The propeller slowly increases with controlled slip until a maximum value is reached. In an alternative embodiment desired voltage versus current readings are stored in the controller for a given propeller/boat/motor combination. The readings may be supplied by a manufacturer or by making a live calibrator run. In another embodiment instead of controlling motor voltage, motor current (or power) is controlled and motor voltage monitored to determine when a given increase in motor power has resulted in a newer higher settled motor voltage. Here, increasing motor current suddenly may suddenly increase voltage, which may slowly level off to a lower voltage as the propeller begins to slip less and transfer more power to the water. In a related embodiment the voltage or power is automatically increased slowly, as determined by the known relationship with monitoring both voltage and current.

In other low cost embodiments the boat speed is not monitored but a desired boat speed is set by a switch (either manually by the boat operator or automatically by a computer or other control circuit) for a range of speeds. For example, a boat motor fixed magnetic field could be set for “low speed operation” by setting a switch that controls the field outside the armature, or “high speed operation” by selecting a field suitable for higher rpm.

Use of Series Wound and Separately Excited Permanent Magnet Motors Field adjustment can be implemented in a variety of electric motors to optimize for performance at various speeds in a variety of motors. In a series wound motor the “field” coil energy (the coil is outside the armature) is strengthened at low boat speed and weakened at higher boat speed. This adjustment may be carried out by altering the effective impedance of the power supply. In contrast to a series wound motor in a golf cart, that draws highest current at lowest rpm and then draws less current at higher rpm, the same motor driving a propeller will draw less current upon acceleration and the motor will present a higher resistance. In a second embodiment the excitation of a “field” winding of a separately excited motor is altered as desired to optimize performance. In a third embodiment the permanent magnet field of a permanent magnet brushed motor is altered by excitation of an electromagnet fixed coil that produces a field that is aligned with (but of opposite polarity to) the permanent magnet field for higher torque and greater efficiency at high boat speed. At lower desired boat speed the permanent magnet field is augmented by current flow in the other direction, (the fields of the electromagnet and the permanent magnet being the same direction). Preferably the voltage to the motor gradually is increased during acceleration to higher boat speed.

In a fourth embodiment the back emf for a permanent magnet brush less motor is effectively decreased by increasing the space between that field and a surrounding field, by, for example, using two sets of windings in the fixed field, that are spaced at differing distances from the armature, which are differentially used. That is, at higher speeds proportionately greater current flows in the outer winding (compared to the inner winding) and at lower speeds greater current flows proportionately in the inner winding. Of course, three windings or more can be used according to this principle and other permutations of feeding different sections to achieve control can be derived. In yet another embodiment, the current applied to the motor is increased incrementally or by a slight amount (about 1, 2, 3, 4 or 5% for example) until the back emf of the motor (which can be measured as voltage) rises to a steady state, after which the current may be increased again.

In related embodiments active hysteresis-based control of winding currents and/or adjustable air gap is used, as is known or can be derived by a skilled artisan. The use of some of available windings at a time is particularly desirable for modulating the field strength. For example, see U.S. Pat. Nos. 6,348,751 and 6,137,203, assigned to New Generation Motors, which show representative adjustment mechanisms for air gap and coil selection to modify this physical parameter. Also see U.S. Pat. Nos. 5,880,548 issued to Lamb on Mar. 9, 1999; U.S. Pat. No. 5,837,948 issued to Aulanko on Nov. 17, 1998; U.S. Pat. No. 5,834,874 issued to Krueger on Nov. 10, 1998 and U.S. Pat. No. 5,646,467 issued to Floresta on Jul. 8, 1997. The materials and methods taught in these patents for modifying magnetic field strength and/or flux between rotor and stator represent knowledge of skilled artisans are particularly incorporated by reference and are not repeated here for space reasons. In particular, each of these mechanisms and/or devices may be used to modulate magnetic field and in many cases, particularly the magnetic force from the surrounding stator onto the rotor. In many cases at low speed the field is adjusted higher to achieve the lower torque and is lower at higher speed for higher torque.

In an embodiment the magnetic field strengths of the armature and of the fixed field around the armature are kept within 35% of each other (measured or calculated at the center of the air gap between them) and both are increased together (staying within 35% of each other) for increased boat speed. Preferably the field strengths are kept within 15% of each other and more preferably within 7.5% of each other. In a particularly advantageous embodiment however, the fixed field outside the armature is kept at a fairly high level upon first turning on the motor to provide increased torque to overcome the inertia of the drive system. Most preferably that field is at a high power (exceeding at least 10% of that used for full speed power, preferably exceeding 25%) upon startup and at very low speeds, for example, at less than 100 RPM speed. That is, the principle enumerated herein of adjusting the fixed field has to give way in some instances to the need for a greater torque to begin rotation, particularly for systems that utilize belts and gears and which have high friction at startup and very low speeds.

A skilled artisan, armed with this information can build or modify a motor to adjust a magnetic field in the motor, and particularly around the armature as desired for greater low speed performance. The automobile, elevator and golf cart motor patent literature contains many examples of circuits that can be adapted to this end and the use of those techniques specifically is contemplated. For example U.S. No. 5,703,448 describes the use of electromagnetic windings with taps that allow intermediate power levels of excitation. Another patent, U.S. No. 4,334,177 teaches the control of both windings by alternately switching between them using low cost parts. Reexamined patent No. 36,459 shows a control algorithm (see FIG. 1 of that document) which is adjustable and which could be adapted for the present invention to achieve a desired torque/speed performance. A microprocesser can be used for control using, for example pulse width modulation of an armature and H bridge by using the tools described in U.S. Pat. No. 5,039,924. The latter patent teaches how the use of current sensors for feedback and adjustment of voltage applied to a motor armature and/or motor field coil. FIG. 1 of that patent shows how to adjust speed vs torque using basic electrical parameters, and such adjustments can be used for embodiments of the present invention. Each of these patents is specifically incorporated by reference in its entirety.

A more complicated electronic system that could be used for control is described in U.S. Pat. No. 5,453,672, which teaches to multiply measured armature current in a brushed motor by a fixed optimal field constant to generate an optimal field current signal. This system can be used to generate a field current error signal to adjust motor power. The technique could be adopted by combining information about propeller speed and torque to adjust a motor according to embodiments. When using a separately excited motor, the armature current can be monitored to determine the status and/or performance of the propeller. Above a threshold armature current, the field current would be adjusted for higher torque to give better performance. Such adjustment is described in U.S. Pat. No. 5,814,958.

In an embodiment the armature current is monitored to create a signal, and this signal is massaged or multiplied to produce a correction signal that adjusts the field current as the armature current increases. Most preferably, a multiplication factor is determined or set (using a potentiometer or a computer) according to a given propeller. That is, when a new propeller is used, a calibration is carried out to determine an optimum adjustment to the field strength. In one such embodiment speed and power measurements are made at two field strengths, and preferably at three field strengths or more. The performance (typically power input to the motor versus boat speed) at each field strength is measured and the results used to set the field strength error correction factor or algorithm for a given propeller. The correction might also be reset (or stored values inputted for later use when conditions change) for additional conditions such as light versus heavily loaded boat.

Other electrical modifications that optimize the torque needs of a propeller to the boat speed via the electric motor may be carried out for other motor types. For example, U.S. Pat. No. 4,243,926 describes the detection of motor loading and adjustment of a voltage to an AC induction motor to compensate. U.S. Pat. No. 4,355,274 describes a voltage control system for an induction motor consisting of a SCR AC voltage controller with sensing and control circuitry that adjusts motor voltage in response to load torque demand, thereby minimizing the motor's magnetizing current and its associated losses. Such electronic manipulations are contemplated for use with AC induction motor driven propellers as well. In an embodiment a controller for an AC induction motor is adapted to increase torque suitable for a propeller.

In a preferred embodiment, upon installation of a new propeller a user obtains data at various speeds and/or motor power inputs to adjust the performance of the motor to increase torque with rpm according to the type of propeller, the type of boat, and even the degree of loading according to the principles and figures enumerated herein. For example a single phase induction motor having two windings can be controlled by setting a suitable torque by controlling voltage for speeds below the synchronous speed (set by AC line frequency) wherein the controller adjusts the amplitude phase angle relative to the line winding, and the frequency of the voltage for a desired response as exemplified in U.S. Pat. No. 6,051,952. The controller also could selectively switch power to the line winding for a different operating mode with both windings at below synchronous speed. The controller can also open the connection to the line winding after starting and operate the motor via the control winding at any speed by adjusting the frequency and amplitude of the controller voltage as described in that patent. In each case, information about the propeller performance preferably is used to determine optimum control settings.

Most preferably, in each case, propulsion unit efficiency is determined over a wide range of boat speeds and an optimum cruising speed (which may be affected by the particular propeller chosen) is determined. Upon choosing the cruising speed, the circuitry controller, which may be hardware configured or under control of a computer program, is adjusted for best performance at that boat speed. In most embodiments such adjustments will modify magnetic field strength by changing voltage, current, frequency, wave form phase shift, or a combination of these to get a suitable torque for a given rpm. In practice, however, a user does not have to actually measure or know rpm or torque value, but the optimization may be carried out by monitoring power consumption for different speeds.

Controlled Overspeed Operation of Electric Motors Another embodiment is a method and apparatus for supplying high power to an electric motor for short time periods as needed that provides a vehicle driver a short burst of energy for uncommon situations. By way of example, an electric car in a crowded city such as Paris may need a brief acceleration to dodge traffic, and a watercraft on the Seine river may have to quickly maneuver around or avoid a slow moving barge, which may require exceeding the waterway speed limit briefly. In such cases, an electric motor, with a continuous duty power output (for example 15 hp) suffices for regular vehicle movement. However, higher power (such as 45 hp) is desired for (typically) brief periods of time such as sixty seconds, forty five seconds, thirty seconds, fifteen seconds, five seconds, two seconds or even less time. A higher (for example 45) hp motor and its power supply cabling/voltage has a much higher cost than a lower (for example 15 hp) continuous duty motor and encounters greater price resistance in the marketplace. In many cases a fossil fuel burning engine is lower cost than the electric motor at the higher power and the electric vehicle suffers a disadvantage as a result. The embodiment of controlled overspeed operation allows a lower cost, and smaller sized motor to be used and can facilitate the acceptance of electric powered vehicles in these situations.

In a desirable embodiment, a lower power electric motor that is rated at continuous duty and (preferably) continuous voltage at normal operating conditions is used for the vehicle, but is operated at an “overspeed” condition when needed. The term “overspeed” in this context means a speed and/or power output that exceeds the continuous duty rating of the motor. In an embodiment the overspeed condition exceeds the continuous duty rating by 50%, 100%, 200%, 250% or even 300% of the continuous duty rating. In the case of a land vehicle such as a mini car or motorcycle, the accelerator may have a switch built in (at an extreme point of throttle operation for example), or a separate switch or button, that turns on the overspeed condition. For example, to quickly jump out of a bad traffic situation, a red button may be activated or a pedal may be pushed all the way to the floor, to hit a button that activates the overspeed condition. In the case of a watercraft, the watercraft controls may include, for example, a button or lever that may be pushed for the overspeed condition.

The overspeed operation of the electric motor requires at least two conditions. One, a higher voltage or higher applied power (such as lower power supply impedance) is supplied to the motor in excess of the continuous duty rating. Two, the motor temperature is monitored to prevent destruction of the motor. Optionally, the temperature of the power supply (battery, fuel cell, super capacitor or other energy source) also is monitored to prevent degradation of the power supply. Upon activation of the overspeed condition, a higher voltage (or lower power supply impedance leading to higher supplied current) is applied to the electric motor. The motor output increases, typically by 50-100%, 50-200%, 50-300% or more during the overspeed activation. This is achieved, for most motors, by increasing the applied voltage. In some instances the voltage may remain constant, (or increase slightly) while current may increase due to lowered power supply impedance. The motor (and/or power supply) temperature is monitored continuously, and if found to be too high, the motor power is controlled, by limitation of the power, or even turning off the motor for a period of time. In another embodiment a cooling device may be activated, such as a fan, water pump, peltier device and the like.

Virtually any electric motor can be used in embodiments. For example, a 5 hp output motor from ecycle (see www.ecycle.com) may be used with a set of lead acid batteries. A 10 hp output motor from Solomon Technologies as (see www.solomontechnologies.com) may be used. In many cases the motor controller is adjusted for higher power. In a lower cost embodiment, a bypass switch is used to directly connect batteries to the motor in a circuit that leads to greater power transfer to the motor. For example, a string of 12 batteries, each having 12 volts may be connected as three parallel strings of 4 batteries per string in serial connection each for 48 volts in normal continuous duty operation. Upon activation of the overspeed condition, the three strings in parallel may be uncoupled and placed in series to form a single 144 volt string. Of course, other combinations are possible as will be apparent to a skilled artisan.

In a particularly desirable embodiment, a temporary energy storage circuit is used to create a higher voltage from a smaller voltage supply. For example, one or more capacitors may be used as energy reservoirs and become charged with electrical energy from a battery and discharged in series (to sum their voltages) with each other and/or with the battery via electronic switchs, or placed in parallel as a skilled artisan will appreciate. In preferred embodiments two or more super capacitors such as for example, at least 1 farad, 10 farad, 50 farad, 100 farad, 1000 farad or even larger sized capacitors are charged from a power supply and then discharged in a series circuit (summing the contributed voltages) over a short time. Then the capacitor(s) are charged again, and discharged.

In an embodiment higher motor voltages are achieved from a battery this way. For maximum effect in this embodiment, preferably at least two capacitor banks are alternately charged and discharged such that when one is being charged, the other is being discharged, and vice versa. A skilled artisan may derive a suitable circuit for boosting voltage, and may, for example, use a high frequency voltage converter to charge a capacitor to much higher voltages. In one such embodiment the charged capacitor(s) alone are used to drive the motor.

A skilled artisan will appreciate variations of discussed embodiments, based on the availability and use of equipment. For example, high power fuel cells are expensive, and a smaller fuel cell that meets the continuous duty energy demands of a motor may be used in combination with an ultra-capacitor energy reservoir, that is charged when the motor is operating at an input power that is less than the rated output power of the fuel cell. The stored energy then is disbursed to the motor when a high burst of speed is desired. Such system may be used to exploit a fuel cell that has a continuous output power that is less than the continuous output power of a motor as well. Furthermore, the temporary energy storage system may accumulate energy from vehicle braking, for example by regenerative braking of an electric car, or regenerative propeller braking from a watercraft, as pioneered by Solomon Technologies.

In some embodiments the motor temperature is continuously monitored. Brushed motors preferably are monitored by placing a thermocouple at or close to the brushes or brush holder, since much of the power dissipation occurs at the brushes in this type of motor. For example, if the brushes are rated at 150 degrees centigrade heat resistance and it is found experimentally that a thermocouple detects 135 degrees when the brushes reach 150 degrees, then a circuit may be used that limits motor power when the thermocouple reaches a lower temperature (for a safety margin) such as 125 degrees. For brushless motors, the temperature measurement may be taken from a thermocouple that thermally connected thermally to one or more field windings. Relative temperature may even be inferred from direct or indirect measurement of motor impedance, since wire resistance changes with temperature. Of course, the actual measurement and desired response should vary depending on type of motor cooling, temperature history of the motor and other variables. For example, if the motor casing/heat dissipater has already heated up due to recent motor use, the minimum acceptable temperature differential between the thermocouple and brush temperature should be greater. Data concerning temperature, temperature changes, history of motor power input and the like may be routinely obtained and used by a skilled artisan and employed in a suitable algorithm and implemented by circuitry and/or software in further desirable embodiments.

In an embodiment, one or more actions are taken to protect against motor temperature rise. Preferably, a cooling fan, water pump, fluid sprayer, differential torque converter, peltier device and/or other device is turned on or adjusted upon activation of the overspeed condition. Such device also, or in addition, may be automatically turned on when a temperature sensor detects that a threshold temperature or temperature condition has been exceeded. Motor input power may be abruptly or continuously decreased; or maximum vehicle speed may be limited as temperature reaches a critical value, or continuously rises, respectively. In one preferred embodiment the overspeed condition becomes unavailable and regular motor control is resumed when heat becomes a limiting factor. Excessive heat may be produced in one or more components of the power supply and/or controller as well, which preferably is detected by one or more temperature sensors such as thermocouples in such component(s).

In a desirable embodiment, a visual and/or audio warning device informs the vehicle operator of the availability of the overspeed operation. For example, if the motor and/or other part becomes too hot and cannot be further operated in the overspeed conditions, a warning light such as a yellow light, a red light, a displayed image, or numerical display may indicate the unavailability of overspeed operation, and/or the time remaining for overspeed use. An audio warning may be used such as a bell, buzzer, siren, chime, or voice to alert the operator. In a desirable embodiment a panel display indicates the amount of time left for overspeed. For example, a two digit display of seconds may be used that automatically increases a displayed numerical value as the motor (and/or other component) cools, or decreases the displayed value as the motor (and/or other component) becomes hotter.

In another embodiment one, two or three lights are used for indicating overspeed capability status. A first light (preferably green) indicates capability. A second light (preferably yellow) means that the capability is less than normal due to heating. A third light (preferably red) means that the capability is lacking. In practice, when the engine (and/or other power components as appropriate) is suitably cold such that overspeed may be used for a given set time such as at least 2, 5, 10, 15, 30, 45, or 60 seconds, a green light is activated to alert the operator of the capability. When a temperature sensor and/or monitor system detects that overspeed has been used and that higher temperature exists, such that overspeed is not available for the given set time, then another light, such as a yellow light is energized. When overspeed capability is not available because high temperature conditions prevent overspeed driving of the motor, then a red light may be energized.

The overspeed embodiments may be used for a variety of vehicles, such as watercraft, cars, trucks, forklifts, motorbikes and the like. In a desirable embodiment for watercraft, a colored button, preferably labeled “thruster,” “power thrust,” “boost,” “power boost,” “warp drive,” “overspeed,” “emergency,” “emergency power,” “fast,” “hipower” or the like is pushed to achieve

Motor Adjustment for Desired Propeller Slip Some embodiments described above improve propulsion performance by adjusting power for a given rpm according to numerical guidelines, or according to results obtained by testing the performance of a particular propeller and motor combination. However, improvements also may be achieved by controlling the motor for optimum measured propeller slip.

Adjusting propeller slip is helpful because merely adding power to a propeller often will cause the propeller to slip excessively through the water until the boat speed catches up. That is, increasing power to a boat propeller that is already well loaded at a steady slip (steady speed) will cause an increased slip until the boat reaches the new speed. Although propeller slip is necessary for thrust and for acceleration, the inventor rationalized that a high slip is less efficient than a smaller slip needed to maintain speed and that the amount of slip can and should be controlled to improve efficiency of consumer electric boating. Furthermore, the optimum propeller slip is smaller at higher speeds than at lower speeds.

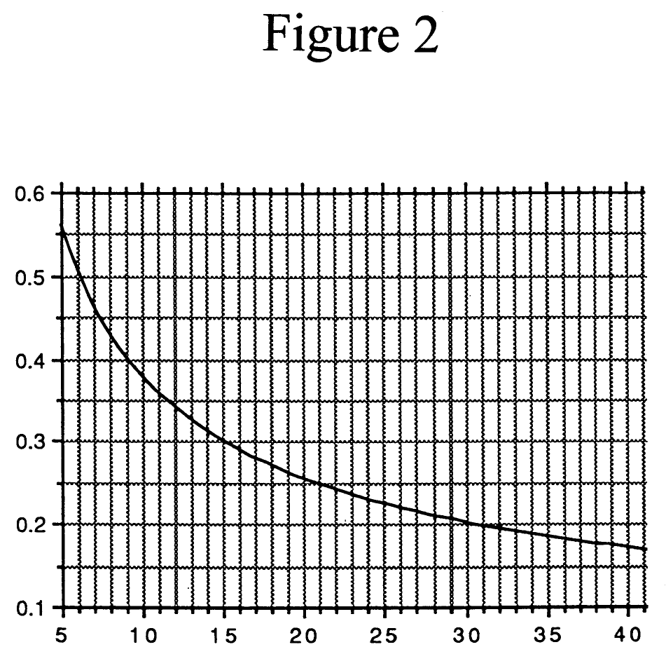

FIG. 2 depicts optimum propeller slip as a function of boat speed for various boats. The X axis is increasing boat speed in knots and the Y axis is increasing slip. As seen in this graph, slow moving boats tend to have higher propeller slips of as much as 50% but boats at higher speed optimally should have much slower propeller slip. For example, a 10 knot boat should have a more efficient propulsion at about 37% slip and a faster boat of 20 knots should have about 25% slip. The inventor discovered that he could obtain greater acceleration efficiency if the propeller speed is kept less than 1.5 times, preferably less than 1.35 times and more preferably less than 1.1 times the optimum slip values shown here for each boat speed by electronic control of magnetic field strength. That is, compared with the common practice of setting an electric motor to full throttle until the boat reaches a maximum speed, the inventor came up with devices and methods for ramping up an electric motor speed and provide more efficient acceleration. The embodiment of limiting propeller slip of electric motor driven watercraft during acceleration will become increasingly useful as electric watercraft are commercialized that achieve great er speeds.

Some embodiments limit slip while providing acceleration to higher speeds for best efficiency. In an advantageous embodiment propeller slip for a given speed, as determined from the chart in FIG. 2, is maintained according to a desired speed (as seen in the horizontal axis of that chart) by manipulating power to the motor, such as described herein. In one embodiment motor power is controlled to limit slip to less than 150% of the value shown on the vertical axis of the chart for a given speed and in another embodiment slip is limited to less than 135% of the value. In still another embodiment slip is limited to less than 125% or even 110% of that value. By way of example a 15 knot target speed might have a propeller slip limited to 0.45 (135% times 0.3) or 0.33 (110% times 0.3). The degree of limitation is best determined by factors such as how fast the user wants to accelerate and the actual optimized situation for the boat/propeller combination because each combination will differ slightly in practice.

In preferred embodiments magnetic field(s) of the motor are adjusted at one or more “sweet spots” of the speed curve for a given boat, boat loading and propeller combination. One sweet spot is a low speed below (within 5% to 25% below) the maximum displacement hull speed, as determined by the length of the waterline by the formula 1.33 times the square root of the waterline length as is known in the industry. Another sweet spot is the most efficient point for a hydroplane capable boat within its hydroplane speed. Still another spot for optimization is the maximum power output point of the motor. Even at high output it is useful to check the propeller slip and modify the motor electrically to achieve a more desirable slip for improved performance. This is conveniently carried out by monitoring motor current increase for a given voltage increase. If the motor increase value starts rising the propulsion efficiency suffers. This embodiment provides a set of target slip values for altering the torque to rpm curve of a given motor and propeller combination, and uses constant monitoring of propeller and boat speed to adjust those values.

In a preferred low cost embodiment the operator of the boat manually optimizes a motor parameter (such as strength of a magnetic field surrounding the motor armature) and then fixes that value into a circuit (typically by adjustment of a potentiometer) or into a computer so that the optimum value can be selected for use at that desired speed. This is carried out for each desired speed, such as a high displacement speed and an efficient spot of a hydroplaning speed, if the boat is capable of hydroplaning. In one such embodiment the motor torque is adjusted by adjusting a fixed magnetic around the armature to provide optimum torque and maximum efficiency. For an AC induction motor suitable electrical characteristics may be modified as exemplified in the discussion above. During use, such optimum conditions may be set by a switch or some other automated means. In an example of setting a switch for a high displacement speed, the user may simply push a button that sets the matching motor condition. Likewise a switch may be used to select other desirable set points.

Of course, in another embodiment the (normally fixed) magnetic field may be adjusted continuously in a pattern determined by the propeller/boat characteristics so that the user merely uses a continuous speed throttle to set one parameter (such as voltage to the armature for a brushed motor in a simple motor example) and the magnetic field outside the armature changes (rises or falls) according to preset steps and/or a preset linear relationship with rises in the armature voltage or (more preferably) current. In a particularly desirable embodiment a computer controls the fixed magnetic field around a brushed armature. A computer uses a look up table of values that yield a power versus rpm relationship similar to that shown in FIG. 1, which is determined beforehand for a particular propeller either by the manufacturer or by the user of the boat.

In an embodiment the propeller slip is determined by measuring the boat velocity and the propeller rotation speed. The determination of slip or more realistically, relative optimum slip is best made from practice tests with a given propeller. In some embodiments of this aspect a numerical ratio of slip is not actually calculated but relative slip is used to adjust the motor power. That is, the power consumption is determined at a given boat acceleration rate and an optimum power is chosen to set the value for a computer program or hardware so that the boat operator can select that optimum value when desired.

In a preferred embodiment propeller speed (in rpm) and boat speed (in other units) are measured continuously and compared. Depending on the comparison results, the internal combustion or electric motor is adjusted to bring the propeller speed to a more desired speed. Propeller rpm can be readily determined by direct measurement from a tachometer that may be built in or added to the motor, by optical means, magnetic means or from motor voltage (if electric motor). One easy magnetic means is to attach a magnet to the propeller shaft or propeller hub and to place a hall effect sensor nearby to detect movement of the magnet near the sensor. Boat speed can be measured by a large variety of devices but preferably by a device that generates an electronic signal which can be readily compared with the propeller speed signal. A comparator then compares the two signals and outputs a control signal to the motor as needed. The comparator can work with a computer that has stored information for desired rpm versus boat speed or the comparison can be entirely in hardware, or even involve different comparisons for different speed ranges. For example, a stepped planing electric boat has very different rpm vs torque needs at high planing speeds and a separate comparator or look up table may be used for the planing speed region compared to low speed operation.

In a less preferred embodiment where it is not feasible to constantly measure propeller and boat speeds a power input versus boat speed curve is determined empirically and used to determine optimum adjustments. Each point on the curve represents an optimum slip for that propeller at the given speed. According to an embodiment, the boat speed is continuously monitored and a motor power that slightly exceeds the power/speed ratio for that particular speed is applied to the motor for acceleration. Up to 10% excess power may be used to accelerate above that speed while up to 20%, 30%, 50% or even 100% excess power may be used in some circumstances where efficiency is progressively less of a concern. Of course, when starting from rest, the boat requires a much higher slip outside this range to achieve a minimum speed. For example a very high slip may be acceptable to get the boat up to the hull displacement speed to save time. However, in another embodiment where time is less of a concern, (for example during a distance/endurance contest) the higher efficiency method of limiting slip may be applied at boat speeds as low as 2 knots or less.

A number of devices and methods can be used to implement this embodiment. In one preferred embodiment a controller device is set to a maximum speed and the device outputs a motor control signal that sets the motor speed to allow propeller slippage of up to 30% more than the optimum slippage, preferably only up to 20% or more preferably up to 10% above the optimum slippage. Generally, in many embodiments a hardware circuit or computer memory used in calibration mode detects control voltages or currents and saves those values for use in regular run-time mode.

Cavitation: Extreme Propeller Slip In extreme instances the propeller will slip so much as to cavitate. Cavitation of fossil fueled boats has been measured directly by, for example, a bubble detector as described in U.S. Pat. No. 5,190,487. However, such use of a bubble detector is undesirable because it is prone to error and introduces a layer of complexity to the equipment, having to be maintained in a marine environment. Another means of detecting cavitation has been with a pressure sensor, such as described in U.S. Pat. No. 5,833,501. The pressure sensor system also is unduly complicated and difficult to maintain. These mechanical systems were designed for use in conjunction with internal combustion engines and are not preferred for the present invention. However, in one embodiment an inexpensive and robust pressure detector made from a piezo film such as that available from Measurement Specialities, (Valley Forge, Pa. USA, website: www.msiusa.com) may be used to detect cavitation.

A preferred sensor for detecting cavitation directly or for inferring boat speed is a metallized piezo film, which is built thin, flexible, is robust and inert, is broadband with a low Q, but having a high piezo activity of, for example, d10 to d100 and more typically d20 to d50. One or more such sensors may be mounted neat the propeller and used to detect cavitation by sensing pressure waves. In a preferred embodiment a circuit compares a motor power signal with a piezo detected pressure signal. If the pressure sensor output indicates that the propeller is not generating a suitable pressure differential (measured using one sensor, or optionally more than one) for a given motor power or speed then the circuit outputs a “cavitation present” signal, which triggers lowered power to the motor.

In another preferred embodiment propeller speed is determined by motor voltage and boat speed is determined by a speed sensor such as a simple piezo electric device. Signals from both sensors are compared and if the propeller speed signal is proportionally too big then the motor power is cut back. A variety of boat speed sensors may be used. However a non-moving sensor such as a piezo electric device, in combination with motor voltage (which is NOT a sensor) is a particularly robust, reliable and inexpensive combination for the comparator. In this embodiment, NO moving parts are used to determine cavitation. On the one hand a piezo electric device such as a metalliized film is not particularly accurate for determining a precise boat speed. On the other hand, the boat speed value does not have to be very accurate and the piezo electric signal, while not easily usable for reporting boat speed, is sufficient for this embodiment. A motor voltage needs to be compared with a rough estimate of boat speed (very slow less than 2 mph, about 5 mph, about 10 mph, about 20 mph etc) for determining cavitation on this basis.

In contrast to the prior art mechanical systems, these embodiments are completely electric and monitor cavitation directly by piezo pressure sensing, by monitoring propeller speed, or by electrically sensing the motor itself to determine whether the motor has entered into a speeded-up state characteristic of cavitation. In a very desirable embodiment the propeller speed is directly measured without using a sensor but instead merely taking the motor voltage. This embodiment is preferred for most electric motor driven watercraft because of its reliability and low cost. Upon sensing cavitation, a circuit electrically decreases power to the propeller. In one embodiment the motor speed is inferred by monitoring current supplied to the motor and a motor speed value compared with a known or estimated boat speed. A sudden decrease in current below a defined rate of change indicates cavitation. A device that detects this condition may sense current through the armature in a brushed motor or through a field winding in a brushless motor and then output a signal in response to an above threshold decrease in current per unit time under steady voltage conditions. The outputted signal adjusts the supply voltage and/or current downwards, decreasing motor power (watts).

In one embodiment a computer monitors the cavitation (excess slippage) signal. In a preferred embodiment the signal is compared in hardware and is generated over a moving time interval established by a circuit time constant and automatically adjusts the power supply downwards. In yet another embodiment the boat speed and propeller speed are monitored as described above and an overspeed condition, defined as an excessive slip ratio, which may be a relative measurement, indicates cavitation. In a particularly advantageous embodiment the propeller speed and motor electrical (current, voltages etc) characteristics are monitored and compared with normal speed and characteristics. If the motor characteristics are outside a normal range, then the motor power is adjusted.

The High Speed Low Efficiency Problem A problem that affects displacement vessels such as most electric boats used for pleasure is that the propulsion system efficiency rapidly drops off as the watercraft approaches hull speed. An embodiment addresses this problem by monitoring motor current and limiting boat motor power when the current starts increasing too much for a given increase in propeller speed. It was noticed that at low, efficient speeds (e.g. at 10%, 20%, 25%, 30%, 50% or 70% of hull speed) the electric watercraft motor current increases fairly linearly with increasing speed. As the boat approaches hull speed (typically becomes within 75%, 80%, 85%, 90% or 100% of hull speed) the current consumption starts to rapidly increase. In this embodiment, the motor current is monitored and when the increase in motor current versus increase in motor voltage exceeds a nominal value (determined by for example increase in current for a given increase in voltage at 30% of hull speed) the motor power is set back. Each motor/propeller/boat combination is associated with a general acceptable current increase versus voltage increase ratio in low speed conditions. An arbitrary increase in this ratio, such as 1.2; 1.3; 1.5; 2.0; or 3.0 times increase in current for a given increase in voltage indicates a low efficiency speed operation, which triggers an alarm such as a bell or buzzer, and in some embodiments, an automatic limitation in speed for greater efficiency of power usage.

Monitoring Propeller Slip It is often helpful to monitor and/or control propeller slip of watercraft. Although some propeller slip is necessary for acceleration, inefficiencies can be seen as various degrees of propeller slip that differ from desired slip values. Furthermore, if slip is measured in real time at different speeds the boat operator can learn more about the boat propulsion efficiency and other conditions of the boat that affect efficiency. Still further, a slip measurement can be compared with reference or desired value(s) and the comparison results used in real time to adjust the boat motor for improved motor and/or battery and/or fuel cell performance.

FIG. 1 shows a general relationship between ideal slip and boat speed and illustrates how the amount of desirable slip varies downwards with increasing boat speed. It was discovered that for any given boat and propeller combination, a similar relationship for ideal slip could be determined empirically and used by a boat manufacturer or the boat operator as a guide for improved performance. The relationship between desired slip and boat speed can be expressed as, for example, a look up table, chart, algorithm, one or more electric voltage resistance or current limits, or electronic circuit parameters. This allows an instantaneous readout of slip to inform the boat user of the boat status at any given time with respect to a given speed, as exemplified in FIG. 1. In one embodiment accordingly, a continuous readout slip measurement device is calibrated to show when slip is excessive (inefficient acceleration for example) close to negative (no acceleration) or very excessive (indicating cavitation).

Unfortunately, however, raw slip numbers generally are not that helpful to regular watercraft operators because the desired slip does not stay constant but changes (generally decreasing) with boat speed. Thus, until now, there has been no satisfactory and widely acceptable slip meter of any kind useful for regular non-technically minded watercraft operators. Embodiments generate slip signals and massage those signals, either numerically, electrically, by design of analog display gauge region size and/or a combination of each, to accommodate the need for a simple meaningful signal. By way of example, a slip of 1.0 at very low (2 mph) speed generally is acceptable and desired, whereas the same slip at 20 mph in many instances is unacceptably high. Merely reporting this figure as digits on a panel is not helpful to many watercraft operators. A circuit (hardware, microprocessor or both) needs to correspondingly decrease the readout slip signal at low boat speed and/or increase the slip signal at higher boat speed. FIG. 1 shows one set of data indicating acceptable slip. Each boat/motor/propeller will have its own ideal relationship which can be provided by a manufacturer or generated by a user as a calibration for his equipment.

A microprocessor can create or receive a boat speed-slip relationship as a look up table or algorithm. Electrical signals corresponding to boat speed and propeller speed then are compared and the result offset by the table information to generate a more usable signal that may be displayed on an analog meter to the boat operator. This way, meaningful qualitative information is presented to the watercraft operator.

Corresponding signal corrections to prevent overemphasis of measured high slip at lower boat speeds may be made by electronic massaging, or even on a display itself. In the latter case a display may have additional markings that distinguish a high speed performance slip from low speed performance slip. Preferably however, conversion from completely quantitative information to qualitative information is carried out by a microprocessor or electronic circuitry that decreases low speed displayed slip with respect to high speed displayed slip. A theme in this embodiment is that the watercraft operator does not want to play around with numbers and memorize acceptable slip values for different boat speeds. Instead, a panel display, which preferably is an analog gauge, quickly provides the compensated qualitative information. Embodiments were discovered that convert the otherwise raw or digital numbers into a form suitable for mass consumption by the common pleasure boater.

Of course, for efficient acceleration, the propeller should slip a little more than that needed to maintain a constant speed and, in many cases above the curve shown in FIG. 1. For example, at 5 knots a slip between 0.55 and 0.75 may be used, at 20 knots, a slip between 0.25 and 0.5 may be used. Conversely, a propeller that slows a boat will have negative slip. A propeller having no real effect on boat movement has zero slip. Knowing the relationship between an ideal slip and boat speed can allow manual and/or automated adjustment of propeller power to bring the propeller slip into a more efficient range. Such adjustment would yield many benefits, including finding and using more efficient acceleration conditions, more efficient battery usage, more efficient stopping (allowing optimal regeneration) more efficient cruising, control of cavitation while accelerating at low speed, control of cavitation at or near hull displacement speed and so on.

An extreme positive slip occurs when the propeller turns so fast that it loses much efficiency and makes bubbles. In the case of fossil fueled internal combustion watercraft, such cavitation often is detected by the noise of the motor winding out and/or the bubbles formed by the propeller. Attempts have been made to limit or prevent such cavitation, using mechanical detecting and/or mechanical control systems. However such crude attempts generally have long feedback loop times and cannot easily control motor speed in a virtually instantaneous manner.

The all-electronic control systems described herein can provide virtually instantaneous electric (and/or internal combustion) motor control to more quickly and efficiently control cavitation, compared with prior art mechanisms and systems. This allows rapid cavitation control during and after onset of cavitation and allows different responses to different cavitations. For example, cavitation at low speeds can be responded to by bringing the motor power within an acceptable acceleration range. Cavitation at high speeds such as cavitation near the hull speed for a displacement boat can be alleviated by lowering motor speed to allow a desired cruising speed that typically is a large fraction of a maximum speed. For example by limiting power until 80%, 90%, or about 95% of hull speed is reached. The prior art cavitation control systems do not address adequately the larger issue of monitoring and controlling slip to improve performance over a range of boat speed conditions.

The electronic control system provides a number of other benefits in terms of increased efficiency. By displaying and/or automatically controlling boat slip a more optimum power can be set for greater efficiency. In another embodiment a circuit that outputs a signal proportional to negative slip (indicating deceleration) controls a motor circuit for optimum regeneration efficiency. This latter embodiment is particularly useful where the field current (magnetic field around the armature) is adjusted to obtain optimum regeneration. For example the field of a separately excited motor is controlled to recover energy from slowing by increasing the field current enough to slow the propeller rotation to achieve an optimum negative slip that gives good regeneration efficiency. If the field is too strong then the propeller will have too much negative slip (eg. water rushes past the propeller without turning it). If the field is too weak the propeller may spin too easily and not absorb as much energy. Of course, the slip signal may be used instead to control the armature circuit of a brushed motor. In each case a routine calibration test may be used to determine what negative slip is preferred for best regeneration efficiency and how to control the motor to obtain desirable resistance to rotation.

Measurement and Display of Slip Determination of a desired slip during boat travel is made by continuously measuring two or more parameters in real time. Preferably a first parameter is motor rpm, which is measured as a relative propeller rpm electrical signal. Preferably a second parameter is boat speed, which is measured as a relative boat speed electrical signal. These two signals are compared to generate a comparison signal that is proportional to slip. The comparison signal can alert or inform the boat operator, via for example an analog meter, light or buzzer. The signal also may automatically control motor power, via for example adjusting the power to within an acceptable slip range for efficient acceleration, when desired, or by decreasing power, if cavitation or another undesireable high slip condition exists or by controlling magnetism of the motor for desired regeneration suitable for stopping. Where the slip signal is used for control the signal is compared with a known reference value or range of values to generate a pulse or other signal for motor control.

Many different types of sensors may be used as means to generate a boat speed signal. Generally, the transducer creates an electrical signal proportional to boat speed. One or more electrical circuits preferably manipulate the signal before electrical comparison with the propeller signal. Preferred sensors include hall effect transducers or optical sensors on drive shafts coupled to common building block components like digital to analog converters and frequency to voltage converters. These components convert the pulsed signal from the sensor to a proportional voltage or current. In more complex embodiments boat speed signals can be derived from a sonar system or derived from a GPS receiver. In the latter case an NEMA 183 interface may be used as this is compatible with the common computer serial port and can receive boat speed information. A particularly desirable device for generating a boat speed signal, particularly for use in detecting gross slippage such as cavitation, is a piezoelectric mounted on the hull below the waterline, and preferably in the front of the boat. Preferably the device is a metallized piezo film, which is built thin, flexible, is robust and inert, is broadband with a low Q, but having a high piezo activity of, for example, d10 to d100 and more typically d20 to d50. An inexpensive and robust detector made from a piezo film such as that available from Measurement Specialities, (Valley Forge, Pa. USA, website: □ HYPERLINK http://www.msiusa.com) □www.msiusa.com)□ can provide boat speed information. Use of a piezoelectric detector in this way is a preferred means for obtaining boat speed.

Many different types of sensors also may be used to generate a propeller speed signal. The propeller speed signal is proportional to propeller rpm. This signal also preferably is manipulated electrically before the comparison. Preferably, for internal combustion engine watercraft the propeller speed signal is generated by a tachometer device, as is well known to a skilled artisan. Many electrical motors contain built-in tachometers or have provisions for adding one. In a preferred embodiment a hall effect magnetic sensor is attached to the motor drive or propeller shaft and the pulsing signal is converted into a form that is more easily compared to the boat speed signal.

In a most preferred embodiment that is particularly appropriate for electric boats, NO propeller speed or motor shaft speed sensor is used. Instead, the voltage to the motor is used to infer propeller speed. The inventors discovered that many if not most electric motor driven watercraft are particularly well suited for this low cost and very reliable embodiment. In this embodiment the motor voltage is directly used and is linearly proportional to speed.

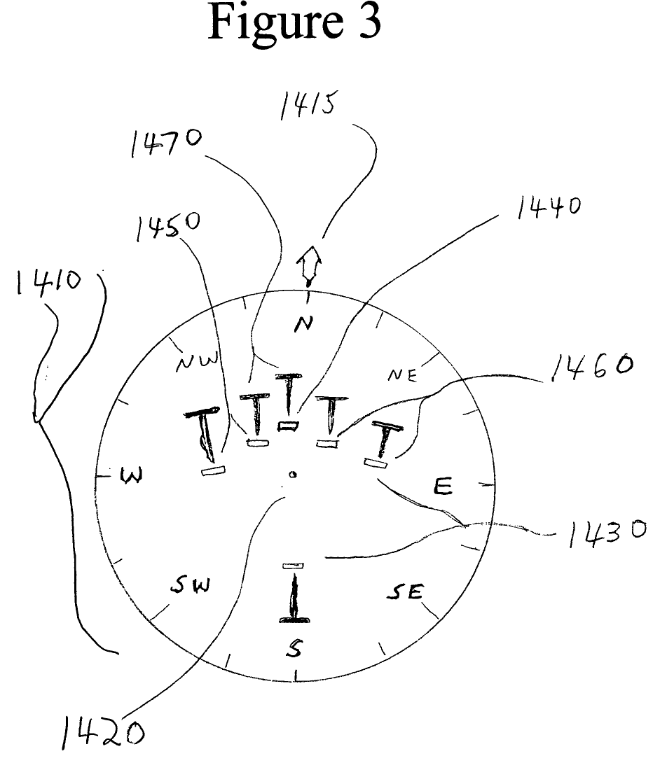

In the most preferred embodiments of this invention the propeller speed and boat speed signals are generated continuously (or the propeller speed is inferred from motor voltage) and compared with each other. A comparison circuit easily can be designed by a skilled electronics craftsman and the block diagrams shown in FIGS. 2 and 3 are representative in this regard. In preferred embodiments a “relative slip” signal is generated by the electrical comparison of propeller speed with boat speed. In most preferred embodiments the relative slip signal is a ratio of the relative propeller and relative boat speed signals as shown in FIG. 2. A ratio is preferred because it is less sensitive to boat speed. If a raw difference signal were generated by a difference comparison, the absolute magnitude of the signal (in most circumstances) should increase at higher boat speeds. The block diagram of FIG. 3 shows a compromise wherein an absolute difference signal (speed signal minus propeller rpm signal or propeller rpm signal minus speed signal) is converted to a log form to prevent excessive swings in detected output as the boat reaches higher speed and greater absolute differences. A ratio comparison, on the other hand, provides a relative “apparent slip” measurement that more accurately follows the desired parameter. In preferred embodiments the apparent slip measurement is further modified to compensate for low versus high boat speed as mentioned above. FIG. 3 shows optional compensation after the difference amplifier.

In a particularly desirable robust embodiment that has no moving parts and is very strong and inexpensive, motor voltage is used to infer propeller speed and a piezoelectric device is used to generate a boat speed signal. In an embodiment the piezoelectric device means for obtaining the boat speed is mounted on the forward hull just behind a laminar flow breaking protrusion that creates eddy currents in the water that flows past the hull. The faster the boat movement, the stronger the eddy currents, which are detected as vibrations by the piezoelectric sensor. A skilled artisan can deduce suitable surface etchings, marks and the like that create turbulent down stream flow under a wide range of water speeds and which are suitable for this embodiment. In another embodiment two electrodes are used that have a measured resistance between them. As the boat pushes through the water and water rushed between the electrodes, the electrical resistance between the electrodes increases, which is a measure of boat speed. This latter embodiment also is desirable as it allows boat speed measurement with no moving parts via means of electrode measurements.

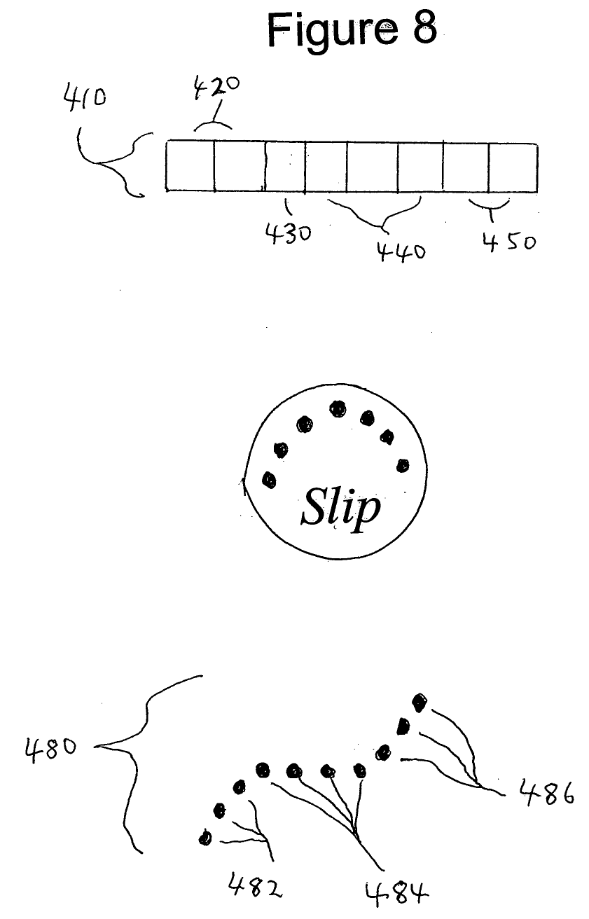

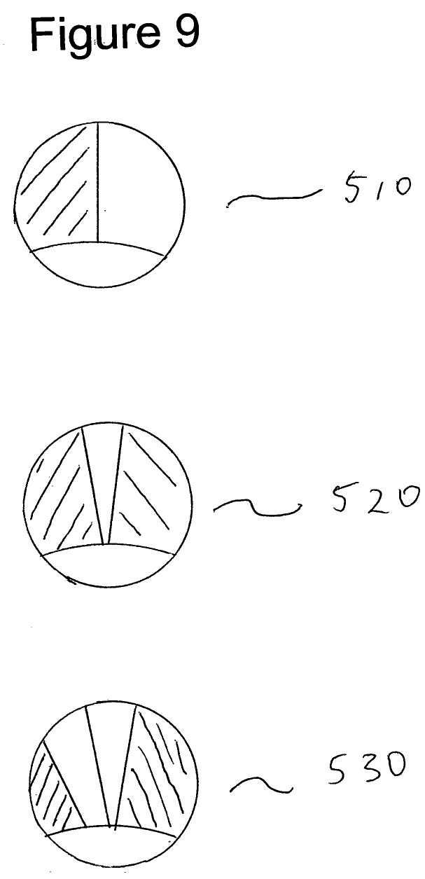

Determining an Optimum Speed-Slip Relationship Some embodiments inform the boat operator of the propeller slip condition in real time. Preferably, the slip is expressed on an analog scale using a meter display output as shown in FIG. 9. The three meters shown on this page contain increasing colored background sections. Meter 510 has two sections. Meter 520 has three sections, with the middle one having a yellow color. Meter 530 has four sections. The two middle sections are shown in clear and the two outer ones are shaded. The needle is not shown in each case and preferably simple writing is present on the background to denote quality of slip. A wide range of user friendly devices using lights can be used. See FIG. 8, which shows bar LEDs 410, LEDs 460 arranged in a semi circle and LED's 480 arranged in a staircase. The bar LED's in 8a are of differing colors that impart slip meaning to the user. LED's 420 are blue, meaning deceleration, LED 430 is yellow, meaning neutral propulsion, LEDs 440 are green, meaning healthy propulsion and LEDs 450 are red, meaning inefficient propulsion. The staircase LEDs 480 of FIG. 8c likewise are colored, with LEDs 482 being yellow, LEDs 484 being green and LEDs 486 being red. In other desirable embodiments a light is added to a panel meter such as a speedometer that indicates cavitation. In another embodiment a red, yellow and green light are added to another gauge to indicate poor, marginal and acceptable slip respectively. In other embodiments the electronic slip signal is compared with a stored value or range of values to determine whether or how the motor power should be adjusted. In this latter case one or more visual or audio signals alert the boat operator. Additionally, one or more circuits may automatically adjust the motor in response to the comparison with a reference signal.

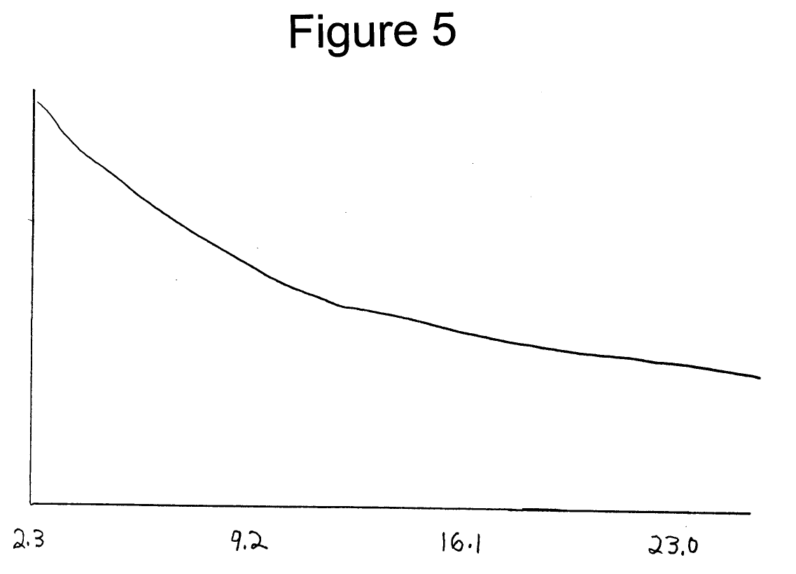

In one embodiment the signal is compared with a known set of values such as those shown in FIG. 5. Such relationship is known, as for example shown in chart 5-2 and Table 5-1 from Propeller Handbook by David Gerr (Mc Graw-Hill, 1989). The chart and table provided in that reference show a desired slip for different speeds obtained by comparing different types of boats rather than performance for a given boat. One particular insight is that optimum slip differs in a reproducible manner, not just between different boat types, such as a tugboat versus a speed boat, but in particular between speeds for a single boat and propeller combination. From this insight, it was found that tight monitoring and control for a given slip range yields rich benefits in boat and battery performance.

In one embodiment an acceptable slip for a given speed is determined by values shown in FIG. 5. In practice the values taken from FIG. 5 preferably represent a mean within a range. For example optimum speed-slip range may be approximately (i.e. exactly equal to or plus/minus an additional 25% deviation of) the plotted value in this figure plus or minus 10%, more preferably plus or minus 20%. In another embodiment the optimum range for efficient acceleration will be within the plotted value and 10%, preferably 20% and more preferably 30% above the plotted value. By way of example, an optimum speed slip range for a 5 knot vessel may be 0.55 plus or minus 0.055, plus or minus 0.11, or plus or minus 0.165. For the wider range, that means a range between 0.385 and 0.715. An efficient acceleration range might be from 0.55 to 0.605, 0.55 to 0.66 and 0.55 to 0.715 slip respectively. These values provide general guidance. In practice a manufacturer, or in some cases the boat operator is expected to determine a most suitable range for a given boat and propeller combination.

A look up table similarly can be used as a reference to detect the excessive slip condition known as cavitation. A cavitation at low speeds might for example be determined when the boat propeller is detected as having twice the optimum slip, three times the optimum slip or even higher values. In one embodiment cavitation may be detected as any slip exceeding a certain value regardless of speed. Using the guidance provided in this specification a skilled artisan can determine suitable values for both optimum speed-slip and to signal excessive slip indicating cavitation or other excessive slip conditions.

In more preferred embodiments an optimum speed-slip relationship is determined by a calibration trial with a given boat and propeller combination. In one such embodiment, the manufacturer sets one or more reference standard curves or look-up tables (preferably as stored information in memory locations, as one or more algorithms or as electrical parameters of a circuit). The boat operator prepares a fine adjustment for a particular propeller (and/or boat loading configuration) by making at least one, and preferably at least two constant speed measurements and adjusting the stored curves or tables. For example, a computer that controls the electrical boat motor may have three stored slip curves, each curve comprising a table of boat speed values and associated table of propeller rpm values. The user would, particularly after installing a new propeller, run the boat at a constant low reference speed such as 3 knots. The computer would check and record the propeller rpm rate and (optionally motor power) upon detecting the constant speed and constant rpm relationship. The computer would use this value to select one of the three stored tables or to adjust one or the tables. More preferably a large number of tables would be used and a second speed check would be carried out.

In another embodiment the computer automatically carries out the entire calibration procedure to determine optimum speed-slip relationships (and overslip conditions). In this more preferred case, the user takes the boat out into a clear (non-crowded) area of waterway and presses a “calibration” button, which starts a calibration sequence. The calibration sequence is carried out by any of a number of ways wherein at least one constant speed or boat power is set or detected by the boat electronics, and then one or more of the other parameters are measured. The result can be compared to stored information to adjust a previous stored speed-slip relationship. More preferably, the boat would check parameters at two or more different constant speeds (or motor powers) and store the results. For example the boat could go a constant 3 mph for a minimum of 5 seconds (to establish a constant condition for 3 mph) and then record relative or absolute propeller rpm. The boat then moves at a constant 5 mph speed for at least 5 seconds, and measures relative or absolute propeller rpm. This determination of boat speed vs propeller speed would be carried out at different boat speeds to generate a more accurate real time speed-slip relationship. In yet another embodiment, the boat computer carries out calibration by comparing slip at multiple motor powers during acceleration, and does not pause at any particular speed.

In carrying out an automated calibration of the speed-slip relationship according to a preferred embodiment, it is easiest to set a constant motor power for each point. Of course, instead of setting a constant motor power a constant boat speed, or constant propeller speed can be set and another parameter(s) detected. Other conditions, such as boat loading will affect the relationship. If a boat becomes more heavily loaded then a greater slip will be required at a given speed to maintain that speed. The further factor of boat loading could be input into the computer (or added to a circuit by adjusting, for example a potentiometer) to adjust for this factor.

The signals from the propeller rpm indicater and the boat speed indicator may be developed by a computer or more powerful adjustable circuit. Most preferred in this case is a look up table of values associating boat speeds for different propeller rpm rates at constant speed conditions that could stored in a computer memory. For purposes of convenience such values herein are termed “steady state conditions.” Once the values are determined, a user can set boat electric motor rpms to a given value and expect the boat to reach the speed associated with that value. If the instantaneous boat speed is greater than that value then the boat will decelerate. If the boat speed were lower than a set value then the boat will accelerate.

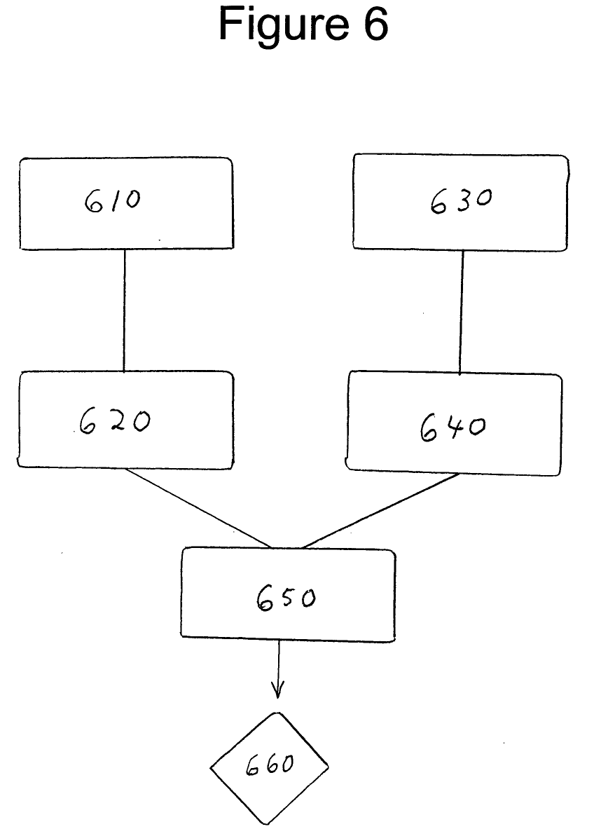

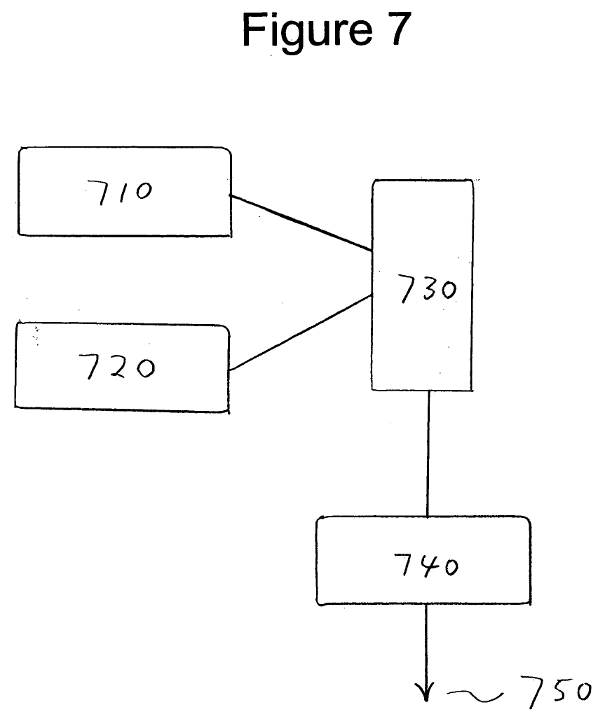

The boat speed versus propeller rpm information can be stored in a wide variety of forms such as including a look up table in computer memory and the setting of one or more electrical characteristics of an electrical circuit. By way of example as shown in FIG. 6 a boat speed indicator output 610 may be converted into a first voltage that varies with boat speed and is sent to D-A converter 620. A propeller speed sensor 630 (preferably a hall effect sensor attached to a propeller shaft) generates a second voltage that is sent to D-A converter 640. Each D-A converter feeds into microprocessor 650 that compares and ratios the two signals and compensates for a greater desired slip at low boat speed according to a relationship such as exemplified in FIG. 5. Microprocessor 650 outputs a signal that is converted into an analog signal by D-A converter 660. In a related embodiment (FIG. 7) no microprocessor is used and signals are converted into log form by log converters 710 and 720 and then ratioed by subtracting one from the other by comparator 730, to generate an analog signal that may be further compensated for boat speed by further circuitry 740 that outputs an analog signal 750 for use in a meter or by other circuitry such as a motor control circuit. In practice it is desired to include one or more adjustable potentiometers to set conditions for calibrating a given standard reading for a given propeller.

Compare Measured Slip with Stored Values for Motor Control A measured relative (or absolute) slip value preferably is compared with a stored or calculated value to determine whether, for a given boat speed, the propeller is slipping too much, indicating poor acceleration efficiency or cavitation, or is slipping too little, indicating cavitation. The comparison also can indicate a change in boat loading. For example, an increased weight load will cause a higher propeller rpm and higher engine current for a given boat speed and can be detected on this basis. The condition of forgetting to pull up the anchor or propeller damage can be detected by excessive propeller speed and excessive motor current for a given boat speed. (This latter condition is distinguishable from cavitation by the combination of high motor current with low boat speed.) In embodiments a warning device is used to indicate such conditions. For example, a red warning light could energize, a chime may sound, or a gauge needle could indicate to the boat operator one or more of these conditions that adversely affect boat efficiency. In a particularly desirable embodiment the electric power to the motor is monitored in place of the rpm monitor. This embodiment is made possible in electric boats because their motor characteristics are more constant compared to fossil fueled internal combustion motor driven boats.

Most preferably the electric relative slip signal is compared with a reference value. The comparison results induce an electronic adjustment of motor power to compensate for an undesirable condition. Several adjustments are possible and desirable.

In one embodiment low speed (at least 25% lower than displacement hull speed) acceleration is optimized or adjusted in real time by decreasing or increasing motor power as appropriate to bring the slip factor into an optimum range for good efficiency. By way of example, a boat speed is determined and an optimum slip determined from a look up table that approximates the plotted curve of FIG. 5. Optimum acceleration in this example is within the plotted value and that same value times 1.3. If the measured slip is below the plotted value then the motor power is increased to bring the slip within this range. If the measured slip is above the plotted value then the motor power is decreased to bring the slip within this range.

In another embodiment acceleration for high speed (above displacement speed) is controlled in a similar manner using stored optimized slip ranges (for each boat speed) that give good efficiency during acceleration. In yet another embodiment the boat operator sets a desired speed, either in mph, knots, or a subjective cruising speed, using a control such as a push button, keyboard or knob, and the steady state slip associated with that desired speed is set automatically.

In yet another embodiment suitable for all types of boats, a device as described herein monitors for unusual loading of a propeller at low speed and outputs a response such as a buzzer when detecting an anomaly such as anchor down when trying to move away, or propeller caught in weeds, or propeller up. A skilled artisan readily will appreciate how to set a device accordingly. For example, when an anchor is still down or the propeller is caught in rope or weeds, a boat speed signal will indicate low speed, but the propeller signal and or motor signal (which could be an electronic parameter of the motor such as voltage, current or power, if an electric motor is used) indicates high resistance. For example the propeller may show high cavitation or high loading, the motor may show high loading with little boat speed and little or no acceleration. Use of a simple piezo electric detector (which tend to be less accurate during use) are particularly useful for the less accurate measurements needed in these situations and can be used for very low cost detection of boat movement. Combined with an electric motor, such systems can be very low cost as the motor electric parameters may be monitored to determine loading, rpm and the like, which are compared to determine an anomalous condition.

Having reviewed how to measure slip, how to determine a desired slip, how to make a comparison of measured slip with desired slip, to notify a boat operator and/or automatically control a boat for greater performance, several examples are presented next to illustrate several embodiments. These examples are representative and are not intended to limit the scope of the appended claims in any way.

### EXAMPLES OF MONITORING SLIP

### Example 1

This example shows the generation of boat speed and propeller speed signals, and use of those signals to generate a ratio slip signal. An analog propeller speed signal is obtained by a hall effect sensor purchased from Westberg Mfg. Inc. of Sonoma, Calif. wired to a LM2917 chip. An analog boat speed signal is obtained by a hall-effect paddle wheel speed sensor attached to the trailing edge of a skis from a Maruta watercraft manufactured by ElectroCruise Boats of Homosassa Springs, Fla. The two analog signals are adjusted to provide equal ranges for each by setting amplification and zero level as needed. The adjusted signals are then converted to log form using operational amplifiers as log amplifiers with transistor junctions in their feedback loops. The log outputs are fed into a difference amplifier circuit, which subtracts the boat speed log signal from the propeller log signal to generate the ratio slip signal. The ratio signal represents both negative apparent slip (when the propeller speed is less than boat speed) and positive apparent slip (when the propeller speed is greater than boat speed).

### Example 2

This example shows the generation of a positive slip indicator signal. Two adjusted analog signals are formed as described in Example 1. The boat speed signal is subtracted from the propeller speed signal by a difference amplifier and this difference is used as an absolute slip signal for an analog slip meter. In a second experiment the difference signal is fed into a log amplifier to decrease the dynamic range of the signal to allow more convenient use of an analog indicating device.

### Example 3

This example shows generation of a cavitation signal. The signal output from example 1 is fed into a comparator and a reference signal corresponding to a high slip value equivalent to a slip of 100% is fed into the comparator. The comparator output is used to signal a chime. When the signal output of example 1 exceeds the reference signal the comparator turns on the chime, alerting the watercraft operator of excessive slip condition. In a separate experiment the comparator output is further processed to indicate whether the high slip condition occurs during low watercraft speed or at cruising speed. In this latter experiment a boat speed signal is fed to a threshold level detector that outputs a signal when the boat speed achieves half maximum speed. That signal is used to select a second piezo electric buzzer that signals when high (above 100%) slip occurs at higher speed condition.

### Example 4

This example shows how the signal of example 1 may be used in different display formats. The circuitry of example 1 is adjusted to provide a continuous output signal of the same polarity across the entire range of watercraft and propeller speeds. The signal is modified by differential amplification to provide a 2.5 volt signal when the slip is 0 (propeller has no apparent positive or negative slip) and to provide a 5 volt signal under extreme positive slip conditions. The modified signal then is fed into a 5 volt full scale analog meter having a display surface as shown in FIG. 7.

### Example 5

This example shows the instantaneous control of motor power by a slip signal produced in example 1. Circuitry as described in example 2 is constructed and adjusted to generates a logarithmic signal output proportionate to excessive slip. The output signal controls a pulse width modulation control for the electric motor that drives the propeller. When the user turns the motor on too high by adjusting a potentiometer, thus creating excessive slip, the output signal becomes a larger voltage that is impressed upon the potentiometer in an opposite polarity, countering the control voltage and decreasing the power to the motor.

Other combinations of the inventive features described above, of course easily can be determined by a skilled artisan after having read this specification, and are included in the spirit and scope of the claimed invention. References cited above are specifically incorporated in their entireties by reference and represent art known to the skilled artisan

Safety Control Device for Suddenly Stopping a Propeller Another embodiment is an electronic device and method for preventing collision of swimmers or other marine life with the boat propeller. During studies of higher speed efficient electric watercraft, it was discovered that both electric motor and fossil fuel motor driven propellers could be rapidly controlled in response to conditions. Furthermore, during the design and building of prototype propellers and hulls, it was discovered that at least one, and preferably, at least two sensors appropriately placed could be used in a system that rapidly halts a propeller when an object such as a rock, manatee, hand, foot or leg enters a danger zone immediately upstream or downstream of the propeller. In an embodiment one or both sensors emit pulses of sonic energy and then detect reflected signals to determine the approach of the object in a danger zone. In another particularly desirable embodiment that responds more rapidly to solid object intrusion, at least one sensor emits a continuous sonic signal and at least one other sensor continuously monitors the signal (or lack thereof) to determine approach of an object.

A preferred embodiment includes: a) an electric motor driven propeller water craft; one or more sensors that scan at least most of the danger zone in front of and/or behind the propeller; and c) a circuit that rapidly halts the propeller upon detection of a solid object in the danger zone. In another form, a preferred embodiment includes: a) an internal combustion motor driven propeller water craft; one or more sensors that scan at least most of the danger zone in front of and/or behind the propeller; and c) a circuit that rapidly halts the propeller upon detection of a solid object in the danger zone. In another form a preferred embodiment includes a) an internal combustion engine driven propeller water craft; one or more sensors that scan at least most of the danger zone in front of the propeller; and c) a circuit that rapidly halts the propeller upon detection of a solid object in the danger zone by activating a friction device attached to the motor and/or propeller shaft.

For purposes of convenience and clarity of the attached claims, the term “danger zone” as used here means a 2 dimensional area that may be upstream or that may be downstream of the propeller covering a plane perpendicular to the propeller axis of rotation, the area including the circle created by the propeller with the propeller axis at the circle center and the propeller tip at the circle circumference. The danger zone area may be positioned in front of the propeller by a distance equal to one propeller diameter. The danger zone area may be positioned behind the propeller by a distance equal to one propeller diameter. The danger zone area may be simultaneously positioned in front of and behind the propeller by a distance equal to one propeller diameter. Other positions may be used. In another embodiment the danger zone is positioned in front of and behind the propeller by a distance equal to two propeller diameters.

In yet another embodiment at least one contact (mechanical) switch or continuous sensor is located on a hull surface to feel when the hull surface approaches a solid object such as a rock or muddy bottom of a waterway. Upon physical contact, a switch activates, and switches a warning device such as a buzzer and/or stops a propeller. The propeller may be stopped for a set period of time such as 1, 2, 3, 5, 10, 20, 30, or 60 seconds or simply switched off. Desirably, a memory device such as a microprocessor records the event, which can be read out later. Also desirably, a custodian of the watercraft, who may be renting the watercraft to the operator, is informed of the event by automated radio signaling. The signaling optionally includes an ID code denoting which watercraft had the event and optionally includes a code denoting how fast the watercraft was traveling when it had the event. In yet another embodiment the system further includes a motor governor circuit that automatically limits the motor power or propeller speed temporarily or permanently upon sensing a predicted collision. In yet another embodiment a kit is provided for adding an electronic propeller guard to a watercraft, including sensors and circuits as described herein, along with one or more fasteners for attaching sensor(s) to the watercraft surface, such as bolts, glue, tape, screws, epoxy, clamps and the like.

Systems that contain Sensor and Activator Circuits An electronic propeller guard in a preferred embodiment comprises a sensing component (circuit or circuit component) and an activating component (circuit or circuit component). The sensing component may pulse monitor or may constantly monitor most (at least 50%), substantially all (at least 90%), virtually all (at least 95%) or all (100%) of danger zone area(s) and detects intrusion of an object into one or more zones. A danger zone preferably is anywhere between the propeller itself to 5 propeller diameters upstream or downstream of the closest side of the propeller surface. In one embodiment the zone is determined at a distance between 0.5 and 1 propeller diameters from the propeller. In another embodiment the zone is determined at a distance of 2 diameters from the propeller. In yet another embodiment the zone is determined at a distance of 3 diameters from the propeller. Upon detection of a solid object, a signal controls an activator circuit that rapidly stops or slows (ie. decreases to less than 60 rpm and preferably less than 10 rpm) the propeller within 0.5 seconds. In one embodiment the activating circuit rapidly stops or slows the propeller within 0.2 second. In other embodiments the circuit stops or slows the propeller within 0.1 seconds, 0.05 seconds, 0.025 seconds, 0.01 seconds, 0.005 seconds and even within 0.002 seconds.

In another embodiment a tactile sensor is located on a hull surface upstream from a propeller and extends at least 1, 2, 3, 5, 8, 10, 15 or 24 inches away from the hull. Two or more sensors can be spaced apart to sense solid objects in a wider volume. In this embodiment a defined “danger zone” per se is not necessarily determined. This embodiment is particularly valuable for sensing rocks on the bottom that may collide with a propeller. In a particularly preferred embodiment, such tactile sensor outputs more than a simple on-off signal. For example, a tactile feeler may be connected to a potentiometer, hall effect sensor, magnet or other device that is used to generate a signal that is proportional to the amount of deflection in the tactile sensor. In an embodiment, a light, buzzer or other signaling device alerts a boat operator to various degrees for example, by increasing the volume of sound as the tactile sensor is deflected more.

This sensor/alert device and/or propeller shut off system is particularly useful when installed on rental watercraft. A major problem with rental craft is the destruction of propellers and propulsion systems by careless users. An alert system as described here can prevent boat damage by at least three different actions. One, a sensed propeller collision can trigger an automatic motor shut down or limit in power, for a set period of time or until the boat returns to the custodian, who may reset the motor power. Two, the system can record instances of detection, and make a record, to be reviewed by the boat caretaker (renter) later on, such as when the caretaker needs to make a decision on giving a withheld damage fee back to the renter. Three, the system can alert the boat caretaker by wireless transmission. The latter technique is particularly useful where the receiver is located at a high enough position to receive signals and no island or other structure blocks transmission. The boat caretaker may respond by controlling the boat via a radio command or by calling the boat operator. For low cost operation, it is very desirable to use family radio, which is particularly suited over water, in many cases for up to two miles of line of sight.

In an embodiment the sensor turns off the propeller and an override switch must be activated to turn the propeller back on. In yet another embodiment a memory device such as a microprocessor records the event and can inform others such as a boat renter of the collision, or near collision history. In yet another embodiment the boat further comprises a wireless transmitter that sends signal(s) to a boat renter indicating the collision/near collision problems in real time, and/or optionally, boat speed information. The wireless reporting of speed, and/or boat collisions with solid objects in real time may be used for other embodiments as well.

In an embodiment that intends to protect people who fall directly or nearly directly on top of the propeller, a danger zone in front of the propeller is extended to include an area vertically above and immediately in front of the propeller, hereinafter termed “extended danger zone.” By “an area above and immediately in front” is meant a rectangular and horizontal surface area beginning above the top of the propeller arc (immediately at the top of the propeller arc or up to one propeller diameter above that point). The rectangle width is the propeller diameter and length extends from the rear of the propeller forward two propeller diameters or until a hull surface is reached. An extended danger zone also may exist behind the propeller.

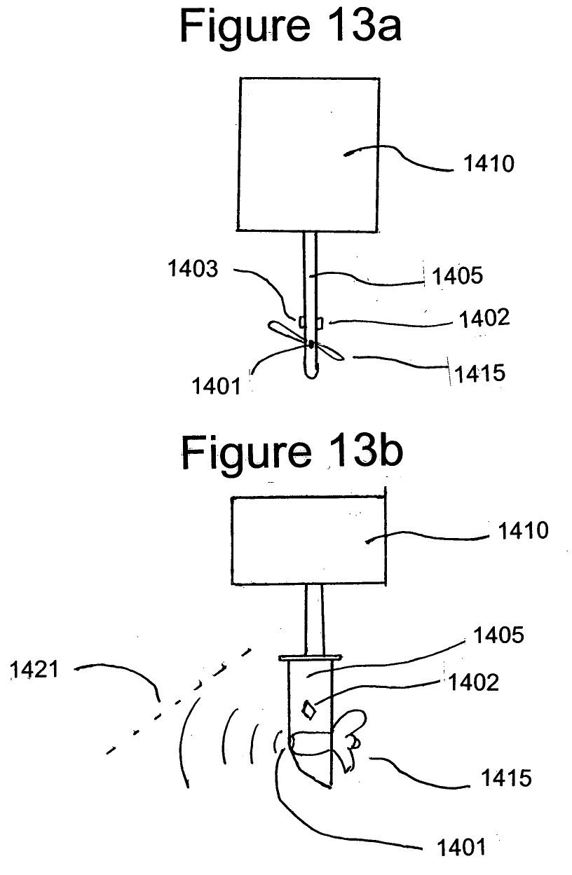

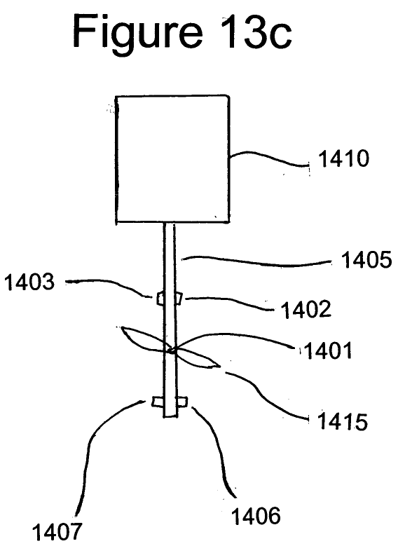

By way of example as seen in FIG. 13b, an extended danger zone for a 10 inch propeller 1315 consists of partly horizonal (45 degrees from horizontal) area 1321 (see dotted line, which is a cross sectional side view) that extends above propeller 1315 and ahead, and utilizes sensor 1302. Not shown in this figure is another sensor directly behind sensor 1302 and that monitors the other side of the drive shaft (including the right half of the partly horizonal zone). Both sensors are directed up towards the water surface and forward towards the front of the boat. In one embodiment the sensors are directed between 30 and 60 degrees down from the horizontal, facing forward. When a piezoelectric crystal sonic sensor is used for this embodiment, the flat surface of the crystal preferably is perpendicular to the desired angle. Of course, other danger zones and extended danger zones may be desired and used depending on the circumstances of each specific application and the examples provided herein are representative in that regard.

A sensor which monitors the danger zone or extended danger zone signals an activator to quickly halt the motor upon sensing an intrusion into that zone. Of course, most sensors will respond to intrusion into a larger zones than that defined here. A sensor often will monitor a much larger area and space, and the “danger zone” and “extended danger zone” defined here are minimum areas that should be monitored for satisfactory operation.

In an embodiment the sensor outputs a signal that triggers an activator circuit that quickly halts the electric or fossil fueled motor which drives the propeller. The activator may be as simple as a control component such as a resister, MOSFET, relay or capacitor involved in signaling or that directly controls the electric motor power or a motor circuit, or a power circuit that energizes a brake (and/or shuts off ignition) in a fossil fueled system but generally will comprise a larger portion of an overall control circuit that dissipates the motor kinetic energy or, more preferably applies an opposing field to actively push against the angular kinetic motion of the motor shaft. In one embodiment a friction brake halts the fossil fueled motor without halting an ignition high voltage (spark) pulse and preferably halts between sparks. In another embodiment that employs a fossil fuel powered engine an ignition spark is interrupted and a friction brake is energized.

Upon activation by the activator circuit the motor control decreases propeller speed to below a value, (preferably 120 rpm or less, more preferably 60 rpm or less, yet more preferably 30 rpm or less, more preferably 10 rpm or less) and more preferably stops the propeller before an object detected in the danger zone can contact the propeller.

Preferably the motor shaft directly couples to the propeller, to allow rapid changes in angular shaft momentum without an intermediary transmission (gear(s) belt(s) or other means) to change rotation speed. A big problem with some watercraft that hinders optimum use of an electronic propeller guard as described here is the inability of many motor/transmission/propellers to suddenly stop without damaging the motor or (if used) transmission. Another problem has been the inability to rapidly slow or stop the propeller with a few revolutions or even within a single revolution. An embodiment to address this problem uses a clutch plate or other mechanical device which disconnects the motor shaft from the motor and/or transmission (i.e. reduction gear). Such devices are appreciated by mechanical engineers.

The Sensor Circuit A sensor circuit comprises one or more electronic components that output an electric signal indicating intrusion of a solid object into water in front of a sensor. A large variety of sensors may be employed that can scan the water (and in some cases air space above the water) immediately in front of, to the rear of, and/or above and below the propeller during propeller motion. Galvinometric devices can be used by measuring conductivity in the water and detecting intrusion of a body that differs in conductivity. Galvinometric (conductivity) measurements generally require use of strong signal processing or filtering to remove unwanted signals such as that produced by wave and bubble activity. These and radiowave devices using pulsed or constant energy fields can be used to sense such objects and/or their movement, as, for example, described in U.S. Pat. Nos. 5,694,653; 3,329,929 and 5,019,822 and described by Gagnon and Frechette, IEEE Annual International Carnahan Conference on Security Technology (Oct. 12-14, 1994 meeting in Albuquerque N. Mex., pp. 2630).

A tactile sensor may be an on-off switch such as a microswitch connected to a feeler such as a wire whisker or stick or fin. A wide variety of tactile sensors are known and may generate continuously varying signals. For example, an optic fiber may be used that alters the degree of deflection by optic changes within the fiber as the light path shortens or lengthens with bending. A hall effect sensor (or conjugate magnet) may be attached to a probe on the inside of a boat and generate a signal as the probe moves.

Sonic sensing with Piezoelectric Devices Most preferably a sensor uses piezoelectric device based sonic sensing within the water, with either (a) at least one piezo device as a transmitter and at least one piezo device as a receiver or (b) one piezo device that acts as both transmitter and receiver, by alternately sending an acoustic signal and then detecting reflection of that signal. The term “sensor” as used herein includes both (a) and (b) type acoustic sensors. The piezo substrate movement generates a voltage that is amplified and compared or adjusted to make a control signal. This sensing technique is known, as for example, exemplified in U.S. Pat. Nos. 5,146,208; 5,168,471; 5,168,473; 5,313,556; 4,349,897; 4,780,085; 5,209,237 and 5,418,359.

Preferably the sound energy is continuously created as a pulse, or more preferably as a continuous tone or tone pattern. For faster response it is particularly preferred to use ultrasonic frequencies over 20,000 hertz, although audible frequencies also may be used. This is because many desirable_lock in circuits require detection of one or several complete cycles to lock in and make an accurate detection of a reflected or refracted sound, or sudden loss in the sound. By way of example a lock in circuit that requires detection of two cycles of a particular frequency will require at least 0.002 seconds to detect the presence or absence of a 1 kilohertz wave and may require even more time. Other circuits that generate or detect more complicated waveforms or patterns likewise require a minimum frequency and or periodicity of pulse for fast response. Preferably a constant energy output device is used that generates a constant frequency of at least 8 kilohertz, more preferably at least 20 kilohertz and yet more preferably at least 40 kilohertz.

Higher frequencies of above 20,000 and particularly above 40,000 and even above 100,000 are particularly desirable to improve response time, efficiency and directionality of transducers used for sonic sensing. The higher frequency energy has corresponding shorter wavelengths. In an embodiment a transducer is used having at least one vibrating (or vibration sensing) surface in contact with water that is approximately (within 10 percent, preferably within 3 percent) the same length as the wavelength of the sonic wave in water. The wavelength of the sonic wave in water is determined by dividing the speed of sound in water by the frequency of the sonic vibration. In an embodiment one or more sonic transmitters are used with such dimensions together with one or more detectors that can be of any size. This is because efficiency and directionality of the transducer is more important for the transmitter than for the detector for embodiments that utilize separate devices.

Particularly desirable is the use of a ceramic or other solid piezoelectric transmitter operating at a resonant frequency and/or selected overtone frequencies, together with a plastic piezoelectric detector that responds to a wide range of frequencies. The inventor discovered from experiments that organic polymer piezoelectric devices (such as plastics) are very useful for sensing but work best when used together in a system with inorganic devices (such as a ceramic) as transmitters. Accordingly, in an embodiment a preferred sensor includes an inorganic device as a transmitter and an organic device as a receiver. The two devices in many permutations are best placed at different locations of a hull or hull extension, with a transmitter sending energy away from the hull in one direction and the receiver facing away at a different direction to receive energy. In one embodiment the transmitter and receiver directions are approximately ninety degrees (ie. 30 to 150 degrees, more particularly 45 to 135 degrees) apart. This orientation, while not that useful for determining distance, is very useful for robust yes/no detection of solid objects, because scattered energy that may reflect off of surfaces further away than the danger zone will be greatly diminished as a result of the positional orientation.

In a desirable embodiment two frequencies or pulse types are used together to sense two different danger zones simultaneously. For example a starboard side piezoelectric transmitter may be used at 40 kilo hertz and emits 40 kilohertz sonic waves on the starboard side. A port side piezoelectric transmitter may be used at 60 kilo hertz and emits 60 kilohertz sonic waves on the port side. A piezoelectric detector that responds to both signals (one representing a port side danger zone and the other representing a starboard side danger zone) may be placed in the center and generates electrical signals corresponding to both zones. A wide bandwidth sensor such as a plastic piezoelectric should be used in the embodiment where one sensor detects two different kinds of signals. Of course, one or more separate detectors may also be used for each transmitter and multiple common detectors may be used, as well as combinations of this. In yet another embodiment three or more different transmitters are used with one or more sensors. In yet another embodiment two pulsed transducers use the same frequency but are synchronized, as described in U.S. Pat. No. 6,377,515 issued Apr. 23, 2002.

In a most simple arrangement, flat or mostly flat sensors are mounted on different portions (hereinafter “control surfaces”) of the boat hull. Preferably the transmitter constantly sends out a signal or pulses the signal. In one embodiment the receiver constantly reads a reflection signal, and a difference in the received signal (increase in reflected signal compared to a previous background signal) indicates entry of an object into the danger zone or extended danger zone. The sensor circuit(s) should be tuned to detect only solid bodies in the immediate vicinity and in the danger zone or extended danger zone. Preferably the sensed zone will be larger than the danger zone (or extended danger zone) in order to provide a greater margin of safety.

Another embodiment uses galvinometric measurements to detect intrusion of a solid body into the danger zone. In this case one or more electrical measurement are continuously made (by pulsing, application of a varying electric current, or direct current, or a combination) between two or more electrically conductive contacts on a control surface(s). A change in conductivity (or related parameter such as impedance if using a varying electric current) indicates the entry of a solid body. In a simple case, an increase in resistance is detected by monitoring a sudden decrease in current between two electrodes. This embodiment works best with a high frequency (radio frequency) field because such field can be set up more precisely between two points and can be altered specifically by the presence of living tissue that contains electrolytes and that interferes with the electromagnetic (radio) field. Yet another embodiment uses infrared sensor(s) to detect an object, as for example described in U.S. Pat. No. 5,369,269.

For galvinometric (or radiowave field) detection it is best to continuously monitor the space between control surfaces and to detect changes above a baseline conductivity or field strength to signal intrusion of a solid body. This is desired because different waters and conditions can give very different conductivity and/or field penetration characteristics. For example, when the boat moves into water that is more salty, the sensors will detect greater conductivity and/or altered field strength penetration. Such simple filtering for sudden changes allows automatically cancellation of slow changes in background signal and improves system performance. Accordingly it is most preferred to use a comparison step whereby the sensor output continuously is compared with a running average to detect rapid changes above a threshold as for example described in U.S. Pat. No. 4,890,265. In another embodiment a reference signal is used with two or more electrodes or sensor surfaces positioned near each other and by detecting the background change in water conditions (for example conductivity changes) for a comparison. An additional reference sensor similarly can be used for background adjustment for acoustic detection as well.

The Activator Circuit The activator rapidly stops the motor upon being triggered by the detector and thus halts the propeller. In practice, the sensor and activator “circuits” often are separate portions of a common circuit since they are best combined into a common design. The activator circuit may act upon a fossil fuel powered boat by interrupting ignition sparks to the sparkplug(s), if used and by engaging a friction device. For use with an electric motor, the activator energizes or alters an electromagnetic field(s) to halt the motor movement.

In preferred embodiments for use with internal combustion engine driven propeller systems, the activator interrupts high voltage pulses to the spark plugs and also engages a friction device to absorb kinetic energy of the motor and propeller shaft. A large variety of means for stopping voltage pulses to the spark plug(s) are easily determined by a skilled artisan. The friction device preferably is attached to the motor crankshaft and/or propeller shaft.

A preferred friction device for internal combustion engines is a disk or other solid surface that is attached to the motor and/or propeller shaft and upon which a disk brake pad or shoe applies force, slowing or stopping the rotation. A variety of devices are known that that rapidly stop a spinning axle. For example, Bendix Corporation has designed and sold a variety of friction brake and friction clutch devices, and represents some of the known engineering that may be applied to this embodiment.

Magnetic braking also may be used to rapidly stop or slow a propeller shaft. In one embodiment a permanent magnet is mounted to the shaft and rotates within a surrounding electromagnet. When braking is desired an electrical current is applied to the electromagnet in a manner (polarity, timing etc) such that the induced electromagnetic field(s) oppose the permanent magnet field(s). This permanent magnet and electromagnet system also may be used as a starter motor for the internal combustion engine and as an electric generator. In another embodiment both the shaft and the surrounding fixed magnetic fields are created by electromagnets, in which case brushes may be used to provide a connection to the moving shaft electromagnet (armature).

In preferred embodiments for stopping an electric motor the activator circuit (or portions of the larger combined circuit) reverses direction of an electromagnetic field of the motor by reversing the polarity of the electric current flowing through the one or more electromagnets until the motor has come to a stop, or a near stop (preferably less than 100 RPM, more preferably less than 60 RPM and most preferably less than 10 RPM) within 0.5 seconds. In another preferred embodiment activator circuit halts the motor within 0.2 seconds and in another preferred embodiment the activator halts the motor within 0.1 seconds. Where the propeller is driven by a separately excited brushed motor the polarity of the fixed coil (outside the armature) is reversed and the back emf or the motor (or motor/propeller rpm) may be monitored until the speed has dropped to zero or below a low detectable value.

Other procedures to rapidly brake electric motors are known and are useful. In the case of a simple permanent magnet motor, the motor kinetic energy may be suddenly absorbed by a circuit that shunts the drive leads to a low resistance. Preferably the polarity of applied voltage is reversed, in a manner that does not overstress the motor. Numerous techniques for rapidly braking an electric motor are known and contemplated for this embodiment. Examples of such control systems may be found, for example, in U.S. Nos. 6,094,023 (Method and Device for Braking an Allmains Motor); U.S. Pat. No. 5,847,533 (Procedure and Apparatus for Braking a Synchronous Motor); U.S. Pat. No. 5,790,355 (Control System); U.S. Pat. No. 4,933,609 (Dynamic Control System for Braking DC Motors); U.S. Pat. No. 3,628,112 (Dynamic Braking of Electric Motors with Load Changing During Braking); U.S. Pat. No. 3,548,276 (Dynamic Braking of Universal Motors); and U.S. Pat. No. 3,794,898 (Dynamic Braking of Electric Motors with Thermistor Braking Circuit), the contents of which specifically are incorporated by reference in their entireties.

An example of rapid braking of high power three phase motors is the product by MTE, a United Kingdom company with a website at entrelec-mte.co.uk. The emergency braking system that is commercially available from this company can be adjusted to halt a motor within 0.5 seconds but could be modified for even shorter stopping times. A boat propeller motor can be halted faster than a corresponding electric car motor because of the lower torque involved with the propeller compared with the car.

Rapid braking of direct current brushless motors is also known to the skilled artisan. The use of a feedback signal based on the back EMF of the motor triggers current flow from the motor into a controller to facilitate an emergency stop, as described for example in U.S. Pat. No. 5,659,231. Also relevant in this context are the disclosures of U.S. Pat. Nos. 6,215,261, 6,084,325 and 6,078,156. Another improvement to resistance based dissipation of motor kinetic energy for brushless motors is described by U.S. Pat. No. 4,426,606. This latter patent teaches a way to dissipate energy stored in the inductance of the winding of the brushless motor by selecting a capacitance to match the winding inductance.

Further systems for adding energy into a motor to oppose the forward motion of the motor are well known and an engineer can find such circuits and techniques in the regular literature. In each such preferred embodiment, a rapid braking circuit activates upon sensing an object upstream, near to or within a danger zone or extended danger zone by the sensor circuit. Preferably two or more sensors are used for broader coverage of a danger zone. Even more preferably time averaging is carried out to detect changes in detected signals and eliminate spurious background signals.

Transducer Placement and Use Transducers (both transmitters and receivers, as well as combination devices) may be placed in a wide variety of locations and in a wide variety of combinations. FIGS. 10 to 15 illustrate representative locations and are discussed next. Tactile feeler sensors can be placed in a wide variety of locations. FIG. 15 shows one representative arrangement of four sensors on boat hull 1505, two of which are seen in this side view. Sensor 1510 is located on the left side and near the deepest part of the 21 foot long hull and extends 3 inches vertically below the lowest point of the hull. Sensor 1520 (not shown) is on the other side of the hull. Sensor 1530 is near propeller 1540 on outboard motor 1550, having a tip that is 10 inches away from the propeller. In some embodiments a tactile sensor such as one near the propeller has a flat surface (fin shape) that aligns with the water flow and may resemble a movable fin.

In yet another embodiment the sensor is a piezoelectric device that is attached to a fin or even the hull itself (on the outer surface, or on the inner surface, if stiff enough to transmit vibration such as aluminum or fiberglass). The piezoelectric device monitors solid object collisions, which produce detectable vibrations. In an embodiment sharp short time duration vibration collision(s) with one or more sharp protuberances of a hard object (rock) is distinguished from a longer time duration vibration collision with a muddy or sandy bottom via signal filtering hardware or by software analysis of the information.

FIGS. 10a, 10b, 1a, 12a, and 13c show related embodiments where sensors are positioned above and below the propeller axis. FIG. 13a and FIG. 13b also show optional sensors 1302 and 1303 that are positioned above the axis and which scan to the port and starboard positions, respectively, of a danger zone. In an embodiment the sensors are angled up from the horizontal to take in most or all of the extended danger zone. The optional two sensor system shown in FIG. 13a and FIG. 13b uses sensors 1302 and 1303, which are tilted up, but not 1301 and can detect solid objects that fall into the water immediately in front of the propeller. In this context sensors 1302 and 1303 are able to detect object above them, and in some cases as is shown here are angled up for better detection in that area.

FIG. 13b also shows rear-ward facing sensor 1331 that monitors part of or all of a danger zone to the rear of propeller 1315. In one embodiment sensor 1331 is tilted up at an angle to monitor at least part of danger zone 1333. Other embodiments of rear-ward facing sensors can be prepared by placing appropriate sensors at other locations of this and other control surfaces and are specifically contemplated.

In some embodiments separate danger zones are sensed both above and below, and to both sides of the propeller axis. Accordingly, it is preferred to use either a single sensor that monitors a wide area, such as sensor 1301 in FIGS. 13a and 13b, or, more preferably multiple sensors. In one embodiment a first sensor is positioned on the left side of a control surface in the middle of a slip stream and monitors at least the left half of the zone. A second sensor positioned on the right side of the control surface monitors at least the right half of the zone.

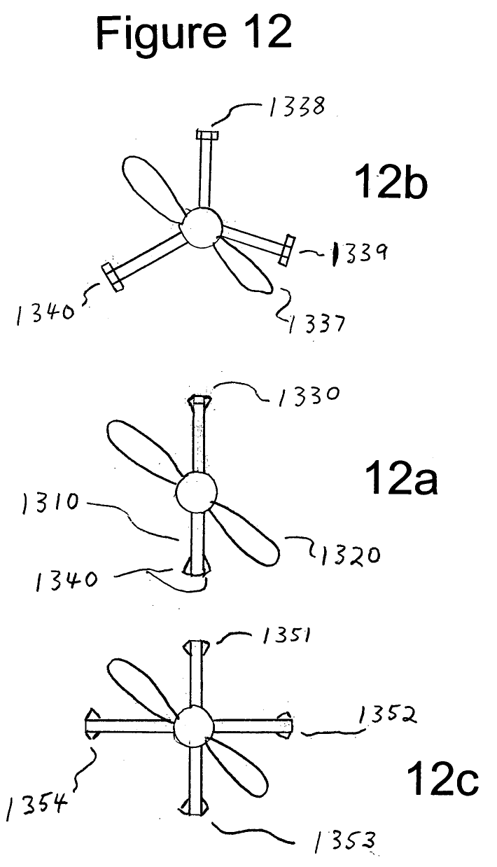

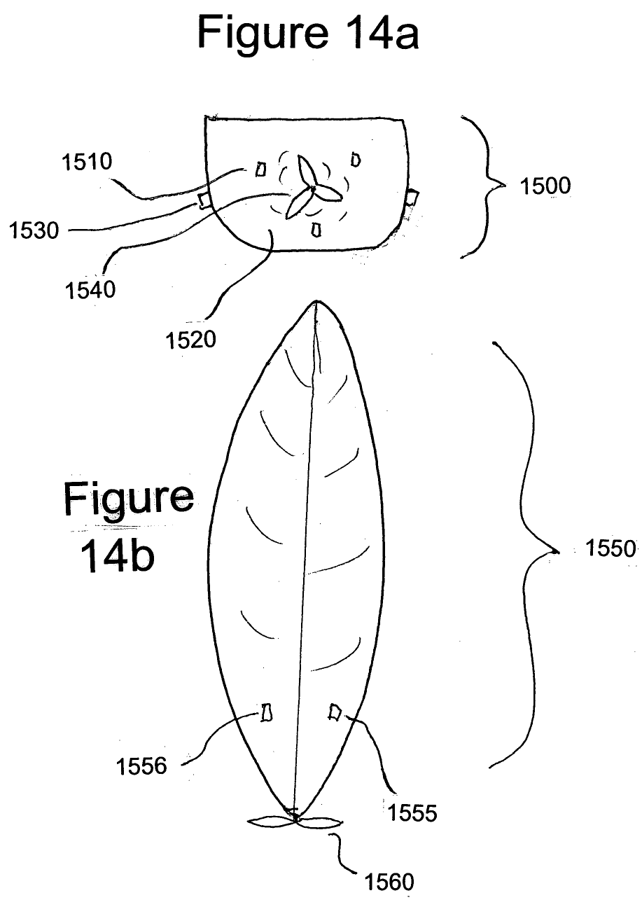

In another embodiment 3 sensors are used, with one monitoring the left side or lower left side, one the right side or lower right side, and one monitoring the top of the danger zone. A three sensor system may, for example, utilize control surfaces as shown in FIG. 12b and FIG. 14b. Sensors 1301, 1302 and 1303 of the system shown in FIG. 13c also may be used together in a 3 sensor system. FIG. 12c shows a representative embodiment with four sensors. In some embodiments such sensors may be used to detect the presence of objects to the rear of the propeller. These are particularly important to prevent contact with swimmers who may be behind or at a propeller when the propeller is first turned on, or when the boat motor is switched into reverse.

In some cases to save money and help provide an economical product that would be acceptable (not too costly) to the marketplace, the lower portion of the danger field may be ignored, as such sensing is still better than none. However, in the non-tactile sensor embodiment, full sensing at least somewhere in the danger zone area within two propeller diameters upstream of the propeller is greatly desired. In a preferred embodiment the monitored danger zone is close to the propeller, and may be within 0 and 1 propeller diameters upstream or downstream of the propeller to more accurately detect all object that will come into contact. In another embodiment the minimum circular area that is constantly monitored is at least 1.5 times the diameter of the propeller and in another embodiment the minimum area being monitored has a diameter that exceeds twice the propeller diameter. These latter cases provide a greater margin of safety. Other geometries can be devised by an engineer and are not presented here for the sake of brevity.

When mounting one or more sensors on the boat hull, preferably one or more piezo transmitters are positioned at the sides of the boat at an angle facing rearwards so as to cover most or substantially all of one or more danger zones. A single sensor may be used at the center line. Preferably, however, sensor(s) located on the hull bottom are used together with one or more at the sides to cover shallow regions of a particular danger zone. In another embodiment the extended danger zone above the propeller is monitored to detect things falling into the water there. In another embodiment tactile sensor(s) are added immediately upstream (within 1, 2, 3, 5, 10 propeller diameter distance from the propeller.)

One or more receivers may be positioned near the transmitters or a single sensing unit (transmitter and receiver) may be combined into a single piezoelectric device as is customarily used for fish finders, for both transmission and detection of sonic energy. In an embodiment, a receiver and transmitter are incorporated into the same device, such as a thin film that may be mounted on a hull. The doppler effect may be used for sensing and a more simple detection of minimum reflected energy measurement can be used. Of course skilled workers have a large range of techniques in this field to implement the sensing. Wires from the piezo devices (if used) preferably pass through the hull behind or near the sensor devices. In a preferred embodiment a high Q high impedance piezo electric sensor is used with a field effect transistor amplification stage at or in the sensor. This serves to convert a high impedance low current signal into a lower impedance signal prior to transmittal over electric wires, and makes the system less sensitive to electrical noise.

The system may be turned off while maneuvering next to a dock and the system's sensitivity may be electronically adjusted to sense minimum sized objects to prevent energizing upon detection of small debris or bubbles within the water. This system also may be integrated into a sonar for detection of solid objects such as fish and bottom structures. A skilled electronics artisan will appreciate how to prepare and/or adjust circuitry and/or software to detect particular types of objects. For example, a system that recognizes a rope is useful for avoiding entanglement with lobster traps and the like.

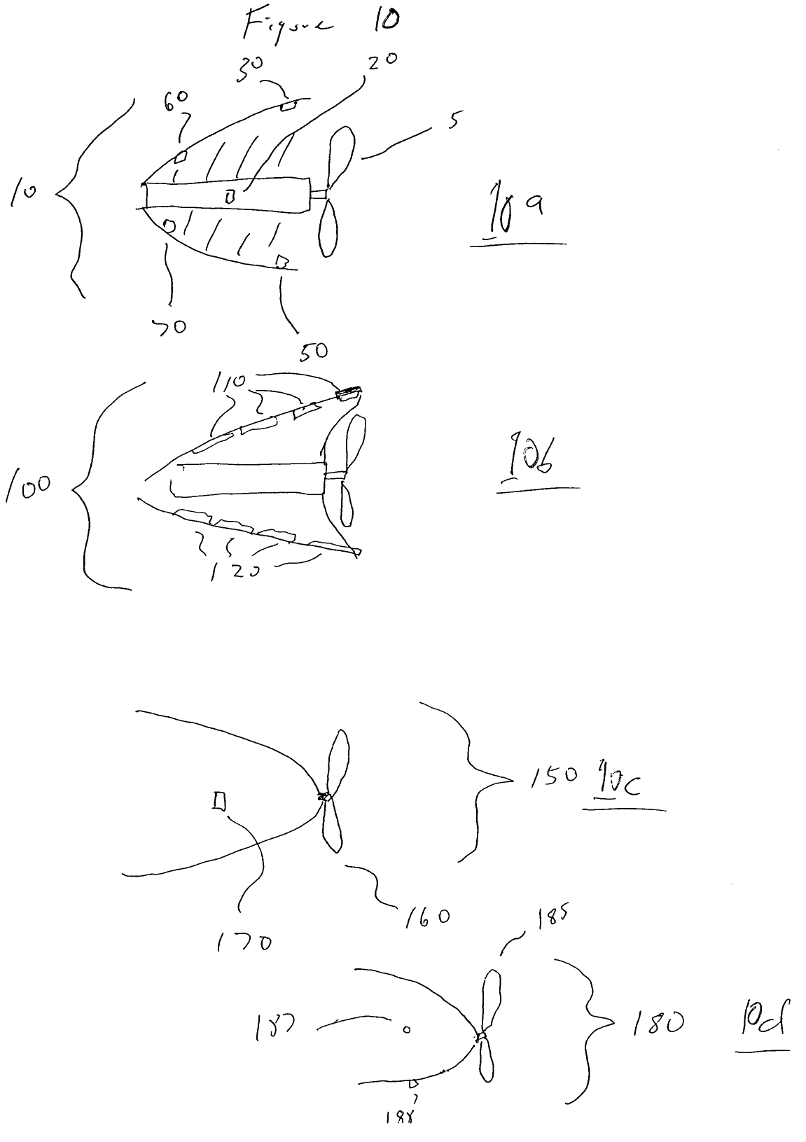

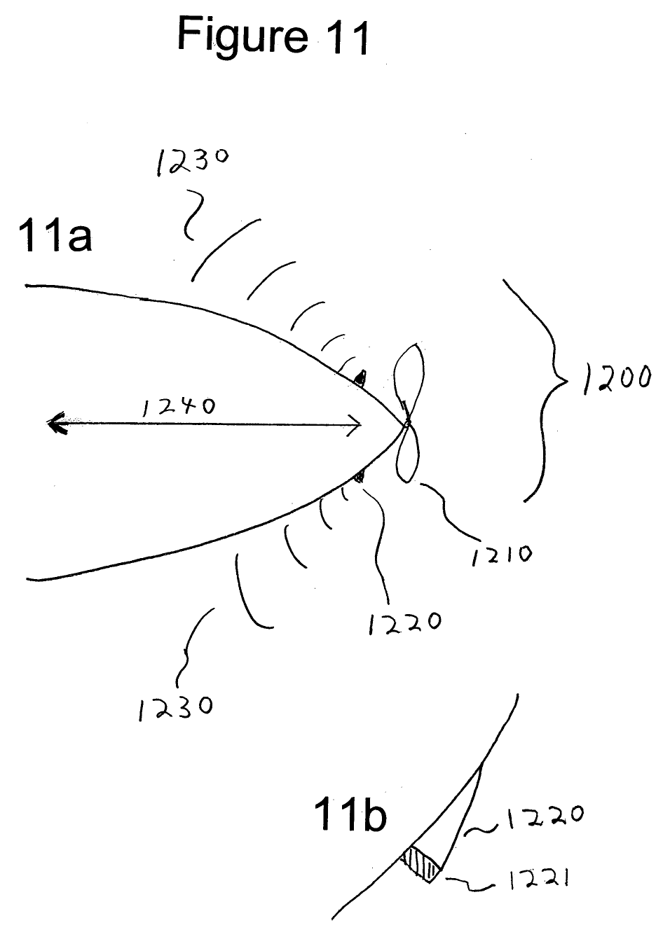

In most cases a sensor is mounted on a control surface, which is a solid surface of the boat or an attached component such as an outboard motor fairing, rudder or fin that contacts the water upstream of the propeller(s) and experiences water flow during forward boat motion. A control surface may influence boat movement. The hull of a boat is a control surface. Preferably a hull surface close to the propeller is used to mount a sensor, as shown in FIG. 14. A fin, rudder or other surface that participates in boat attitude stability, boat direction, speed and so forth also is a control surface. FIGS. 10 to 14 show representative control surfaces. The control surfaces of FIGS. 10 to 11 are rudder or stabilizer fins, as might be found in a submarine, inboard motor powered boat such as that commercialized by ElectroCruise Boats of Homosassa, Fla., “kakusu maruta” boat such as that commercialized by Maruta Electric Boatworks, and the like. The control surfaces of FIG. 13 are part of an outboard motor such as the type commercialized by Ray Electric Outboards Inc. and that by Briggs & Stratton.

Most propellers have one or more control surfaces immediately upstream of the slip stream to take advantage of the high flow rate of water found immediately in front of the propeller to control boat movement. Likewise, a swimmer's body is at great risk in this area because of the high water flow and the risk of being pulled into that same slip stream. In this context, preferred embodiments may be thought of as adding intelligence to these control surfaces.

Placing sensors as described herein immediately upstream to the propeller (in the slip stream) on control surfaces provides other advantages relating to boat intelligence as well. Such sensing can report the state of flow of water over those surfaces. That is, the sense signal(s) can be used to output a propulsion status indication, boat speed indication (by virtue of monitoring reflectance from, for examples bubbles that pass between adjacent sensors), cavitation, presence of weeds, water turbidity, relative efficiency of movement useful for controlling optimum motor power, and the like. For example, weeds and turbidity can be detected with correct selection of sonic measurements and/or with infrared detection.

Movable tactile feeler(s) such as a rod, wire or fin may be used that have a sensor to create a continuously variable electrical signal corresponding to pressure on the sensor. Preferably such sensors are further utilized to obtain more information beyond predicting collision with a propeller. A tactile sensor may be arranged that outputs a signal that changes with boat speed. As the boat moves faster, more deflection of the tactile sensor exists and (typically) a greater deviation signal is generated, indicating higher speed. Such sensors thus can be used to detect speed as well as collisions.

Most propellers are used in a reversed direction at times to make a watercraft travel backwards. This motion is especially dangerous to swimmers located to the rear of the propeller and in preferred embodiments one or more sensors are directed to sense a danger zone to the rear of the propeller to alleviate this problem.

Rapid Stopping of an Internal Combustion Engine Driven Propeller In a preferred embodiment for fossil fuel powered internal combustion engines the activator interrupts high voltage pulses to the spark plugs and also engages a friction device to absorb kinetic energy of the motor and propeller shaft. A large variety of means for stopping voltage to the spark plug is easily determined by a skilled artisan. The friction device preferably is attached to the motor crank shaft and/or propeller shaft.

A preferred friction device is a disc or other solid surface attached to the shaft and upon which a disc brake caliper or shoe applies force, slowing the rotation. A variety of braking devices are known. “Bendix” has commercialized a number of such brakes and clutches over the years that may be used or modified for this embodiment.

Magnetic braking also may be used to rapidly stop a propeller shaft. In one embodiment a permanent magnet is mounted to the shaft and rotates within a surrounding electromagnet. When a braking is desired, an electric current is applied to the electromagnet in a polarity such that the individual electromagnetic field(s) oppose the permanent magnetic field(s). This electromagnetic/permanent magnet system also may be used as a starter motor for the internal combustion engine and as an electricity generator. In another embodiment both the moving magnetic field(s) and the fixed field(s) are made from electromagnets.

Multiple Users via Multiplex Systems An important feature of many embodiments is continuous sensing of one or more danger zones through constant emission of signals, either sonic, galvanometric, infrared, microwaves, or other. When two or more boats come close to each other signal(s) from one boat may be sensed by another. If the interfering signal is similar (eg, in frequency, pulse coding etc) to the expected signal then the interfering signal may trigger an improper propeller turn off. In some situations, such as during collision avoidance maneuvering this turn off can lead to undesirable loss of control. This embodiment provides systems for removing or alleviating the effects of such cross talk.

According to embodiments a propeller shut off system automatically senses the presence of the coded sensor of another boat and shifts frequency or pulse form in response. According to this embodiment, after the propeller automatically is shut off in response to sensing an intrusion into a danger zone, the signal generator, (such as piezoelectric transmitter, galvanometric current, infrared radiation, microwave or other electromagnetic radiation etc) is switched off and the danger zone monitored. If the danger zone intrusion signal remains then the system switches into multiplex mode. In multiplex mode the system alters to the use of a different frequency or other signal characteristic, which at least potentially avoids the other signal system. This alteration (turning off the danger probe signal, monitoring for loss of sensed signal, and moving sensor system to a new frequency or pulse characteristic if needed) preferably occurs rapidly, preferably less than 0.5 seconds and more preferably in less than 0.1, 0.1, 0.05 and even less than 0.025 seconds. Because of the short time period required for this operation, in most instances one boat will move its sensor characteristics (such as frequency) before the other danger zone intrusion system is activated.

Examples of Electronic Propeller Guards The sensor circuit(s) are applicable to a wide range of control surfaces. In these examples the term “sensor” means a piezoelectric device in the context of positioning on a boat hull or other control surface. The term sensor also is used in a general sense to include associated circuitry (not located on the hull in these examples) that output a signal (or trigger a control portion of a common circuit).

### Example 1

Piezoelectric of acoustic sensor 120 is mounted on the port side of boat fuselage/fin 110 as shown in FIG. 10a. The sensor comprises a flat quartz crystal and a drive/monitoring circuit (located inside the boat) such as used in fish finding equipment and is adjusted to provide a signal when a submerged solid object presenting more than 1 square inch cross sectional area is placed 15 inches directly in front. Another piezoelectric from a second sensor (not shown) is mounted on the opposite starboard side of fuselage/fin 110. The faces (plane of the vibrating piezoelectric crystal) of the sensors are pointed forwards away from the propeller at a 10 degree angle away (toward the starboard and port sides respectively) from the central axis of the boat such that each sensor monitors the water on each respective side of fuselage/fin 110 in front of the propeller.

The signals from sensors 110 and 120 trigger an activator. The activator may brake an internal combustion engine or may control the power to the armature of a permanent magnet electric motor by a control circuit that uses pulse width modulation. The activator in this case includes a voltage sensor (input resistance) that accepts a voltage output from the sensor circuit when a threshold signal indicate a minimum sized object in the danger zone. When sensor 120 and/or the other sensor detect the solid object and cause a signal output, the activator reverses the power output from the controller control circuit until the back electromotive force induced in the control circuit from the kinetic energy of the slowing motor reaches a minimum threshold value (indicating a low or no speed condition).

In a variation of this example, two sensors 130 and 150 are positioned at the top and bottom as in FIG. 10a. In yet another embodiment additional sensors 60 and 70 are used in combination with sensors 30 and 50. Here, all four sensors are pointed directly to the front. In another variation rather than using the a single sensor to monitor a given area in a pulse generation and detection mode (such as used for fish finders) one piezoelectric device is used as a transmitter and another is used as a receiver, to allow greater short range sensitivity and greater immunity from false signals. In this case pairs of sensors are used (one on top and one on the bottom) to generate a signal at one sensor and receive at the other. If a solid body enters the space near the sensor, that body will reflect sonic energy to the receiver. A threshold detecting circuit then outputs a signal when the reflected energy exceeds a given set value.

### Example 2

In this example galvinometric measurements are made using electrodes 1110 and electrodes 1120 on fin surface 1100 shown in FIG. 10b. The measurements are input into a comparator that monitors and adjusts for long term (more than 5 seconds) changes in conductivity. When a solid object enters the volume between the upper and lower electrodes, galvinometric measurements indicate a short term change in conductivity and output a signal to a control circuit, stopping the propeller. In further embodiments conductivity between pairs of facing electrodes is used to detect an approaching body, which perturbs conductivity between the left most electrodes before doing so to pairs of electrodes to the right.

### Example 3

In this example, boat hull 1150 of FIG. 10 has an attached propeller 1160 and a outside-rear facing piezoelectric sensor 1170. A second sensor that also faces outside (away from the boat) and towards the rear is mounted on the opposite side from sensor 1170. Both sensors (including their signal analysis circuitry) monitor for intrusion of a solid body and are adjusted to ignore signals from the propeller. Upon detection of a solid body, the motor/propeller control circuit causes the propeller to stop suddenly.

In a variation shown in FIG. 10d boat hull 1180 has an attached propeller 1185 and three outside-rear facing piezoelectric sensors. Sensor 1188 is located at the bottom of the hull and sensor 1187 is located two thirds the way up the hull on the port side. A third sensor (not shown) is located two thirds the way up the hull on the port side. The three sensor have overlapping fields of detection. In this example each piezoelectric sensor uses a separate frequency and can locate a solid body independently.

In another embodiment related to this four sensors facing out and to the rear are used on a hull such as shown as hull 1180. One transmitting sensor is at the bottom at the location of sensor 1188. A second transmitting sensor is at the center top of the hull. Half way between the two transmitting sensors and half way up on both sides are two receiving sensors. During operation the transmitting sensors emit 20 Khz sonic vibrations. The side-mounted sensors receive some sonic energy reflected off of the propeller blades and this reflected signal is filtered out by a filtering circuit. When a solid object enters a danger zone, (which is defined for purposes of illustration as half way from the sensors to the propeller) the reflected signal from either the top and bottom transmitter is received by at least one of the side receivers and an output signal is sent to a control circuit that rapidly stops the propeller.

In another embodiment 6 sensors are equally spaced in a ring in like manner about the axis of a hull as shown in FIG. 10d with alternating transmitting and receiving piezoelectric transmitters and receivers. The extra sensors improves the coverage available. In yet another embodiment the sensors as described in this example are mounted 6 inches to the front of the propeller at separate locations (top and bottom, side etc) as before, but facing out and forward, away from the propeller.

Preferably the sensors are pointing between 5 degrees and 60 degrees away from the long axis of the boat, and more preferably between 15 degrees and 45 degrees. FIG. 11 depicts this embodiment. Boat hull 1200 has attached propeller 1210. Sensors 1220 and 1225 are shown at the bottom and top of the hull respectively for convenience. Sonic waves 1230 are emitted from the sensors, which also detect reflective signals. Sensor 1220 has face 1221 that points away from propeller 1210 (FIG. 11b). The plane of 1221 is partly perpendicular to boat axis 1240. The angle between vector 1240 and face 1221 (FIG. 11a) preferably is between 15 and 45 degrees. In other embodiments sensors have similar respective faces that may point toward the propeller at the rear, and preferably make an angle between 15 and 45 degrees with respect to the boat axis vector.

When using rear directed sensors, it is important to space the sensors further away from the propeller, preferably between 1 and 5 propeller diameters from the propeller towards the front of the boat. It is important in these cases generally to correct for signals produced from the propeller, as the propeller will generate a reflected signal. In one embodiment a propeller speed signal (preferably measured from a tachometer) is input to a correction circuit that will help correct for the propeller signal. The background propeller signal in most instances will change with propeller speed. By monitoring the speed, better background signal correction can be used.

### Example 4

This example illustrates detection of a solid object using sensors attached to one or more fins immediately in front of the propeller.

FIG. 12a shows single axis fin 1310 in front of propeller 1320. Sensors 1330 and 1340 are mounted to the tops and bottom of fin 1310 four inches in front of propeller 1329 and face forward. These sensors are piezoelectric and detect solid objects in the manner described in Example 3. FIG. 12b shows 3 axis fin 1335 in front of propeller 1337 with sensors 1338, 1339 and 1340 at the tips of the fins facing directly forward and perpendicular to the boat long axis. In this example, the fins have the greatest size at the very rear near the propeller (not shown). Thus, the sensors have clear space in front to send and receive sonic vibrations to detect intruding solid objects. The individual sensors can be independent (the same piezoelectric device is both a transmitter and receiver) or may be coordinated with each other by sending signal(s) between them. Upon sensing intrusion of a solid body via reflected sonic energy (echo) from the intruding body surface, a sensor or sensor combination triggers a control circuit to quickly stop the propeller.

FIG. 12c shows placement of four sensors 1351, 1352, 1353 and 1354 at the upstream sides of four fin tips. These sensors work in like manner to that explained for the sensors of FIG. 12b.

### Example 5

In this example sensor 1401 is mounted at the leading edge of vertical post 1405 of electric outboard motor 1410 shown in FIG. 13a. During operation the sensor scans the water ahead of the propeller and (via its circuitry) is adjusted to create a propeller immediate stop signal when detecting a new solid object having 2 square inches of cross sectional area perpendicular to the sonic emissions of the sensor within 2 feet of that sensor. The sensor can be adjusted to additionally detect solid object intrusion into the extended danger zone represented as plane 1421 in FIG. 13b. Plane 1421 extends in a vertical axis from the water surface on the right side of 1421 down to the top of the propeller and is as wide as two propeller widths. (Sensors 1402 and 1403, also shown in this figure are optional and are not used in this example.)

### Example 6

In this example sensors 1406, 1407, 1402, and 1403 are attached to vertical post 1405 of electric outboard motor 1410 shown in FIG. 13c. The sensors are mounted on the bow side of post 1405 in front of propeller 1415. Sensors 1402 and 1406 are pointed slightly to the left (preferably 5 to 45 degrees to the left of the boat long axis). Sensors 1403 and 1407 are pointed slightly to the right (preferably 5 to 45 degrees to the right of the boat long axis). During operation the sensors scan the water ahead of the propeller and are adjusted to create a propeller immediate stop signal when detecting a new solid object within 2 feet of a sensor.

### Example 7

In this example 2 rear-ward facing sonic sensors 1556 and 1555 are mounted equally spaced from the center line of a 21 foot long boat hull and half way up the water line, and face propeller 1560 (FIG. 14a). The sensors detect a body that enters the water near the propeller and activate an immediate propeller brake sequence upon detecting a solid object that enters the danger zone 2 feet in front of the propeller. In another example the sensors are further away (4 feet in front of) the propeller.

### Example 8

In this example sensors 1510, 1520 and 1530 are mounted on hull 1500 3.5 feet in front of propeller 1540 as depicted in FIG. 14b. The propeller in this case has a diameter of 14 inches. Each sensor is facing directly to the rear and is perpendicular to the boat long axis. Each sensor is mounted 24 inches away from the axis of the propeller. During use, the sensor signals are corrected for the propeller signal and, after correction is made, a solid object is detected by reflection of sonic vibration as described above.

One embodiment is a correction system for diminishing the propeller signal from the detection signal. This correction system may be implemented in hardware or in software. The system uses at least two and preferably at least 3 separate sensors (as shown in FIG. 14b) that face to the rear and that are equally affected by the propeller. By placing each sensor the same distance away from the propeller and matching each sensor's characteristics, the sensor outputs are compared to detect a new object entering the danger zone. That is, each sensor will output the same propeller signal. That strong background signal is automatically negated by comparing each signal with each other. One way to implement this embodiment is to subtract one signal from the other to obtain a difference signal. If the difference is greater than a threshold value then a propeller stop signal is generated.

In practice, this automatic correction system works best when the propeller rotates rapidly. A time constant for each sensor output should take into account the propeller speed and time between each propeller blade comes in front of each sensor. By comparing each sensor output, with compensation for the delay between presentation of propeller blades in front of each detector this system can sensitively detect intrusion of a solid object. In a most preferred embodiment, a three blade propeller is used with a three sensor system where the sensors are equally spaced around the propeller, providing the most even propeller background signal for correction. This embodiment as well as the others may be implemented with a microprocessor executing a stored program.

Inexpensive and Convenient Electronic Steering Many control systems for watercraft generally are complex, both in construction and in use. For example, while sometimes desired, and contemplated for some embodiments of the present invention, use of geostationary satellite signals with digital signal processing is really not necessary for automated electronic steering, in view of the fact that the earth has a very reliable magnetic field. Thus, complex equipment with maintenance, cost, and reliability concerns can be avoided by using the earth's field. Another problem arises when the user is confronted with a digital display of heading in degrees and has multiple buttons to choose from after considering the heading in degrees. Pleasure boaters often are more concerned with practical matters such as lining up a boat with a buoy and like to focus attention on the water and push a single button or switch, perhaps without having to even look down at the control panel.

In contrast, many watercraft operators desire simple controls that are easy to use without training. The operator may desire the boat to maintain a heading, but does not want to learn hot to operate an autopilot to do this. Accordingly, an embodiment provides a simple push button or toggle switch to set a boat on a heading. In an embodiment, a dash mounted switch is provided with a placard having one or a few words such as “cruise,” “cruise control,” “auto pilot” and the like. In another embodiment the button or switch is provided on a motor throttle handle. The control may be as simple as a rocker switch having the words “on” and “off” printed on the upper and lower respective surfaces. In an embodiment, a circuit is provided that keeps the auto pilot (steering control) on when the motor power (carburator adjustment or electric adjustment, if for an electric motor) is increased, but turns the auto pilot off when power is decreased or turned off. In another embodiment a control circuit turns off the auto pilot when the steering is manually adjusted. In yet another embodiment a control circuit senses when the steering is manually adjusted and resets the direction after a manual correction is made. In yet another embodiment an audible signal is made when the course is reset. In another embodiment the autopilot is turned off when either steering or power is adjusted.

In a particularly desirable embodiment an auto pilot as described herein automatically engages whenever the user touches a steering wheel or other directional control. A touch switch that senses pressure may be mounted on the control and more preferably electrical conductivity from a conducting control surface to a hand is sensed (pick up of stray rf with a high impedance circuit as are known in the art). When the operator operates or contacts the control surface, the autopilot is automatically turned on. Thus, if the user is holding a steering wheel, and not turning it, the boat automatically adjusts its directional control (rudder or the like) to maintain a constant heading. In a related embodiment the auto pilot automatically turns on if the control surface is touched or moved and held for more than a set time, such as a second, two seconds, three seconds or the like, without moving it. The automated pilot would turn off or reset if the control surface is touched again or moved.

This embodiment can be built into the watercraft control circuitry and automatically activated without any further switching or decision making required by the user, and thus be a transparent part of the boat control systems. This embodiment provides true corrected steering that can compensate for temporary or permanent imbalances in directional control such as when two stern drives change thrust with respect to each other, which tends to change the directional bearing of the boat. That is, this embodiment allows a boat to stay on a straight heading despite flaws in the steering systems and despite encountering water current, waves and the like that may tend to shift heading. In a particularly desirable embodiment the control only operates above a set boat speed, such as above 5, 7, 10, 15, or 25 miles per hour, or above a set propeller speed associated with higher boat speeds. In a most preferable embodiment the control automatically activates above a set speed such as five miles per hour and turns on without the operator necessarily knowing, although a panel light may be used to signal the fact that the “corrected course” circuitry is activated. In another embodiment, a compass heading, such as an analog dial, digital display or the like may read out the instantaneous set heading utilized by the auto pilot, for the convenience of the operator.

A variety of circuits may be used to implement embodiments to allow use of the earth's magnetic field for a convenient user operated heading device. For example, a compass may be made from multiple geomagnetic field detectors that are arranged to sense when the watercraft's heading is (a) dead on, (b) slightly off center in either direction, and optionally (c) progressively more off center from a desired set heading. During use, the operator sets a heading, then the device senses whether the watercraft heading is in the selected direction, (requiring no steering control), is heading too much to the left, or is heading too much to the right, requiring course correction by momentarily or permanently altering the steering right or left respectively. The device outputs an electrical signal denoting correct heading, (or no signal meaning no correction needed), or other off center condition. In another embodiment the device senses at least two levels of off course direction for either side of the desired direction. The two or more levels indicate relative error such that a first lower level of error signal is used to make a low level (weaker) steering adjustment. A second higher level of error signal triggers a high level of steering shift and so on for successively higher error signal(s) if desired.

A very desirable way to implement a simple switch operated autopilot or autocorrection of steering that automatically engages above a set speed, is to use two or more ratiometric hall effect devices oriented at different positions so that each outputs a different signal depending on geomagnetic heading. A circuit receives the signal (or creates the signal by correct biasing) and responds to changes by outputting at least one left or right correction signal. The correction signal(s) are used to drive an actuator for changing or adjusting course. Discrete ratiometric devices type A3515 may be mounted with their sensing axes on a horizontal, or more complex sensor packages may be used. For example, Dinsmore sensor model 1525 or, more preferably model 1625 analog compasses may be obtained from The Robson Company, Inc. Erie, Pa. at low cost and provide two outputs that may be interfaced with other circuitry that detects changes in heading.

The two analog outputs from the 1625 sensor may be interfaced directly with, for example an 8-bit, 12-bit or other A/D converter, using the highly curved portions as a sector designator only, as described in the engineering diagram for this sensor (see http://www.imagesco.com/articles/1525/03.html). More preferably, the analog outputs of this sensor are used directly, and monitored for changes to determine course shifts. For example, the cosine output, which presents a fairly linear decreasing voltage from 10 to 120 degrees (region A) and a fairly linear increasing voltage from 225 to 350 degrees (region B) may be used within those regions to drive a comparator or sample and hold circuitry that responds to increased or decreased voltages by outputting a correction signal. A positive sine signal above a threshold voltage, on the other hand can be used to determine when region A is active. A negative sine signal beyond a threshold negative voltage is used to determine when region B is active. Between 350 to 10 degrees and between 120 to 225 degrees, the sine signal is used, as it is a fairly linearly decreasing voltage and increasing voltage in these two regions respectively. A skilled electronics technician can use a microprocessor, and/or simple analog devices such as comparators to switch between the four regions and sample-detect changes in course heading as changes in voltage within each region.

An explanation on how to use the 1625 analog device above is representative and other devices, including discrete hall effect devices may be used. Also, for higher cost embodiments that utilize other computer equipment, a complete high performance electronic compass sensor module such as the TCM1 or TCM2 may be purchased (see http://www.pcweb.com/pni/TCM2.HTM) having built in sending circuitry. The output correction signal generally has to be buffered and is used to control an actuator. A variety of actuators will be appreciated, depending on the particular watercraft used. In a preferred embodiment the watercraft employs an electric motor or electric powered control surface such as a rudder. Hydraulic steering may be conveniently used for fossil internal combustion powered watercraft. For example, see the HyDrive (TM) Admiral Series of hydraulic steering units from HyDrive Engineering (http://www.coursemaster.com/Catalogue3_page.html). Also see the inboard and outboard kits from this company, which can be mated with autopilots.

A fun to use analog auto pilot Embodiments provide auto-pilots that allow the user to control the boat without training, without even having to look at a panel display, or in some cases, without even knowing that the autopilot exists. Inexperienced boat operators generally are familiar with compasses and how to rotate them without receiving detailed instructions. Accordingly, in a desirable embodiment that utilizes some operator movement of an analog device, the auto pilot consists of a hand manipulated knob or other dash mounted device with compass headings on the knob or on the dash. For example a dash may have a flat horizontal planar surface from which protrudes a knob 4 inches diameter with a raised center portion of 1.5 inch diameter. The knob outer and lower flat region has heading markings on it that correspond to compass headings such as north, south, east, west and so on. The dash area outside the knob has a “heading” mark at the top adjacent to the knob edge. During use the operator merely rotates the knob to the desired heading. Preferably a switch is provided which engages the autopilot as needed by push button, toggle or other action. Variations of this device, such as a touch screen that shows a compass and which allows selection by touching a desired heading may be used. A rotating knob is preferred, although touch panel, slide switch and other devices may be used. Most preferably the operator selection of heading is carried out in an analog manner (no numbers to decide on) by a hand movement such as that exemplified here. In this example the compass headings are on a rotating knob but could be on a fixed surface under the knob.

In another embodiment a simple switch, preferably push button variety is provided that allows a user to maintain the watercraft on its present heading. In this case, by pushing the switch, the user alerts the auto control circuit to lock in the present heading. The user may turn off the control by activating (ex. by pushing) the switch again.

Although an electronic steering device according to this embodiment may employ the output of multiple discrete sensors, equivalents of this embodiment may utilize other relative magnetic sensing device(s) that may be analog or digital and may comprise multiple sensing within the same device. The signals indicating error are connected electrically to an electromechanical actuator that controls a rudder or other steering device. For boats that rely on differential thrust for steering, the error signal is fed directly into the controller of the motors as suited to correct the course. This embodiment is suitable for fossil fuel powered boats and trolling motor powered boats as well as regular electric boats.

A preferred embodiment of an electronic steering device is shown in FIG. 3. Platen 1410 rotates about center 1420 by hand adjustment. The center of the platen may contain a knurled knob or protrusion for easy turning to set the desired direction, which is noted by proximity of dial 1410 markings to fixed “course heading” indicator 1415 which is a fixed mark outside the platen. This figure shows an inexpensive embodiment that uses five discrete hall effect sensors, which are shown as 1450, 1440 and 1460 in the figure but which are affixed to the underside of the plate. Signal amplifying circuitry may exist in the rotatable platen, wires from the platen exit out the rear and are connected to further circuitry to effect steering changes. In this simple “hard wire” method it is preferred that the platen rotate only plus and minus 180 degrees from a set point in order to prevent over twisting of the wires.

FIG. 3 also shows center origin detector 1440 that is used to define a reference magnetic north. The platen contains two more magnetic north sensors 1450 that are oriented (pointed) progressively more to the left of the center origin detector 1440, and two more sensors 1460 that are oriented progressively more to the right. For the sake of explanation, FIG. 3 shows sensors 1450 and 1460 positioned to the left and right of origin detector 1440 respectively, but in practice, the sensors can be placed anywhere on the platen as long as they are facing slightly left and right of the center origin detector, respectively and are fixed in position with respect to detector 1440. By way of example, the first sensor on the left may be positioned so it faces (points) 15 degrees to the left of center, the second sensor from the left is then positioned to face 7.5 degrees to the left of center and the third sensor is positioned to face center (straight up as shown). The fourth sensor then is positioned to face 7.5 degrees to the right of center and the fifth is positioned to face 15 degrees to the right of center. By “positioned” is meant that the sensor is positioned so that its input is oriented in the desired position, which for a typical hall sensor is perpendicular to the center of the marked flat side. Although not shown here, a circuit for implementing a “simple switch” to lock in a present heading may be implemented by using multiple hall effect sensors (preferably at least 2) arranged in a pattern. By providing signal outputs at all directions the circuit can monitor deviation from a present course setting at all positions of the platen. In fact, this embodiment may be implemented without a rotating device.

An optional sensitivity enhancer 1470 may be positioned in front of each magnetic field detector. The enhancer is a paramagnetic elongated device that may take shape of a nail and which focuses magnetic field lines to an axis in front of the magnetic field detector to improve sensitivity. The end of the enhancer away from the hall effect device preferably is larger and the end towards the enhancer is pointed, with the diameter of the constricted end approximating the diameter of the sensor chip to facilitate focusing of magnetic field lines into the sensor. In equivalent embodiments where multiple hall sensors are positioned within the same chip but facing at slightly different angles from a center reference, such sensitivity enhancers may be added to the chip as elongated paramagnetic depositions of iron, nickel chromium and the like extending out from the sensitivity spot for paramagnetic device(s) within the chip.

The inventor prefers large discrete hall effect devices and particularly, discrete ratiometric hall effect sensors, however, because they are more easily used with large enhancers such as inexpensive low carbon steel nails with sharp points for greater sensitivity. This figure also shows N, S, E, W (etc.) markings. Those markings indicate the desired heading, but become the true heading when the boat is on proper course, as detected by a signal produced from center detector 1440 and decreased or absent left and right error signals, respectively from sensor groups 1450 and 1460. In one embodiment of operation, a user rotates the platen until the device indicates that true north has been detected, and at this point the compass heading adjacent to mark 1415 is the true course heading.

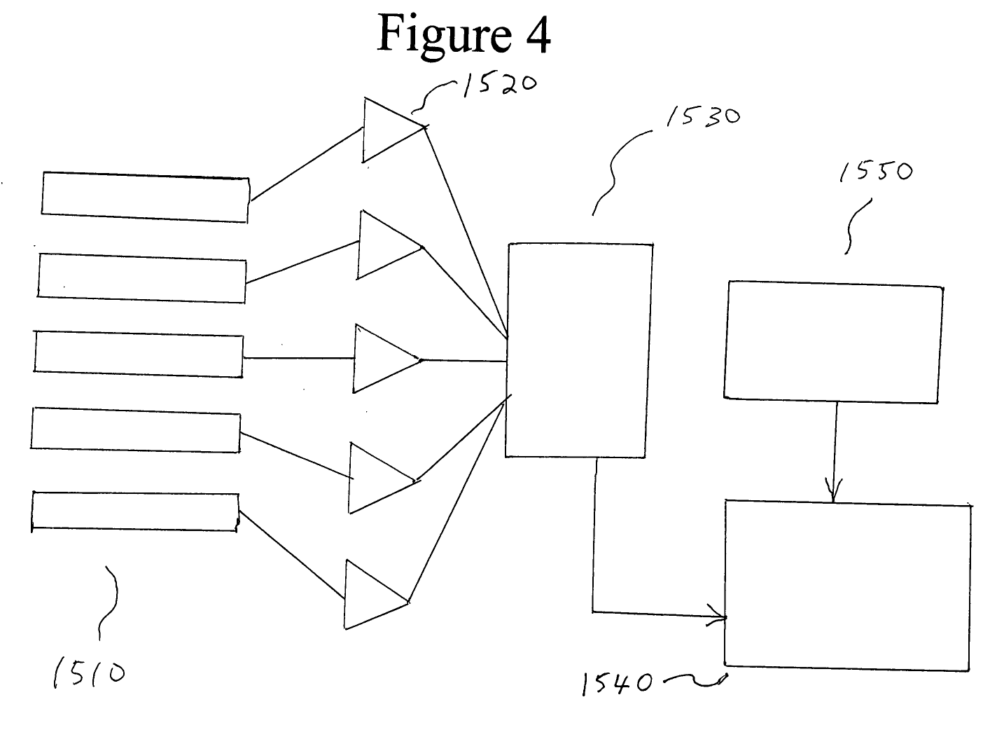

FIG. 4 shows a representative block diagram outline for implementation of a particularly robust automated electronic steering device that may be built from easily obtained discrete hall effect sensors from an electronics parts vendor. The five hall effect sensors 1510 on the left side of this figure are discrete ratiometric hall effect sensors such as type A3515. These are biased to produce signals in response to magnetic fields. Each signal from a hall effect sensor is separately amplified by buffer amplifiers such as MOSFET operational amplifiers 1520 which feed logic chips in control circuit 1530 that produce digital signal output(s) in response to the detection of magnetic north by each hall effect sensor and control motor 1550. In an embodiment not shown here, the amplifier/buffer circuitry, which may be as simple as a transistor amplifier, is built into the hall sensor chip. In another embodiment, two or more sensors are present within the same chip.

A signal may arise to denote any of several conditions. A “course OK” logic signal may come from detection of a sensed magnetic north signal from the center origin detector hall effect sensor. A “slight correction to the right needed” signal may arise from a sensed magnetic north signal detected from the “small left sensor” device that is positioned to face slightly (typically between 2 to 15 degrees, preferably 3 to 8 degrees) to the left of the center origin detector. A “stronger correction to the right needed” signal may arise from a sensed magnetic north signal detected from the “large left sensor” device positioned to face more (typically between 3 to 30 degrees, preferably 5 to 20 degrees) to the left of the center origin detector. Analogous correction signals are determined from the small and large right sensors, and/or other sensors that may be positioned in other orientations. In some embodiments the control signals may not be discrete digital signals but rather analog signals, and are treated in like manner by control circuitry.

In a simplified version of this embodiment, only three hall effect sensors are used, in which case only one kind of correction signal is produced from the control circuit for each side. In another embodiment a large number of sensors are used and their outputs compared either in hardware or by operation of a computer program to decide on how to correct the heading of the watercraft. In yet another embodiment, analog outputs from multiple sensors, either within the same chip, or in different chips, are blended, by summing, comparing, or otherwise as a skilled artisan may readily achieve, before obtaining a control signal to the motor(s).

In one embodiment an additional sensor is used facing substantially away (preferably 180 degrees away) from the center origin detector sensor. A signal produced from the additional sensor indicates that the watercraft has turned around, and needs to be re-oriented. In that case, the control circuit may determine which direction the watercraft has rotated from stored information regarding which error sensor(s) (left or right from center) were activated last. A suitable correction, and or audible alarm to notify the watercraft occupants can be automatically outputted by the control circuit.

The control circuit produces a large electrical pulse or continuous signal to control or directly power at least one motor to effectuate a course change. The motor may be a servo mechanism, solenoid, or other device for adjusting a rudder or steering wheel. The “motor” may consist of two motors that are separated such as floating skis motors and which steer the craft by virtue of their relative power outputs. At least some of the control circuit may be a computer and carried out by software. While implemented easily in many electric propulsion systems such as electric boats powered by batteries or fuel cells, these embodiments also may be used and are intended for internal combustion powered boats. For example, where two stern motors are used (one to the port side, on to the starboard side), the fuel rate of supply to both can be modulated to achieve turning. A rudder can be manipulated, a steering wheel can be servo controlled, and the like.

In operation, a user turns the platen until a desired heading (0 to 360 degrees of the compass, preferably displayed at the edges of the round platen that contains the sensors) is selected. Preferably the platen compass markings indicate “N” at the center origin sensor detection line, and an adjustment for true magnetic north deviation is built into the platen. Also, course indicator line or other marking 1415 in FIG. 3 should be placed on a surface about which the platen rotates and is used as a set point that lines up with the desired compass markings on the rotating platen.

After setting the platen to a desired heading the device is actuated and steers the watercraft until automatically or manually turned off. For the example shown in FIGS. 3 and 4, there are two modes of operation. In a first mode called “new course setting” the user turns the platen to a desired heading. The control circuit then starts to determine whether any of the hall effect sensors are activated. If a sensor is activated, the control circuit responds by a programmed or set response as exemplified above. For example, if the large right sensor alone is activated, then the control circuit adjusts the watercraft to turn more to the left. More likely, when only 5 or 6 sensors are used, no sensor will be activated upon turning the “new course setting” mode on, in which case the control circuit turns the watercraft in a sharp circle to one side or the other until one of the sensors is activated and a regular response such as described above can be activated. In a second mode setting called “maintain present course” the user turns the platen until the center origin detector is activated, by, for example a light readout and/or audible beep indicator, and the device maintains the course as described. That is, once the watercraft departs from the desired heading one or more hall effect sensors activate and turn on one or more effectors 1540 shown in FIG. 4, which may for example be a rudder, propulsion motor control or alarm.

A concern when designing an using geomagnetic auto pilots such as those described herein, is that the hall effect device works best when positioned within a certain attitude range with respect to the horizon. Unfortunately, a watercraft tips forward and back and left to right in the waves. If a geomagnetic sensor such as a hall effect sensor is tilted off vertical, it begins to sense some of the vertical component of the earth's field, which may introduce some error. For practical purposes, up to approximately 12 degrees of tilt, as with any compass, is acceptable for many of these devices. However, the boat may suddenly lurch, which may confuse a sensor. Partly for this reason, the sensors, their circuitry or even software (when used) can accommodate temporary deviations by a variety of mechanisms as are known to skilled artisans. For example, sensor packages such as 1525 and 1625 have built in damping so that the indications are similar to those of a standard liquid-filled compass. That is, if a signal reading is suddenly altered corresponding to a 90 degree change in heading, it will return to proper indication in 2.5 to 3.5 seconds, with no overswing. In desirable embodiments the responsive control and/or output circuitry and or software (if used) utilizes a response time constant long enough to accommodate these changes. In another embodiment, any sudden change above a set threshold value (e.g. change in voltage per unit time) will be ignored and the sensor output is re-read a short period later. This accommodates (is resistant to) such short term perturbations.

In another desirable embodiment the regular acceptable tilt range of about 12 degrees is increased to 15, 18, 20 or more degrees by electrically coupling sensors in parallel that are held in alternative positions with respect to the horizon. This can be achieved for example by summing analog outputs into a discrete summing buffer or amplifier subcomponent of a circuit. In yet another desirable embodiment a paramagnetic material such as iron with an expanding vertical aspect is positioned in front of a hall effect sensor to help gather magnetic lines of force more in a vertical dimension. Sensitivity enhancers 1470 shown in FIG. 3 desirably have a broader acceptance angle for magnetic fields and can be more immune to the effects of tilt. More preferably the sensitivity enhancers are solid cone shaped rather than having flat heads.

It was discovered that in many types of uses, tilting of a watercraft left and right, in response to waves is a particularly, and more common source of possible error. Accordingly, in a particularly desirable embodiment a tilt detector is fixed to the watercraft body to sense when the watercraft tilts left or right. The tilt sensor output can be used to detect when the boat has exceeded a tilt angle and can block the auto pilot from taking action from an erroneous deviation in heading caused by the tilt. In sophisticated embodiments, the tilt detector output may activate a software subroutine for correcting the effect of tile, or even activate detection from alternative geomagnetic sensors that are fixed at the alternate tilts and which are (at least momentarily) more correctly positioned at the horizon, as determined by the tilt detector. In another embodiment, the tilt detector detects tilt fore and aft. In yet another embodiment the problem of tilt is alleviated by isolating the geomagnetic sensor from extreme tilt by floating the sensor in a fluid. In the latter case thin flexible wires may attach to the sensor to allow movement. Alternatively, for an embodiment that addresses sideways tilt, the sensor is pinned on an axis that is parallel to the keel (or longest dimension of the boat), allowing the sensor to at least partially float along that axis, preferably on a spring mechanism that may be adjusted to set a normal position.

Motor and Battery Cooling Systems The electric boat industry that uses motors in contact with water has not faced squarely the dilemma of requiring water contact with the motor to remove waste heat, while at the same time, minimizing that water contact to decrease friction that interferes with boat movement. Ideally, an electric boat should interact minimally with the water and should (particularly at higher speeds above the hull displacement speed limit) not excessively perturb the water with a protruding motor. At low trolling motor speed conditions, the extra drag caused by a trolling motor is often not a concern, but as the electric boat industry develops this phenomenon is becoming a more important limitation.

One way to decrease drag using a trolling motor is to incorporate the motor in a Maruta (TM) design for higher speed electric watercraft. While adapting trolling motors for use in prototype Maruta hulls the inventor discovered that the axle of such motor generally is the first part to receive waste heat, despite the fact that the motor is design to transfer heat through the metallic casing to the surrounding water. That is, heat more readily transfers to the axle, not the casing in many situations, yet the casing is used to transfer the waste heat. In studying this problem, several new conformations of motor design and axle design were discovered that utilize the axle more fully to dissipate heat, allowing greater design flexibility for the motor case and in some cases allowing design of the motor casing into the boat surface. In an embodiment the motor case is modified to allow greater hydrodynamic matching with hull design while allowing good water contact to dissipate the heat. In a related embodiment, batteries that can be charged rapidly but which generate much waste heat are mounted in the hull to allow good thermal contact with the water.

In an embodiment, an electric motor axle is made long enough to provide a large contact surface with a conductive propeller. In common designs used most often for small electric motors such as those sold by Minn Kota and Motorguide (2 hp, 1 hp, 0.5 hp or less) the motor axle extends out of the case through a seal and a simple connection with a threaded portion of the axle is made to a non-thermal conductive propeller. In a particularly advantageous embodiment, in contrast, the motor axle extends further along the length (fore/aft) of the propeller and contacts the propeller through a larger distance. The axle extends and (more importantly contacts) at least 1/4 inch, preferably at least 0.4 inch, 0.5 inch, 0.75 inch, more preferably at least 1.0 inch, 1.25 inch, 1.50 inch or even greater than 2.0 inches of a propeller hub wherein the propeller is made from a thermoconductive material. The propeller thermoconductive material may for example, be metal such as aluminum or brass, plastic or other thermally conductive polymer, or a ceramic material and has an opening in the center that thermally contacts the motor axle. Preferably the thermal contact occurs through a bore in the propeller that preferably is at least 0.5 inch, 0.75 inch, more preferably at least 1.0 inch, 1.25 inch, 1.50 inch or even greater than 2.0 inches of the propeller central region “hub.”

In another embodiment, heat transfer is facilitated by an increased diameter of the axle outside of the motor on the propeller side to allow greater heat transfer to the propeller. In yet another embodiment the axle increases in diameter from a narrow diameter at the end away from the propeller to the propeller end. In yet another embodiment the motor case contacts water and the axle transfers heat through a large contact with a conductive propeller as described here. Although most previous sealed electric motors are trolling motors of less than 2 horsepower, embodiments that utilize the motor axis for at least some cooling are used for electric motors of at least 2 hp, 3 hp, 5 hp 10 hp, 25 hp and even above 50 hp. Without wishing to be bound by any one theory of this embodiment, it is thought that much heat is generated on the axle (via the armature windings, when used) and, in some cases is transferred to the axle from a surrounding electromagnet. The axle, which may include a permanent magnet or an electromagnet, generates much heat directly in some motors and certainly can absorb heat from other parts of the motor.

In another embodiment the motor axle is hollow and water flows through the axle, cooling it. In these embodiments, a particularly useful motor is one wherein the axle has a large diameter of at least 1 inch, 2 inches, 3 inches 4 inches, 5 inches, 8 inches or even greater than 12 inches. The axle may be a wound armature that receives power with brushes and surrounded by magnets or the axle may comprise permanent magnets and be surrounded by electromagnets.

In yet another embodiment the motor is sealed within a case that is shaped to match the surface of a watercraft. The outer surface of the motor casing directly contacts the water and transfers heat to the water via this contact. The motor casing preferably is made from a metal. Parts of the casing in contact with the water may be at some distance from the heat producing components of the motor and the heat may be transferred to the outer surface by the casing itself, and/or through a filler material that may be present in the casing. In a preferred use, a boat hull is designed with a depression and/or opening in its hull to accept the motor with casing. The motor is mounted on the boat such that the casing forms a continuous surface with the hull except for the spot where a propeller shaft protrudes. That is, a boat hull has a depression in it that matches the size of a motor, wherein the motor has a conductive flange extension of its casing that forms a hydrodynamic surface with the hull upon mounting in the hull.

In a related embodiment a heat generating electrical device such as a MOSFET or other power controlling device is thermally connected to a surface and the assembly is mounted on or in the hull surface, allowing transfer of heat from the electrical device to the water. In a particularly advantageous embodiment the heat generating electrical device is a battery such as a metal hydride battery or other battery that generates heat upon charging and/or discharging. This embodiment is particularly useful for allowing rapid charging of electric boat batteries.

An important commercial limitation of electric boating is the time required to charge batteries. Some advanced glass mat batteries, for example, can be charged from 50% depletion in as little as 15 minutes if the heating problem were addressed sufficiently. Metal hydride batteries can charge up in very short times if cooled properly. This embodiment provides cooling for rapid charging. In one embodiment the boat hull is built with depressions below the waterline that accept the batteries. The batteries preferably are built with large conductive surfaces that contact the batteries on one side and the water on the other. Each battery/conductive surface assembly is mounted in the mull with bolts or other fasteners. A further advantage of this embodiment is that the battery weight can be placed low in the boat. Preferably the battery heat removal surface is at the side on the boat and not in a flat bottom to allow water circulation by convection as the boat will be at rest during charging from shore power.

A preferred embodiment provides a passive (thermal conduction only) or peltier (active heat pumping) based mechanism and procedure for its use that controls/adjusts the temperature of a storage battery. A battery temperature is adjusted by a peltier heat pump that is thermally attached to the battery, preferably to a metal terminal of the battery that absorbs heat from within the battery. This embodiment allows faster charging, and in some cases, better discharging through control of battery temperature. During charging the battery temperature is monitored and if the temperature is too high, at least part of the charger current is directed to one or more peltier devices to pump heat out of the battery. The peltier device preferably is connected to a heat sink and most preferably for charging watercraft batteries, is connected to a material that transfers the heat to a body of water that the watercraft is sitting in. The peltier (or a heat conducting plate, coil, matt or the like) may also be connected (i.e. physically contact, optionally through use of heat sink compound or other conductive layer) to the outside of the battery or other part of the battery. This aspect of the embodiment particularly suits lowering temperature of watercraft batteries because a great deal of heat can be easily moved from the battery to a large volume of water. In another embodiment the device is switched as needed to pump in the opposite direction and increase the battery temperature when the battery is too cold. The peltier device(s) preferably are mounted with one surface on a large hull shape conforming surface such as aluminum. A skilled artisan will readily will appreciate modification to embodiments suitable for specific boat hulls, motors and so on.

In a preferred embodiment the charger output is maintained at a high or maximum level during charging, even when the battery temperature is too high to absorb a maximum charge rate. A control circuit senses when battery temperature is too high, and automatically shifts part of the charger output to the peltier device(s) to pump heat out of the battery and into a large heat sink, such as a metal hall or a metal tube with water running through it wherein the water comes from a body of water that the watercraft is sitting in. After the battery temperature moves lower, the control circuit increases charging power to the battery. In a preferred embodiment the control is continuous and the power delivered to the battery is gradually decreased with increasing battery temperature while the power delivered to the peltier device(s) gradually increases with increasing battery temperature. This system maximizes use of the charger over prior art wherein the charger output simply is decreased to prevent overheating the battery. This embodiment takes advantage of a simple and massive heat sink (water) to allow inefficient peltier heat pumping from a battery to the heat sink, while allowing the battery charger to operate at maximum output to both cool the battery and charge at the highest rate possible.

Monitoring and Control of Batteries, Hydrogen Supplies and Fuel Cells Energy costs for transportation using internal combustion engines usually are determined by measuring the rate or total amount of fuel used for a given time or distance traveled. Accordingly, a user of fossil fuel for transportation can conveniently determine operating efficiency by resort to fairly straightforward measurements of the amount of fossil fuel. However, electrochemistry powered electric motors, such as battery powered or fuel cell powered devices operate under different rules and are not as easily monitored for energy efficiency. The inventor reasoned that the performance of electrochemistry powered energy supplies such as electrochemistry cells of batteries, membranes of fuel cells and catalysts of fuel cells gradually deteriorate during use. In extreme cases these parts and devices need to be replaced during the life of the powered device such as a car or boat. Thus, in order to properly appraise the true cost of a power source for these devices, the deterioration and, (in many cases) expected life span of the power source need to be accounted for.

Devices and methods for more accurately determining true energy costs for chemistry powered devices were discovered, such as those that employ batteries and fuel cells. In addition, monitors of energy efficiency and cost efficiency were discovered that provide real time feedback to operators of devices such as land vehicles and watercraft so that costs of use and replacement of electrochemical devices may be minimized. Without wishing to be bound by any one theory of this embodiment it is believed that a natural consequence of many chemistry driven systems that utilize chemically reactive surfaces such as electrochemical cell plates and membranes, is that the impedance (resistance to current flow as electrons and/or protons) gradually increase with deterioration. The inventor discovered useful ways to combine measurements of the deterioration with readout and signaling devices that provide value to the user, who can utilize this information to make economic decisions for more optimum control of the electrochemistry powered device. In this context the term “electrochemistry powered” refers both to regular electrochemical cells such as those found in batteries as well as chemical conversion systems such as membranes and catalysts used in fuel cells to convert chemical energy into electrical energy.

From these basic insights, particular devices and methods were discovered. In most cases exemplified the devices are described in terms of use in watercraft. However a skilled artisan readily will appreciate applicability to a wide range of uses including other transportation such as air and train travel and other energy uses such as refrigeration and energy generation for homes, factories and other uses.

Monitoring the Cost/Efficiency of Electric Power Supply Use In an embodiment accounts for the cost of the power supply as well as the cost of the energy itself. In many cases the power supply is a recurring cost that can exceed the cost of the energy used. By way of example, a 500 pound 48 volt lead acid battery pack having a capacity of 208 amp hours (10 kilowatt hours) may cost $1500 yet may last for only 300 charge cycles if fully discharged between cycles, for a per cycle cost of $5. The electricity for charging the battery pack, at $0.15 per kilowatt hour would cost about $1.50. In this case, the raw energy cost for electricity accounts for 23 percent of the true energy cost and the recurring cost of the perishable storage of the electricity accounts for 77 percent of the true energy cost. In the case of a boat that travels 5 miles per hour using 3 kilowatts (about 4 horsepower for an hour), the per mile cost is $0.45, but electricity used is only $0.10. Analogous determinations may be made for fuel cells and particularly fuel cell power reservoirs that utilize reversible binding at moderate (less than 25 atmospheres, particularly less than 10 atmospheres, 5 atmospheres or even less than 2 atmospheres) pressures as such materials and devices, which will become more useful as they become further refined.

The energy use rate varies according to motor speed and other conditions. The vehicle operator often needs to monitor the battery usage for feedback in order to operate the vehicle at an efficient condition and to predict how long an energy supply can last. Although not generally appreciated, the same is true of the large power supply cost as well. In the example given above where a $1500 power supply is consumed at a rate of $0.45 per mile when completely discharged between uses, the same power supply that is only discharged 50 percent between uses may last 1000 cycles for a per mile cost of only $0.27. FIG. 16 shows the relationship between depth of discharge (x axis) and battery life (life cycles on y axis) for a particularly stable battery made by Lifeline (TM). This figure shows that 100% discharge uses up approximately 1/350 of the battery life whereas a 50% discharge uses up approximately 1/1000 of the battery life. Other large lead acid battery types generally are more prone to greater wear rates upon greater discharge depth. Clearly, while the user may economize by adjusting electric motor power for most efficient use of electricity that costs about 10 cents a mile, the user sometimes desires to monitor battery cost usage, which costs about 30 or 40 cents a mile under even moderate use conditions. This embodiment allows a user to monitor and control for the high battery costs by providing a combined cost figure (both electricity and battery) in real time during vehicle operation.

An efficiency meter according to an embodiment monitors the cost of both power usage and battery (or fuel cell supply unit such as a hydride reservoir) depletion. The meter displays a signal that corresponds to the rate of energy use as compensated for battery or hydride reservoir wear. During energy removal from a fully charged battery, the battery wear is minimum and the cost (displayed value) will be less than the situation where the same amount of energy is removed from the same battery that has become more depleted. This allows the user to immediately understand the true cost of battery plus electricity use over a range of conditions.

The display shows a composite signal corresponding to a) energy cost plus b) battery cost. The energy cost portion of the total or relative cost displayed by the meter generally is determined from an electrical parameter of electric energy consumption such as voltage, current or power. The electric parameter may be factored using a variable from a look up table or user input or may be calibrated by a circuit. The battery cost generally is determined by factoring the present state of battery depletion and/or battery life state by a value obtained from a lookup table, user input or electrical parameter. The parameter may be set using push buttons or a rotary potentiometer. In a preferred embodiment the parameter is set by the manufacturer and is transparent to the user. The cost parameter preferably is factored by the instantaneous discharge state (and optionally wear state) of the battery to derive a battery cost factor. For example, the discharge state determined by measuring voltage may be factored by a circuit that is adjustable for the battery type, or may be analyzed by a microprocessor that contains a replacement cost variable.

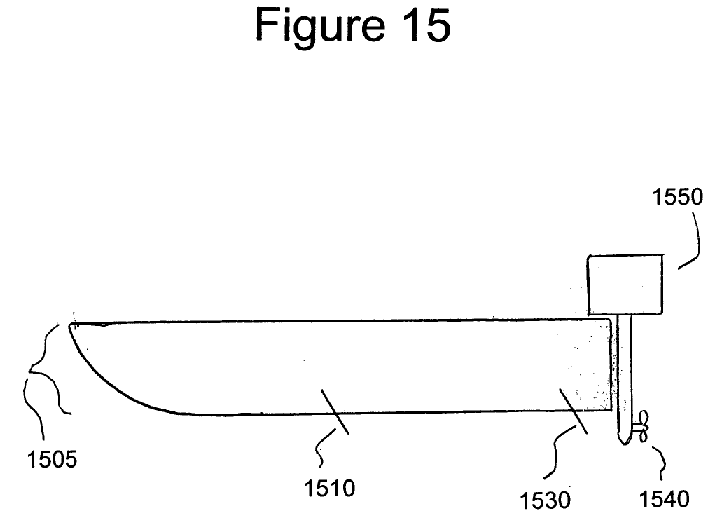

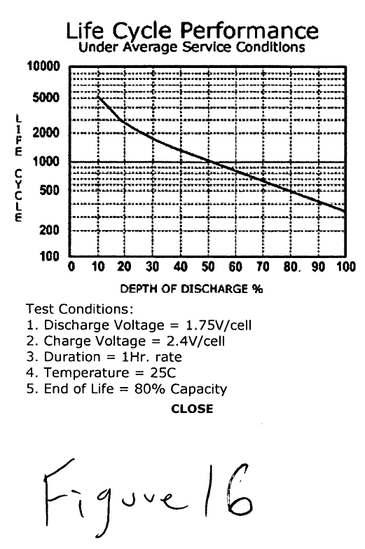

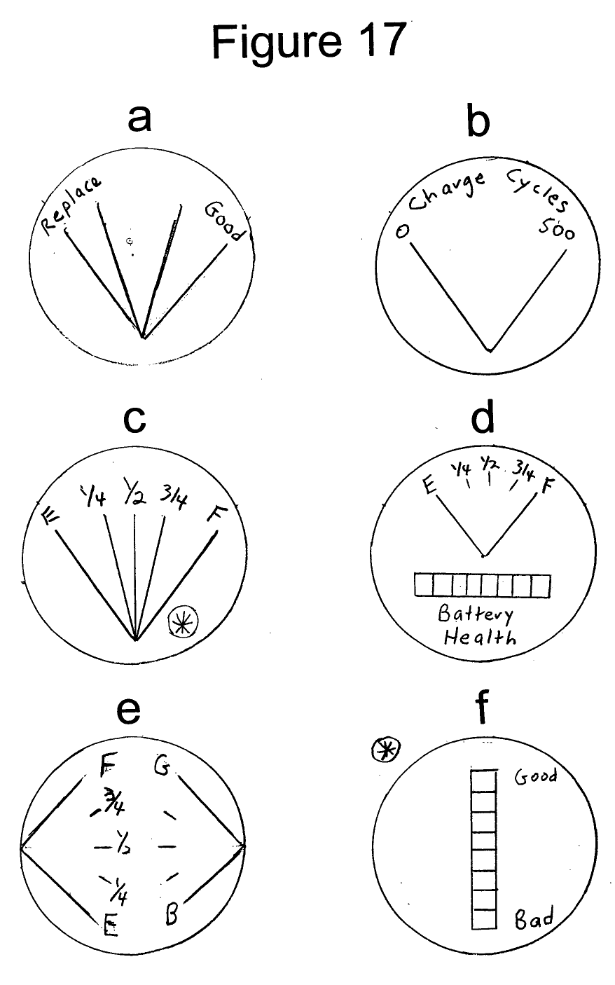

The display may show relative or absolute cost per unit distance or, more preferably, per unit time. In many embodiments shown in FIGS. 17a to 17f, the display is an analog gauge. The display also may be digital, and/or include one or more lights such as light emitting diodes, that may be arranged in a pattern. The display may be or may include an audible device to alert the operator of a non-efficient condition. In a preferred embodiment the display is a single needle gauge that shows lower efficiency to the left side and higher efficiency to the right side. In another embodiment the composite signal is used to drive a motor control circuit to automatically adjust the motor drive to a more efficient setting.

Monitoring Electrochemical Battery and Fuel Cell Degradation A desirable embodiment allows the monitoring of battery, fuel cell and hydrogen reservoir health. This is particularly useful for providing advance warning that a battery needs to be replaced. Batteries, fuel cells and hydrogen (such as metal hydride or carbon-hydrogen binding material based) reservoirs contemplated for this embodiment may be used for primary sources of power as well as accessory power in conjunction with other energy sources such as internal combustion engines. In representative cases, multiple electrochemical cells are connected in series. Each cell has a characteristic impedance (resistance to electric current) that, individually or as a group within a battery can be directly measured or inferred. Generally speaking, the lower the resistance the greater the performance of a battery. This embodiment monitors battery resistance changes and couples a sensed change to a particularly useful warning device, that is particularly well suited for batteries used in transportation and most particularly for watercraft.

As a battery, fuel cell or hydrogen binding reservoir becomes old and used its performance degrades. For example, in the case of a lead acid battery, the lead plate may become sulphated and exchanges ions with the surrounding solution less effectively, thus increasing impedance. Other degradation also tends to decrease conductivity and increase impedance. In embodiments impaired performance is measured by measuring internal impedance. Contaminants such as water, oxygen, sulfur and the like often contaminate and degrade both fuel cell membranes or solid catalysts, or the materials used for reversibly binding hydrogen in hydrogen absorbing reservoirs. In such other embodiments, performance may be measured by comparing an index of catalyst or binder performance with a reference, which preferably is stored information from a standard measurement. In many cases, the measurement is made when the catalyst (as part of the fuel cell) or hydrogen binder (as part of the reservoir is new, or otherwise judged in good working order. For example, a membrane based catalyst in a fuel cell may provide a given voltage and current for a given pressure or amount of hydrogen supplied at a given temperature, when new. As the material ages or becomes contaminated the voltage and/or current available for the same condition decreases. Alternatively waste heat might be measured and used as an index of performance quality (a higher measured waste heat means a lower performance in this embodiment).

The increase in impedance with degradation of a battery may be measured by detecting battery voltage at a specific current and dividing voltage by current to obtain effective resistance. Preferably such detection is carried out at a high enough current value that sufficiently probes the battery condition. For example, a cell having a large surface area may be degraded over most of its area but still display have good conductivity (low resistance) over a small section. If the cell were tested by measuring a low current the small section that works well likely would dominate and the measurement would detect primarily the low resistance of that section. By testing a cell at a high current rate, a greater portion of the cell generally effectively will be tested and a more accurate result obtained. Preferably, the test current should be between 10% and at least 100% of the maximum current flow during normal battery usage. More preferably, the test current should be between 1% and 200% of the one hour capacity of the battery. By way of example, a battery that can discharge 5 amps for twenty hours (100 amp hours total for a normal discharge) preferably is tested by drawing typically somewhere between 1 amp and 200 amps to determine impedance. More preferably the test current should be between 5% and 100% and more preferably between 10% and 50%. A skilled artisan can determine a desired current flow based on the battery type to be tested. Most conveniently the impedance test is carried out by shunting a known resistance across the battery and monitoring voltage across the resistor to determine current.

In an advantageous embodiment the internal impedance of a new battery is measured and the value stored. As the battery deteriorates, the impedance increases. Comparison of a later measured impedance with impedance of a new battery (either directly measured or inferred from other batteries of the same type) provides a measure of the deterioration. In a preferred embodiment an end point impedance for a very deteriorated battery may be used as a comparison. The difference between a measured impedance and an initial new battery impedance and/or a reference end of use battery impedance most advantageously is output to a meter for alerting the user. A “bad” battery having reached an unacceptably deteriorated condition according to an embodiment has reached a point where the battery can only accept 80% of its normal discharge ability (determined as watt hours). According to another embodiment a bad battery is defined as one that cannot be charged up to more than 99%, 97%, 95%, or 90% of the normal fully charged voltage, as determined by testing the voltage under a small load such as 10% or 50% of an normally used discharge rate.

According to a low cost embodiment a battery impedance measurement is carried out and compared to a stored value provided by a manufacturer of the battery, battery health gauge or other equipment. For example, the impedance of a given battery such as a life line group 27 12 volt advanced glass mat battery is determined for a given temperature and/or state of charge. Information relating to the “good” impedance value is input into a battery health monitoring device according to the invention and used as a reference to compare an installed group 27 battery of the same type as the battery ages during use. When the installed battery impedance increases beyond a given amount from the “good” battery value, a signal is produced to indicate this fact. Alternately or in addition a “bad” battery impedance value may be determined for that type of battery and input into the device as a reference. When the tested (installed, and aging) battery begins to approach the higher impedance of the “bad” reference value or meets that value, a signal is produced indicating the need to replace the battery. In another embodiment both good and bad values are used for a more complete and accurate comparison. This type of comparison advantageously alleviates the need to make a reference “good” battery measurement for a newly installed battery. Preferably a temperature measurement is taken and used to calibrate the impedance for more accurate measurements. Ideally a temperature sensor is located on the battery itself, although for convenience the sensor may be located separately such as in the monitoring circuitry or a display unit. Still further the battery state of charge may be used to compensate the measurement for a more accurate determination of battery quality.

The impedance or derived quality of battery measurement in preferred embodiments will be adjusted for (corrected for) temperature effects. The impedance of a battery changes with temperature and thus the temperature should be measured for normalizing the measured impedance. In a preferred embodiment a thermister or other temperature sensor is physically attached to a metal part of the battery such as an electrical binding post. In the case of a lead acid battery a temperature sensor preferably is connected to a lead terminal of the battery.

The state of charge of the battery also affects the measured impedance. In an embodiment an impedance or derived quality value from the impedance measurement is adjusted by taking into consideration of the state of charge. In most instances the state of charge is determined by measureing the battery voltage, preferably under a small current draw. A skilled artisan readily can add this conversion to a microprocessor or other circuit to allow determination of state of charge from a look up table or algorithm for correcting the impedance or derived quality value.

According to a preferred embodiment battery temperature and impedance are measured to derive a “new battery” calibration signal for when the battery is new (or a “new battery” impedance value inputted as this reference). This result is stored. Later, during use of the battery, the user may carry out a battery state test or the circuit can automatically carry out the test to derive a direct or indirect impedance, for example during a start up sequence for using the battery, during battery charging, or at a regular time interval. The battery state test would determine an absolute or relative impedance and measure temperature. A change in impedance value is determined by comparing the stored result with the new test result. The change also may be compared with a reference change result corresponding to a completely deteriorated battery impedance for a more comparative result.

The impedance test results may be output in the form of an analog signal and read on a meter that shows a gradation from good to questionable to poor battery health, or similar result. Monitoring and display of battery health form impedance measurements can be carried out by a variety of techniques. Embodiments provide greater convenience compared to the previously known devices by eliminating quantitative analysis. Examples of useful readout systems are shown in FIGS. 17a through 17f.

Monitoring Electrochemical Fuel Cell Degradation Fuel cell degradation can be monitored in an analogous manner as that for regular batteries, according to an embodiment. The actual degradation may arise from several components of the fuel cell, including, for example a catalyst or a membrane. While not wishing to be bound by any one theory of how this embodiment may be used, the inventors point out that such component parts need to be replaced, and/or serviced such as by electrically treating to improve performance. For example, a typical fuel cell, in many cases will show on the order of 6 percent degradation in performance per year. Some fuel cells should be maintained to prolong their useful life. For example, Jung Yi et al. describe in patent application No. WO0199218 (“Method and apparatus for regenerating the performance of a PEM fuel cell”) that PEM fuel cell performance losses caused during normal operation may be at least partially recovered by periodically reducing the cathode potential to about 0.6 volts or less, and preferably to 0.1V or less. A lower potential will regenerate the cell more quickly. On return to the normal cell voltage, performance is improved. The performance losses during normal operation may be measured by a variety of techniques according to this embodiment. Most preferably the fuel cell internal impedance is measured and compared to a reference value, that may be stored by the manufacturer, may be input by the user, or that may be determined by measurement of the fuel cell when the fuel cell is new or relatively new. An increasing impedance is associated with decreasing performance, in this embodiment. The impedance may be measured as resistance to current flow, as might be, for example, measured by voltage from the cell divided by current, after taking into account the resistance of the energy sink after electrically coupling.

In an embodiment, the internal impedance itself is determined or inferred and is displayed. The internal impedance display may be in relative units or qualitative measure such as a panel meter with area indicating “good,” “acceptable,” “marginal,” “service,” “replace,” “poor” and the like. The display may be as simple as an indication light that goes on when the measured impedance indicates that a threshold has been reached for internal impedance. In a preferred embodiment the threshold is a value that corresponds to the value associated with a fuel cell that is 20% degraded (lost 20% of maximum power, capacity or other parameter of power output capability.) In other embodiments, the threshold for a panel display such as a light, appearance of a symbol on a LCD or buzzer is 5%, 7%, or 10%. In one embodiment a different panel light such as an LED turns on for each of several thresholds such as 5%, 10%, 15% and 20%, and shows progressive loss in performance. In another embodiment a single threshold is used to indicate that the user should carry out a maintenance procedure or replace a part of the fuel cell. Another visual indicator (not shown) is a simple panel light located by itself that comes on when the battery impedance becomes excessive.

Monitoring Battery Charge, Fuel Cell and Hydrogen Reservoir Status One problem, particularly in the electric boat industry is that battery charge status meters based on battery voltages do not accommodate strong discharge or recharge currents while displaying the amount of capacity remaining. One reason for this in many cases is that the nominal (fairly unloaded) battery voltage is needed for determining state of charge. When high current is drawn or the battery is being recharged, such nominal voltage measurements generally are not easily obtained. An embodiment addresses this limitation by using a voltage memory device, which may be implemented in hardware (for example a capacitor that is only connected to the battery when the battery is not loaded or being charged) or software (a measured nominal voltage level is stored in one or more memory locations). During use, the device only responds to (senses) nominal voltage when current (enough to affect the nominal voltage) is not being drawn or added during strong discharge or during recharge.

Typically, the device senses when current is high enough to affect nominal voltage, and stops sensing voltage at this time, instead relying on the last stored value to generate a display. The device optionally also senses current flowing back into the battery (charging current) and stops sensing a nominal voltage at that time as well. The switching and voltage storage can be implemented a variety of ways as will be appreciated by an electronics technician. For example a solid state switch or relay may disconnect a sensor from the battery upon triggering by an above threshold current value in the battery circuit (or a reverse current). A particularly desirable display will indicate 1) battery state of charge, for example by analog needle movement or led segments; 2) a “charge” light indicating that the battery is being charged; and 3) a “discharge” light indicating that significant current is being drawn from the battery. Most preferably, the state of charge indication becomes decoupled from the battery when either light is on, and instead maintains the last measured value.

Hydrogen reservoirs for fuel cell powered vehicles such as watercraft In an embodiment, materials for physisorption of hydrogen are used for hydrogen reservoirs. The reservoirs occupy large volumes, and can, in many embodiments utililze materials that reversibly bind only small weight percentages of hydrogen under their normal operating conditions to allow hydrogen storage for fuel cells. In desirable embodiments, pressure and/or temperature are controlled to adsorb hydrogen and/or to desorb hydrogen from the large volume reservoir of binding substance. By large volume is meant that at least 1 liter, preferably at least 5 liters, 10, 25, 50, 75 100, 125, 150, 175, 200, 250, 300 liters or more of space that contains a hydrogen physiabsorbant are used for a vehicle such as a car, or preferably a watercraft, having a fuel cell that generates moderate (i.e. between 1 kw and 100 kw; preferably between 3 kw and 75 kw and more preferably between 5 kw and 50 kw of electricity from hydrogen for a vehicle. In an embodiment a large volume (eg. 50 liters to 75 liters, 75 liters to 125 liters, 125 liters to 200 liters, 200 liters to 300 liters, or even 300 liters to 500 liters volume) is matched with such a moderate sized small fuel cell in a vehicle such as a small watercraft (less than 45 feet long, preferably less than 35 feet long, less than 30 feet long or even less than 25 feet long) such that even a poor reversible physiabsorbant (i.e. reversibly binds less than the often stated goal of 6% hydrogen by weight of absorbant, less than 5%, 4%, or even 3%) can be used for long distance travel in a small craft by virtue of using a large volume of physiabsorbant.

In another embodiment a large volume of physiabsorbant that reversibly binds between 6% and 10% by weight of hydrogen is used with such sized fuel cell. The last embodiment is not expected to achieve commercial success for some time, but the use of large volumes of low capacity (particularly less than 6%, 5%, 4%, 3%, 2%, 1% or even less than 0.5% binding of hydrogen/absorbent wgt/wgt) favorably may be used in a reservoir as described herein.

A craft such as a car or boat may have a hull, or outer shell that comprises a low ambient or moderate pressure container (ie. single chamber or preferably series of chambers), that contain reversible physiabsorbent. In a preferred embodiment the physioabsorbant is arranged to allow large surface area exposed to the chamber (or container inside volume). by presentation via complexing, surrounding, or adhering to polymer, metal such as metallic invaginations, fins porous plastic, porous ceramic and the like. Desirably multiple tubes or other conduits within the chamber allow flowing of another gas or liquid inside the pressure chamber with physioabsorbant on or near the surfaces of the conduits and exposed to the chamber lumen so that the other gas or liquid controls the temperature of the physioabsorbant, facilitating adsorption and/or removal of hydrogen from absorption to the physioabsorbant.

In a desirable watercraft embodiment, one or more chambers are prepared within the hull itself and exist at least partly near to a body of water that the watercraft sits in. The chamber content(s) (including physioabsorbant) may be insulated from the surrounding water or may be insulated and temperature controlled. In the latter case, a high or low temperature may be forced upon the absorbant to release hydrogen during watercraft operation. The chamber may be separated from the water by one or more barriers. Preferably, multiple chambers are used so that if the watercraft hull experiences a hull failure at one spot, the entire hydrogen reservoir is not placed at risk. In another embodiment the hydrogen reservoir chamber includes a material that automatically seals a small breach in the containment system by virtue of having a higher pressure than the surroundings and in which the material is free to escape or migrate to or into any hole produced by a collision, and occlude such hole. The material may be a fibrous material that swells when in contact with water. The material also or in addition may have the property of polymerizing or forming a solid when in contact with water and/or molecular oxygen. In this way, any breach that leads to contact with water and/or the atmosphere will automatically heal.

Preferably the hydrogen reservoir is maintained at an internal pressure that is within a factor of 15, and more preferably within a factor or 10, 7, 5 or even a factor of 3 (ex. between 0.33 and 3.33 atmospheres) from ambient pressure. This advantageous embodiment allows the use of lower cost construction materials and lower cost pumping to get the hydrogen into and out of the reservoir. In a desirable embodiment, a cost tradeoff is made to use a lower percentage by weight hydrogen binding substance (which in many cases dominates costs) and conditions (very high pressure and very low pressure conditions are more expensive to achieve) so that smaller pressure changes are used with a larger volume of reservoir. The large reservoir volume accommodates the lower hydrogen capacity of the material in the less extreme pressure conditions by allowing sufficient hydrogen use despite the lower differential requirements. Unlike many terrestrial applications, a boat may have large void volumes to accommodate such large reservoirs.

An advantage of an embodiment is that by placing the reservoir in or under the water, greater safety can be achieved. For example, the entire hydrogen reservoir may exist as a torpedo or other shaped volume under the watercraft. The Maruta (tm) boat concept described in U.S. Pat. Nos. 6,571,722; 6,532,884; 6,273,015 and 6,073,569 for example, can be used wherein the hydrogen reservoir is a low energy density (less than half the density of gasoline, or even less) power supply that is maintained in a water bath having a reasonable temperature (i.e. a lake, ocean, river, or the like). Alternately the hydrogen reservoir tank(s) may be covered on the boat interior side (the side(s) away from water) by a stronger material such as steel sheet, graphite fiber fiberglass, mesh or the like. By placing the reservoir at least partially underwater, the watercraft owner experiences less risk of explosions. A land vehicle also can be constructed according to these principles, by constructing the side(s) of the reservoir facing the occupants with stronger material so that any explosion and/or leak(s) could be directed away from the occupants.

Watercraft are particularly useful for many embodiments because of the presence of large bodies of water in contact with the vehicle and the fact that large spaces often exist in watercraft that serve dual use as hydrogen storage spaces. Most desirable is the use of hydrogen absorbent materials and chambers that have a weight density less than water, such as less than 1 gm/cc; less than 0.9 gm/cc; less than 0.8 gm/cc; less than 0.6 gm/cc; less than 0.5 gm/cc or even less than 0.4, 0.3 or 0.2 gm/cc. By using energy storage materials and/or reservoirs of low weight densities, the watercraft receives the added bonus of improved flotation or reserve floatation. In an embodiment a hydrogen reservoir occupies (space fills) at least 10, 24, 50, 75, 85 percent or more of a space at the front bow of the boat from the furthermost point to 5 percent of the distance back to the stern. In another embodiment the hydrogen reservoir occupies space under a boat seat. In another embodiment the hydrogen reservoir occupies at least 0.5, 1, 2, 3, 5, 10, 25, 50 or more percent of the boat hull. In another embodiment the hydrogen occupies a small torpedo or submarine shape that is submerged in the water and that optionally comprises one or more lifting surfaces, such as that used in a SWATCH ship design. Such structures are particularly useful for large ocean going vessels.

In an embodiment, hydrogen gas is introduced into the chamber by connecting a source through a tube and applying via high pressure (at least 1.1, 1.5, 2, 3, 5, 10 or more atmospheres pressure). In an embodiment the pressure facilitates physical absorption to the absorbent. In an embodiment hydrogen is removed from the reservoir by connecting a tube preferably via a pressure regulator that directly or indirectly feeds a fuel cell. Temperature of the reservoir contents may be increased to both increase adsorption and increase desorption of hydrogen. In an embodiment a feedback control system is provided wherein the pressure from the reservoir (measured within the tank by piezoelectric soundings, by piezoelectric transducer or the like, or, for example measured in an outside stream obtained from the reservoir etc) is measured constantly or periodically, and heat is added to the reservoir as needed to maintain a minimum off gassing pressure or minimum hydrogen supply to the fuel cell. In an embodiment multiple reservoirs are connected as needed to maintain a desired hydrogen supply rate. In another embodiment a low pressure is applied to a reservoir to remove hydrogen. In yet another embodiment both pressure (low or high) and temperature (low or high) are controlled to remove hydrogen from the reservoir.

Monitoring of hydrogen bound to the absorbent within the chamber preferably is carried out, both to determine the percent state of charge (or total amount of energy) as well as to determine the relative health of the system. A variety of sensors and sensor systems may be used for these aims. Preferably temperature sensors are used, such as thermistors or thermocouples. Thermistors, for example may be physically in contact with a structural support within the chamber (such as an aluminum or other metal fin or large area structure) or imbedded within the absorbent itself. Desirably the heat of binding or release from binding can be measured as a change in temperature at the sensor(s) while charging with hydrogen. As hydrogen binds to the absorbent, the absorbent undergoes a temperature change. In many cases, the amount of hydrogen, proportion of filled absorbent etc. can be best determined by converting the temperature change to a relative imputed energy change via correcting for ambient or starting temperature and then comparing with stored values. A skilled artisan can appreciate how to measure both inside and outside temperature to determine or infer a binding energy change of the system. By placing and monitoring multiple sensors within the chamber more detailed information may be obtained.

Other techniques for determining bound hydrogen may be used. Piezo electric sound wave generation and dispersal within a chamber may be used to determine bound hydrogen but must account for gas pressure within the chamber. In an embodiment a higher bound hydrogen content is detected as a stronger conducted sound wave as an absorbent in this embodiment becomes more dense and acoustically more conductive. In another embodiment light reflectance, conductance and/or absorbance measurements may be taken, particularly at one or more light wavelength regions associated with color(s) of the absorbent material.

Measurements of bound hydrogen may be used to infer deterioration of the hydrogen reservoir quality, that may result, for example, from aging, contamination by oxygen, contamination by water, or contamination by other gases such as carbon monoxide or carbon dioxide. Typically, a known good reference value is measured for the tank, or inputting to a comparison device such as a microcomputer, non computer circuit, or software program. Measurements then may be taken during use of the chamber and compared with the reference to detect deterioration. For example, temperature change measured within the chamber may be determined for a given set of conditions (ambient temperature, chamber pressure, state of charge of the absorbent) and compared with one or more reference values. A lower than usual change in temperature for a given condition, for instance, may indicate that the absorbent has lost some of its vigor and that less hydrogen binds or the binding is less favorable, requiring higher pressure (or other variable such as temperature) for the same amount of binding.

In another embodiment the relative amount of hydrogen in the hydrogen storage reservoir is determined by monitoring the pressure and temperature, which can indicates the amount of hydrogen left to be absorbed. The measured values may be compared with a look up table to determine hydrogen, for example. The amount of hydrogen in an embodiment can be determined by piezoelectric measurements, because the absorbance, reflectance or permissivity of the storage material (as well as the gaseous open space itself) to a sound wave can change with the amount of hydrogen bound or presence in the open space.

In another embodiment the health, or deterioration of the hydrogen storage reservoir is determined by measuring the hydrogen efflux under a set of conditions such as pressure and temperature and comparing the efflux (measured for example, as pressure, or amount) and comparing with known values. For example, a new and good performing reservoir of a defined volume might be filled by exposure to 10 atmospheres of hydrogen gas at 50 degrees Fahrenheit and may generate a total of 2000 liters of hydrogen gas (determined at 1 atmosphere and 25 degrees Celsius) but after use for two years may only absorb (at the same time/temperature/pressure conditions) and subsequently regenerate only 1500 for a deterioration to 75% effective capacity. Preferably such quality measurement is determined once, for each filling and use. The result of this comparison may, for example be displayed on a meter, as a flashing light if over a threshold during filling or during use, or may be communicated to a central monitoring station by wireless signal.

A variety of hydrogen absorbents are known and can be used. Modifications of these and further absorbent types will be discovered and can be used. Low absorptive capacity absorbents (as defined above) are particularly desirable for an embodiment wherein the absorbent is used in a reservoir having an overall low density and doubles as a buoyancy material. Examples of hydrogen absorbents are, complexes of inorganic materials such a fibrous, porous, or even regular large solid surfaces of metals, glass, minerals, or with organic polymers, and may include (singly or in combination): silicas, aluminas, zeolites, graphite, activated carbons, carbon nanofibers and combinations such as nanocubes formed from terephthalic acid and zinc oxide as described by BASF (see “Basf Rolls Out ‘Nanocubes’ for Hydrogen Storage” in Fuel Cell Today Nov. 11, 2002) metal hydride alloys such as those made by Air Products and Chemicals (see Fuel Cell Today Feb. 13, 2003 p. 32) and. Examples of such materials can be found in the popular literature. See for example Appl. Phys. A 72: 619-623 (2001); M. G. Nijkamp's thesis of April 2002 entitled “Hydrogen Storage using Physisorption, Modified Carbon Nanofibers and Related Materials” on file at the University of U (Netherlands) library, and “Hydrogen-storage materials for mobile applications” by Louis Schlapbach and Andreas Zuttel, in Nature 414: 353-358 (2001) which are particularly incorporated with respect to the materials taught therein.

Most desirable absorbents however, are metal-organic frameworks such as those pioneered by Omar Yaghi at the University of Michigan (Science 300: 1127-1129 (2003)). In one embodiment absorbent comprises metal organic frameworks made from zinc oxide and terephthalate. In a desirable embodiment the metal is zinc. In another desirable embodiment the organic framework has carboxylate residues that may be used to bind to a solid support. Preferably the framework comprises at least 1, 5, 10, 25, 50% or more organic framework of polymer that holds the hydrogen absorbent in place while maintaining an open structure. Other examples of materials in this context are those described by Chen, B et al. “Interwoven metal-organic framework on a periodic minimal surface with extra-large pores” Science 291: 1021 (2001); the use of transition metals that favorably may be used as exemplified in Khan, M. I. “Novel extended solids composed of transition metal oxide clusters” Journal of Solid State Chemistry 152: 105 (2000); Li, H. in Nature 402: 276 (1999) and Reineke, T. M. et al. in Journal of the American Chemical Society 122: 4843 (2000)

During use in a chamber (for example as energy source in an auto, in an airplane wing, watercraft as described herein etc) the framework preferably is bound to a solid support inside the chamber. Most preferably the solid support is organic or is organic covered metal and the framework covalently is bound to the solid support. For example, aluminum fins, glass fins, polymeric fins, graphite fiber, and the like may be distributed within the chamber and the metal organic framework is coupled to the solid support by covalent bonds. Such organic reactions are well known to skilled organic chemists, and may utilize, for example, functional residues on the framework, solid support surface or both, such as amino, amido, carboxyl, hydroxyl, ester, azido, sulfydral, nitro, and the like.

Accordingly an embodiment of the invention is a manufacturing procedure wherein metal-organic framework material, which may be in the form of polymer and metal formed in solution, in suspension, as a colloidal suspension, as a dispersion, or as a powder is attached to a larger solid surface within a chamber that can be exposed to varying pressures. In an embodiment, the metal organic material is contacted to and becomes bound to a large area solid surface that in turn is assembled inside a chamber. In an embodiment a chamber with baffles etc. is formed with surfaces inside it that can bind metal organic framework and a solution, suspension, colloidal suspension, powder or other form of the metal framework is flowed into the chamber and allowed to react with the surface. This preferably is followed by a wash step to remove unbound material and optionally with a quenching step, whereby excess unreacted active residues on the surface (and/or on the metal-organic framework) are reacted with a small molecular weight ligand to block from further reaction. Such chemistries are well known. For example, see U.S. Pat. Nos. 6,586,182; 6,573,369; 6,235,876; 5,919,523; 5,554,386; 5,562,099; 5,543,332; 5,529,986; 5.512,492; 5,487,390; and 5,206,159 the contents of which and more specifically the reagents, and coupling chemistry methods of which are incorporated by reference.

Depending on the available residues of the organic framework, the organic framework might be primed to react with moieties on the solid surface, or the solid surface may be treated to create active residues that can react with organic framework. That is, the contact leading to binding or coupling between metal-organic framework and solid surface may arise from an active moiety made on the solid surface, an active moiety made on the organic framework, or possibly both. The art of binding active molecules, and small particles such as latex particles to other molecules or solid surfaces by treating with one or more agents such as EDAC, formaldehyde and the like is well developed in the chemical diagnostics and processing industry. That industry also has many materials that may be used as the solid surface, such as porous plastic, scintered glass, and other materials available from such companies as the Porous Products Group of Pall Corporation. Some of these materials desirably are simple and porous plastics made from cheap materials such as porous polyethylene, and can bind up organic framework (with attached metal) by non-specific (non-covalent) interactions. The metal-organic framework may it self be assembled on the solid surface. An embodiment of the invention is a wide open space (eg. Porous, fibrous, finned, etc) chamber capable of holding a partial vacuum or partial pressure wherein a high solid surface within the chamber has attached to it a hydrogen binding material such as a metal-organic framework. The chamber may be exposed to different pressures to reversibly absorb and desorb hydrogen. In a desirable embodiment a partial vacuum is required to desorb hydrogen. For example less than 0.9, 0.75, 0.5, 0.2, 0.1 003, or even less than 0.015 atmosphere pressure is made to the chamber contents to facilitate hydrogen desorption. This condition is particularly more safe, as a accident that results in breach of the chamber will not quickly generate large efflux of hydrogen. Unlike other hydrogen storage systems that keep hydrogen under high pressure, breach of the system will not as easily cause an explosion. Of course, generally speaking the hydrogen removed at the lower pressure may have to be presented to a fuel cell at a higher concentration and may need to be compressed before further use.

A variety of embodiments have been described for storing, monitoring and use of electrical or fuel cell energy. A reader readily will appreciate that each embodiment may be combined with other embodiments described herein. All such embodiments specifically are intended within the scope of the invention and have not been separately presented for the sake of brevity.

The contents of all publications, patents and patent applications listed herein specifically are incorporated by reference in their entireties. Priority applications U.S. Ser. No. 10/187,830 filed Jul. 3, 2002; U.S. Nos. 60/323,723 filed Sep. 21, 2001; 60/302,647 filed Jul. 5, 2001 and 60/349,375 filed Jan. 22, 2002; U.S. Ser. No. 10/164,566 filed Jun. 10, 2002; U.S. Ser. No. 09/877,196 filed Jun. 11, 2001; 60/296,754 filed Jun. 11, 2001; 60/302,647 filed Jul. 5, 2001 and 60/349,375 filed Dec. 22, 2001; U.S. Ser. No. 10/164,567 filed Jun. 10, 2002; U.S. No. 60/296,754 filed Jun. 11, 2001; U.S. Nos. 60/396,084 filed Jul. 17, 2003; 60/445,249 filed Feb. 6, 2003; 60/433,591 filed Dec. 16, 2002; 60/349,375 filed Dec. 22, 2002; 60/431,200 filed Dec. 6, 2002 and U.S. provisional application entitled “Magnetic Torque Converter” filed Jun. 3, 2003 most specifically are incorporated by reference in their entireties.

I claim:

1. An overspeed mechanism for exceeding the continuous duty power output of an electric motor in a vehicle, comprising: a) an electric motor with a given continuous duty power rating; b) a power supply for the motor comprising an energy source and power control circuitry for providing electric energy to the motor in excess of the continuous power rating; c) a switch for activating overspeed power to the motor; and d) a temperature detector with associated control circuitry located on at least the motor or power supply component, wherein the switch engages the power supply to supply power in excess of the continuous power rating, the temperature detector continuously monitors temperature and the temperature detector associated control circuitry blocks the provision of power to the motor in excess of the motor's continuous duty power rating upon detection of a high temperature by the temperature detector.

2. An overspeed mechanism as described in claim 1, wherein the electric motor has a continuous power rating of between 3 and 30 horsepower.

3. An overspeed mechanism as described in claim 1, wherein the power control circuitry comprises battery bank switches.

4. An overspeed mechanism as described in claim 1, wherein the power control circuitry comprises capacitive banks that periodically become charged and discharged into the motor, wherein the discharge voltage applied to the motor exceeds the battery voltage.

5. An overspeed mechanism as described in claim 1, further comprising a visual indicator of the status of overspeed capability.

6. An overspeed mechanism as described in claim 5, wherein the visual indicator is selected from the group consisting of a green light indicating that overspeed power is available, a yellow light indicating that some but not maximum overspeed power is available, a red light indicating that no overspeed power is available, a gauge with a needle that displays the relative amount of overspeed time available, and a digital readout that indicates relative or absolute amount of overspeed time available.

7. An overspeed mechanism as described in claim 1, further comprising an electric fan for cooling the electric motor, thereby the fan is activated upon activation of the overspeed mechanism.

8. An overspeed mechanism as described in claim 1, further comprising a water pump for for transporting water into contact with a surface of the motor upon activation of the overspeed mechanism.

9. A watercraft that comprises an overspeed mechanism as described in claim 1.

10. An land vehicle that comprises an overspeed mechanism as described in claim 1.

11. A kit for adding overspeed capability to a vehicle, comprising an overspeed mechanism as described in claim 1, and one or more fasteners for attaching one or more components of the overspeed mechanism to the vehicle.

12. An electric vehicle power supply usage efficiency monitor, comprising:
a) an electrical signal receiving input that accepts a signal which indicates the relative or absolute state of power supply depletion;
b) at least one circuit or software program implemented in a microprocessor or other hardware that compares the input from a) with a factor that accounts for the cost of the power supply and that outputs a signal corresponding to both rate of power usage and state of power supply depletion; and
c) a signaling device that indicates cost or efficiency of power use to an operator of the vehicle.

13. A monitor as described in claim 12, wherein the power supply is selected from the group consisting of an electric storage battery, a lead acid battery, a metal hydride battery, a nickel cadmium battery, a lithium battery, a hydrogen tank, a graphite hydrogen storage container, a carbon nanotube hydrogen storage container, a metal hydrogen storage container, an alcohol fuel storage container, a wet chemistry reduced compound in a container, sodium borohydride in a container, and a hydrocarbon storage container.

14. A monitor as described in claim 12, wherein the power supply is a chemical that is used to supply energy for a fuel cell.

15. A monitor as described in claim 12, wherein the microprocessor of b) comprises a look up table of values or an algorithm corresponding to a power supply life use time at the measured power supply depletion.

16. A monitor as described in claim 12, wherein the signaling device is selected from the group consisting of a visual analog meter, a visual bar meter, a visual meter with regions showing relative or absolute projected energy costs, a digital meter, a digital meter showing relative or absolute projected energy costs, and an auditory device.

17 A monitor as described in claim 12, wherein the microprocessor of b) comprises a look up table of values or algorithm corresponding to added energy costs for reversibly depositing a chemical fuel for powering a fuel cell in the storage container.

18. A monitor as described in claim 12, wherein the vehicle is a watercraft.

19. A monitor as described in claim 18, further comprising a control governor circuit that automatically decreases electrical power use to a lower maximum value that conserves the health of the power supply.

20. A power supply status monitor for a fuel cell that alerts an operator of a higher cost condition of operating the fuel cell's power supply comprising:
a) an electrical signal receiving input that accepts a signal that indicates the relative or absolute state of power supply depletion;
b) at least one circuit or software program implemented in a microprocessor or other hardware that compares the input from a) with a range corresponding to the higher cost condition to determine when the range of higher cost of power supply use has been entered; and
c) a signaling device that indicates cost or efficiency of power use to an operator of the fuel cell.

21. A power supply status monitor for a fuel cell as described in claim 20, wherein the higher cost condition is a low chemical fuel concentration in a storage container that requires energy input to remove the chemical fuel from the storage container.

22. A power supply status monitor for a fuel cell as described in claim 21, wherein the energy input is selected from the group consisting of heating at least part of the storage container, pumping the storage container, washing the storage container with a gas or liquid, vibrating the storage container, and changing the volume or shape of the storage container to extract more of the chemical fuel.

23. A power supply status monitor for a fuel cell as described in claim 20, wherein the signaling device is selected from the group consisting of a bell, a buzzer, a chime, a piezoelectric buzzer, a light, an electrical signal sent to a computer, an electrical signal sent over a telephone line, an analog visual gauge, a digital visual gauge and a flat screen display.

24. A battery health monitor for a vehicle, comprising:
a) a hardware circuit comprising i) signal inputs for a power demand signal and for a state of capacity signal, ii) at least a microprocessor or other circuitry for comparing the signal input with one or more stored values, iii) a temperature transducer that monitors the battery temperature, iv) a reference signal value corresponding to the status of a healthy battery, and v) an electrical output from the hardware circuit to indicate battery health; and
b) a signaling device that receives the electrical output from the hardware circuit to indicate battery health to an operator of the vehicle;
wherein the hardware circuit tests the battery's ability to generate power by 1) asserting a known load on the battery, 2) measuring the battery output in response to the known load to generate a power demand signal, 3) compensating the power demand signal for power with a temperature signal from the temperature transducer, and 4) compensating the power demand signal with a state of capacity signal indicating the state of battery depletion, and 5) comparing the double compensated signal with a reference signal to generate the output signal indicating battery health.

25. A battery health monitor as described in claim 24, wherein the signaling device is a panel mounted device selected from the group consisting of an analog meter with colored regions, an analog meter with green yellow and red areas to indicate multiple full battery charge cycles remaining, few full battery charge cycles remaining and no full battery charge cycles remaining respective, an analog meter with numeric display of relative or absolute number of battery charge cycles remaining, a light to alert when few or no full battery recharge cycles remain, a buzzer to alert when few or no full battery recharge cycles remain, an alert light within a fuel panel gauge to alert when few or no full battery recharge cycles remain, and a panel display.

26. A battery health monitor as described in claim 24, wherein the hardware circuit test of the battery with the known load occurs automatically during a recharge cycle and the result is used to update the output signal.

27. A battery health monitor as described in claim 26, wherein the test occurs at a point determined by a reference voltage and wherein the charging battery voltage exceeds the reference voltage.

28. A battery health monitor as described in claim 24, further comprising a push button switch that asserts the known load on the battery to allow user interrogation of a present battery health status.

29. A battery health monitor as described in claim 24, wherein the reference signal is obtained by asserting the known load on the battery when the battery is first used.

30. A battery health monitor as described in claim 24, wherein the temperature transducer is a thermister that is mechanically and thermally coupled to a battery terminal.

31. A fuel cell health monitor for a vehicle, comprising:
a) a hardware circuit comprising i) signal input for a power demand signal ii) at least a microprocessor or other circuitry for comparing the signal input with one or more stored values, iii) a reference signal value corresponding to the status of a healthy fuel cell, and iiv) an electrical output from the hardware circuit to indicate battery health; and
b) a signaling device that receives the electrical output from the hardware circuit to indicate fuel cell health to an operator of the vehicle;
wherein the hardware circuit tests a fuel cell parameter associated with the fuel cell's ability to generate power by 1) asserting a known load on the fuel cell, 2) measuring the fuel cell output in response to the known load to generate a power demand signal, 3) comparing the measured output in response with a reference signal to generate the output signal indicating fuel cell health.

32. A fuel cell health monitor as described in claim 31, wherein the load is a resistive load and the measured fuel cell output is a current at a known voltage to derive an impedance that is compared with the reference signal.

33. A fuel cell health monitor as described in claim 31, further comprising a fuel cell temperature measurement, wherein the measured fuel cell output in response to the known load is calibrated by the temperature measurement before comparing with a reference signal.

34. A fuel cell health monitor as described in claim 31, wherein the measured fuel cell output response is an impedance of a membrane within the fuel cell.

35. A fuel cell health monitor as described in claim 31, wherein the signaling device is a panel mounted device selected from the group consisting of an alert light to indicate that a membrane or other degradable part of a fuel cell requires replacing, an alert light within a fuel gauge to indicate that a membrane or other degradable part of a fuel cell requires replacing, an analog meter with green yellow and red areas to indicate that a fuel cell membrane or other degradable part of the fuel cell has good marginal or no life remaining respectively, an analog meter with numeric display of time or energy flow remaining before a fuel cell membrane or other degradable part of the fuel cell should be replaced, time or total energy available from the fuel cell before fuel cell maintenance is required; a light to alert when fuel cell maintenance is required; a buzzer to alert when fuel cell maintenance is required, and a panel display.
